(19) United States
(12) Patent Application Publication
(10) Pub. No.: US 2026/0039870 A1
(43) Pub. Date: Feb. 5, 2026

(54) POINT CLOUD ENCODING METHOD AND APPARATUS, POINT CLOUD DECODING METHOD AND APPARATUS, DEVICE, AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/352,633

(22) Filed: Oct. 8, 2025

Related U.S. Application Data
(63) Continuation of application No. PCT/CN2023/087659, filed on Apr. 11, 2023.

(51) Int. Cl. H04N 19/597; H04N 19/105; H04N 19/423; H04N 19/70

(52) U.S. Cl. CPC H04N 19/597; H04N 19/105; H04N 19/423; H04N 19/70

(57) ABSTRACT

The present application provides a point cloud encoding method. The method includes: determining a first parameter, where the first parameter is used to indicate a maximum number M of reference points bufferable in a prediction reference buffer, M being a positive integer; determining M reference points based on the first parameter, and storing the M reference points into the prediction reference buffer, and determining an attribute prediction value of a current point based on reference points included in the prediction reference buffer.

### CROSS-REFERENCE TO RELATED APPLICATION

This application is a Continuation application of International Application No. PCT/CN2023/087659 filed on Apr. 11, 2023, which is incorporated herein by reference in its entirety.

### TECHNICAL FIELD

The present disclosure relates to the field of point cloud technologies, and in particular to a point cloud encoding and decoding method and apparatus, a device and a storage medium.

### BACKGROUND

A surface of an object is captured by a collection device to form point cloud data, which includes hundreds of thousands or even more points. In a process of video production, the point cloud data is transmitted between a point cloud encoding device and a point cloud decoding device in a form of a point cloud media file. However, such a large number of points brings challenges to transmission, and thus, the point cloud encoding device needs to compress the point cloud data before transmission.

Point cloud compression is also called point cloud encoding, in the process of point cloud attribute encoding, at least one neighboring point of a current point is first determined from reference points in a prediction reference buffer, and subsequently, an attribute prediction value of the current point is determined based on the attribute information of the at least one neighboring point. However, the performance of attribute encoding and decoding is poor, leaving room for further improvement.

### SUMMARY

The embodiments of the present disclosure provide a point cloud encoding and decoding method and apparatus, a device, and a storage medium.

In a first aspect, the embodiments of the present disclosure provide a point cloud decoding method, including:
determining a first parameter, where the first parameter is used to indicate a maximum number M of reference points bufferable in a prediction reference buffer, M being a positive integer;
determining M reference points based on the first parameter, and storing the M reference points into the prediction reference buffer; and
determining an attribute prediction value of a current point based on reference points included in the prediction reference buffer.

In a second aspect, the present disclosure provides a point cloud encoding method, including:
determining a first parameter, where the first parameter is used to indicate a maximum number M of reference points bufferable in a prediction reference buffer, M being a positive integer;
determining M reference points based on the first parameter, and storing the M reference points into the prediction reference buffer; and
determining an attribute prediction value of a current point based on reference points included in the prediction reference buffer.

In a third aspect, the present disclosure provides a point cloud decoding apparatus, for performing the method in the above first aspect or various implementations thereof. Exemplarily, the apparatus includes a functional unit for performing the methods in the above first aspect or various implementations thereof.

In a fourth aspect, the present disclosure provides a point cloud encoding apparatus, for performing the method in the above second aspect or various implementations thereof. Exemplarily, the apparatus includes a functional unit for performing the methods in the above second aspect or various implementations thereof.

In a fifth aspect, there is provided a point cloud decoder, including a processor and a memory. The memory is configured to store a computer program, and the processor is configured to call and run the computer program stored in the memory to perform the methods in the above first aspect or various implementations thereof.

In a sixth aspect, there is provided a point cloud encoder, including a processor and a memory. The memory is configured to store a computer program, and the processor is configured to call and run the computer program stored in the memory to perform the methods in the above second aspect or various implementations thereof.

In a seventh aspect, there is provided a point cloud encoding and decoding system, including a point cloud encoder and a point cloud decoder. The point cloud decoder is configured to perform the methods in the above first aspect or various implementations thereof, and the point cloud encoder is configured to perform the methods in the above second aspect or various implementations thereof.

In an eighth aspect, there is provided a chip for implementing the methods in any one of the first to second aspects or various implementations thereof. Exemplarily, the chip includes: a processor, configured to call a computer program from a memory and run the computer program, to enable a device equipped with the chip to perform the methods in any one of the first to second aspects or various implementations thereof.

In a ninth aspect, there is provided a non-transitory computer-readable storage medium for storing a computer program, where the computer program enables a computer to perform the methods of any one of the first to second aspects or various implementations thereof.

In a tenth aspect, there is provided a computer program product, including computer program instructions, where the computer program instructions enable a computer to perform the methods in any one of the first to second aspects or various implementations thereof.

In an eleventh aspect, there is provided a computer program, where the computer program, upon being executed on a computer, enables the computer to perform the methods in any one of the first to second aspects or various implementations thereof.

In a twelfth aspect, there is provided a bitstream, where the bitstream is generated based on the method of the second aspect.

In a thirteenth aspect, there is provided a non-transitory computer-readable storage medium. The non-transitory computer-readable storage medium has a computer program and a bitstream stored thereon, and the computer program, when executed by a processor, enables the processor to perform the method described in the second aspect, to generate the bitstream.

### BRIEF DESCRIPTION OF THE DRAWINGS

FIG. 1A is a schematic diagram of a point cloud.

FIG. 1B is a partially enlarged diagram of a point cloud.

FIG. 2 is a schematic diagram of a point cloud picture at six viewing angles.

FIG. 3 is a schematic block diagram of a point cloud encoding and decoding system involved in an embodiment of the present disclosure.

FIG. 4A is a schematic block diagram of a point cloud encoder provided by an embodiment of the present disclosure.

FIG. 4B is a schematic block diagram of a point cloud decoder provided by an embodiment of the present disclosure.

FIG. 5A is a schematic diagram of a plane.

FIG. 5B is a schematic diagram of a node coding sequence.

FIG. 5C is a schematic diagram of a planar flag.

FIG. 5D is a schematic diagram of sibling nodes.

FIG. 5E is a schematic diagram of an intersection of a laser radar and a node.

FIG. 5F is a schematic diagram of a neighborhood node at the same partitioning depth and the same coordinate.

FIG. 5G is a schematic diagram of neighborhood nodes in a case where a node is located at a lower plane position of a parent node.

FIG. 5H is a schematic diagram of neighborhood nodes in a case where a node is located at a high plane position of a parent node.

FIG. 5I is a schematic diagram of predictive encoding of planar position information of a laser radar point cloud.

FIG. 6 is a schematic diagram of infer direct coding model (IDCM) coding.

FIG. 7A to FIG. 7C are schematic diagrams of triangle soup-based geometry information coding.

FIG. 8A is a schematic diagram of a distance-based LOD construction.

FIG. 8B is a subjective schematic diagram of a distance-based LOD generation process.

FIG. 8C is a flowchart of predictive encoding.

FIG. 8D is a schematic diagram of a LOD partitioning.

FIG. 8E is a schematic diagram of inter-level nearest neighbor search.

FIG. 8F is a schematic diagram of performing nearest neighbor search based on a spatial relationship.

FIG. 8G is a schematic diagram of nearest neighbor search for a co-planar, co-edge and co-vertex.

FIG. 8H is a schematic diagram of a neighboring point search.

FIG. 8I is a schematic diagram of a neighboring point search.

FIG. 8J is a schematic diagram of a neighboring point search based on a fast search algorithm.

FIG. 8K is a schematic diagram of an inter nearest neighbor search.

FIG. 8L is a flowchart of a lifting transform.

FIG. 8M is a schematic diagram of a RAHT transform process along x, y and z directions.

FIG. 8N is a schematic diagram of a RAHT transform.

FIG. 8O is a schematic diagram of RAHT forward transform and inverse transform.

FIG. 9 is a schematic flowchart diagram of a point cloud decoding method provided by an embodiment of the present disclosure.

FIG. 10 is a schematic diagram of a prediction reference buffer.

FIG. 11 is a schematic diagram of updating the reference prediction buffer.

FIG. 12 is a schematic diagram of updating the reference prediction buffer.

FIG. 13 is a schematic flowchart diagram of a point cloud encoding method provided by an embodiment of the present disclosure.

FIG. 14 is a schematic block diagram of a point cloud decoding apparatus provided by the embodiments of the present disclosure.

FIG. 15 is a schematic block diagram of a point cloud encoding apparatus provided by the embodiments of the present disclosure.

FIG. 16 is a schematic block diagram of an electronic device provided by the embodiments of the present disclosure.

FIG. 17 is a schematic block diagram of a point cloud encoding and decoding system provided by the embodiments of the present disclosure.

### DETAILED DESCRIPTION

The present disclosure may be applied to the technical field of point cloud upsampling, for example, may be applied to the technical field of point cloud compression.

In order to facilitate understanding of the embodiments of the present disclosure, related concepts involved in the embodiments of the present disclosure are briefly introduced as follows firstly.

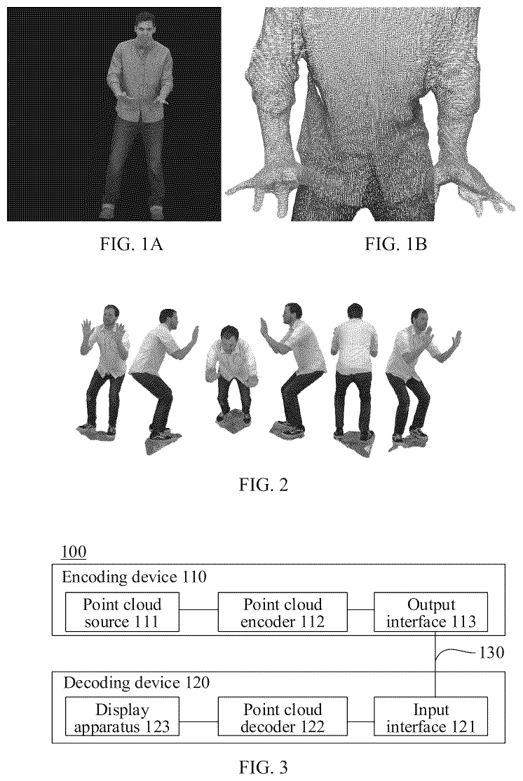

A point cloud refers to a set of discrete points in space that are irregularly distributed and express spatial structures and surface attributes of three-dimensional objects or three-dimensional scenarios. FIG. 1A is a schematic diagram of a three-dimensional point cloud picture, and FIG. 1B is a partially enlarged diagram of FIG. 1A. It may be seen from FIG. 1A and FIG. 1B that a point cloud surface is composed of densely distributed points.

A two-dimensional picture has information expression at each sample point (also referred to as pixel point), and the distribution is regular, so there is no need to record its position information additionally. However, distribution of points in a point cloud is random and irregular in three-dimensional space, so it is necessary to record a position of each point in space to completely express the entire point cloud. Similar to the two-dimensional picture, during a capturing process, each position has corresponding attribute information.

Point cloud data is a specific record form of a point cloud. A point in the point cloud may include position information of the point and attribute information of the point. For example, the position information of the point may be three-dimensional coordinate information of the point. The position information of the point may also be referred to as geometry information of the point. For example, the attribute information of the point may include color information, reflectance information, normal vector information, or the like. The color information reflects a color of an object, and the reflectance information reflects a surface material of an object. The color information may be information in any color space. For example, the color information may be RGB. For another example, the color information may be luma-chroma (YCbCr, YUV) information. For example, Y represents luminance (Luma), Cb (U) represents blue chromatic aberration, Cr (V) represents red chromatic aberration, and U and V represent chroma for describing chromatic aberration information. For example, for a point cloud obtained according to the laser measurement principle, a point in the point cloud may include three-dimensional coordinate information of the point and laser reflectance intensity of the point. For another example, for a point cloud obtained according to the photogrammetry principle, a point in the point cloud may include three-dimensional coordinate information of the point and color information of the point. For another example, for a point cloud obtained by combining the laser measurement principle and photogrammetry principle, a point in the point cloud may include three-dimensional coordinate information of the point, laser reflectance intensity of the point and color information of the point. FIG. 2 illustrates a point cloud picture, where FIG. 2 illustrates six viewing angles of the point cloud picture. Table 1 illustrates a point cloud data storage format consisting of a file header information part and a data part.

TABLE 1

| | |
|---|---|
| 1 | ply |
| 2 | format ascii 1.0 |
| 3 | element vertex 207242 |
| 4 | property float x |
| 5 | property float y |
| 6 | property float z |
| 7 | property uchar red |
| 8 | property uchar green |
| 9 | property uchar blue |
| 10 | end_header |
| 11 | 75 318 0 0 142 0 |
| 12 | 75 319 0 0 143 0 |
| 13 | 75 319 1 1 9 9 |
| 14 | 77 315 0 1 9 9 |

In Table 1, the header information includes a data format, a data representation type, the total number of points of a point cloud, and content represented by the point cloud. For example, the point cloud in this example is in “.ply” format, represented by ASCII code, with a total number of 207,242 points, and each point has three-dimensional position information XYZ and three-dimensional color information RGB.

The point cloud may express the spatial structures and the surface attributes of three-dimensional objects or three-dimensional scenarios flexibly and conveniently; moreover, since the point cloud is acquired by directly sampling real objects, the point cloud may provide a strong sense of reality under the premise of ensuring accuracy; and therefore, the point cloud is widely applied, and its application range includes virtual reality games, computer-aided design, geographic information systems, automatic navigation systems, digital cultural heritage, free-viewpoint broadcasting, three-dimensional immersive remote presentation, and three-dimensional reconstruction of biological tissues and organs or the like.

Acquisition approaches for the point cloud may include, but are not limited to, at least one of the following: (1) generated by a computer device, the computer device may generate the point cloud data based on virtual three-dimensional objects and virtual three-dimensional scenarios; (2) acquired by 3-Dimension (3D) laser scanning, where point cloud data of three-dimensional objects or three-dimensional scenarios of static real world may be acquired by the 3D laser scanning, and millions of point cloud data may be acquired per second; (3) acquired by 3D photogrammetry, where visual scenarios of real world are collected by a 3D photography device (i.e., a group of cameras or a camera device with multiple lenses and multiple sensors), to acquire point cloud data of the visual scenarios in real world, and point cloud data of three-dimensional objects or three-dimensional scenarios of dynamic real world may be acquired by 3D photography; or (4) point cloud data of biological tissues and organs acquired by a medical device, where in the medical field, the point cloud data of biological tissues and organs may be acquired by a medical device such as a magnetic resonance imaging (MRI),a computed tomography (CT), and an electromagnetic positioning system.

Point clouds may be classified into dense point clouds and sparse point clouds according to acquisition approaches.

The point clouds are classified into the following types according to a time series of the data:
first type: static point cloud, where an object is static, and a device for acquiring the point cloud is also static;
second type: dynamic point cloud, where an object is dynamic, but a device for acquiring the point cloud is static; and
third type: dynamically acquired point cloud, where a device for acquiring the point cloud is dynamic.

The point clouds may be classified into two types according to purposes:
type I: a machine perception point cloud, which may be used for scenarios such as, an autonomous navigation system, a real-time inspection system, a geographic information system, a visual sorting robot and a disaster relief robot; and
type II: a human eye perception point cloud, which may be used for point cloud application scenarios such as, digital cultural heritage, free viewpoint broadcasting, 3D immersive communication and 3D immersive interaction.

Through the above point cloud acquiring technologies, the cost and time period for acquiring the point cloud data are reduced and the accuracy of the data is improved. The change in the acquisition approaches for point cloud data makes it possible to acquire a large amount of point cloud data. However, with the growth of application demand, the processing of massive 3D point cloud data has encountered the bottleneck in storage space and transmission bandwidth limitation.

Taking a point cloud video with a frame rate of 30 frames per second (fps) as an example, the number of points of the point cloud per frame is 700,000, and each point has coordinate information xyz (float) and color information RGB (uchar); and thus, the data volume of a 10s point cloud video is approximately 0.7 million×(4 Byte×3+1 Byte×3)×30 fps×10 s=3.15 GB. For a two-dimensional video with a YUV sampling format of 4:2:0, a resolution of 1280×720 and a frame rate of 24 fps, the data volume of a 10 s video is approximately 1280×720×12 bit×24 frames×10 s≈0.33 GB, and the data volume of a 10 s three-dimensional video with two-viewpoints is approximately 0.33×2=0.66 GB. It can be seen that, for videos with the same length, the data volume of point cloud video is much larger than that of two-dimensional video or that of three-dimensional video. Therefore, in order to better realize data management, save server storage space and reduce the transmission traffic and transmission time between the server and the client, point cloud compression has become a key issue to promote the development of the point cloud industry.

Related knowledge of point cloud encoding and decoding is introduced below.

FIG. 3 is a schematic block diagram of a point cloud encoding and decoding system involved in an embodiment of the present disclosure. It is to be noted that FIG. 3 only illustrates an example, and the point cloud encoding and decoding system in the embodiments of the present disclosure includes but is not limited to that illustrated in FIG. 3. As illustrated in FIG. 3, the point cloud encoding and decoding system 100 includes an encoding device 110 and a decoding device 120. The encoding device is configured to encode (which may be understood as compress) the point cloud data to generate a bitstream, and transmit the bitstream to the decoding device. The decoding device is configured to decode the bitstream generated by the encoding device to obtain decoded point cloud data.

The encoding device 110 in the embodiments of the present disclosure may be understood as a device with a point cloud encoding function, and the decoding device 120 may be understood as a device with a point cloud decoding function. That is, in the embodiments of the present disclosure, the encoding device 110 and the decoding device 120 includes multiple types of devices, such as smartphones, desktop computers, mobile computing apparatuses, notebook (e.g., laptop) computers, tablet computers, set-top boxes, televisions, cameras, display devices, digital media players, point cloud game consoles, and vehicle-mounted computers.

In some embodiments, the encoding device 110 may transmit the encoded point cloud data (e.g., the bitstream) to the decoding device 120 via a channel 130. The channel 130 may include one or more media and/or apparatuses which are capable of transmitting the encoded point cloud data from the encoding device 110 to the decoding device 120.

In an instance, the channel 130 includes one or more communication media that enable the encoding device 110 to transmit the encoded point cloud data directly to the decoding device 120 in real time. In this instance, the encoding device 110 may modulate the encoded point cloud data according to a communication standard and transmit the modulated point cloud data to the decoding device 120. The communication medium includes a wireless communication medium, such as, a radio frequency spectrum. Optionally, the communication medium may also include a wired communication medium, such as, one or more physical transmission lines.

In another instance, the channel 130 includes a non-transitory storage medium, and the non-transitory storage medium may store the point cloud data encoded by the encoding device 110. The non-transitory storage medium includes a variety of locally accessible data storage media, such as an optical disk, a DVD, and a flash memory. In this instance, the decoding device 120 may acquire the encoded point cloud data from the non-transitory storage medium.

In yet another instance, the channel 130 may include a storage server, and the storage server may store the point cloud data encoded by the encoding device 110. In this instance, the decoding device 120 may download the encoded point cloud data stored in the storage server from the storage server. Optionally, the storage server may store the encoded point cloud data and transmit the encoded point cloud data to the decoding device 120, such as a web server (e.g., for a website), a file transfer protocol (FTP) server, or the like.

In some embodiments, the encoding device 110 includes a point cloud encoder 112 and an output interface 113. The output interface 113 may include a modulator/demodulator (modem) and/or a transmitter.

In some embodiments, the encoding device 110 may further include a point cloud source 111 in addition to the point cloud encoder 112 and the output interface 113.

The point cloud source 111 may include at least one of: a point cloud collection apparatus (e.g., a scanner), a point cloud archive, a point cloud input interface, or a computer graphics system, where the point cloud input interface is used to receive point cloud data from a point cloud content provider, and the computer graphics system is used to generate the point cloud data.

The point cloud encoder 112 encodes the point cloud data from the point cloud source 111 to generate a bitstream. The point cloud encoder 112 transmits the encoded point cloud data directly to the decoding device 120 via the output interface 113. The encoded point cloud data may also be stored in a non-transitory storage medium or a storage server for subsequent reading by the decoding device 120.

In some embodiments, the decoding device 120 includes an input interface 121 and a point cloud decoder 122.

In some embodiments, the decoding device 120 may further include a display apparatus 123 in addition to the input interface 121 and the point cloud decoder 122.

The input interface 121 includes a receiver and/or a modem. The input interface 121 may receive the encoded point cloud data through the channel 130.

The point cloud decoder 122 is used to decode the encoded point cloud data to obtain decoded point cloud data, and transmit the decoded point cloud data to the display apparatus 123.

The display apparatus 123 displays the decoded point cloud data. The display apparatus 123 may be integrated with the decoding device 120 or external to the decoding device 120. The display apparatus 123 may include a variety of display apparatuses, such as a liquid crystal display (LCD), a plasma display, an organic light emitting diode (OLED) display, or other types of display devices.

In addition, FIG. 3 only illustrates an example, and the technical solution of the embodiments of the present disclosure is not limited to FIG. 3. For example, the technology of the present disclosure may also be applied to unilateral point cloud encoding or unilateral point cloud decoding.

The current point cloud encoder may adopt two point cloud compression coding technology routes proposed by the Moving Picture Experts Group (MPEG) of the international standards organization, namely Video-based Point Cloud Compression (VPCC) and Geometry-based Point Cloud Compression (GPCC). The VPCC projects a 3D point cloud into 2D and encodes a projected 2D picture using existing 2D coding tools. The GPCC partitions a point cloud into multiple units step by step using a hierarchical structure and encodes the entire point cloud by encoding and recording the partitioning process.

The point cloud encoder and the point cloud decoder applicable to the embodiments of the present disclosure are described below by taking the GPCC encoding and decoding framework as an example.

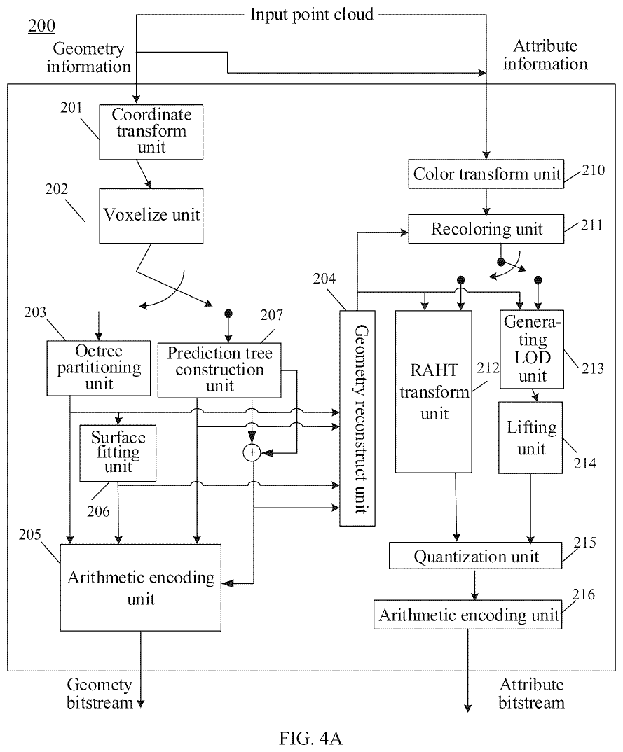

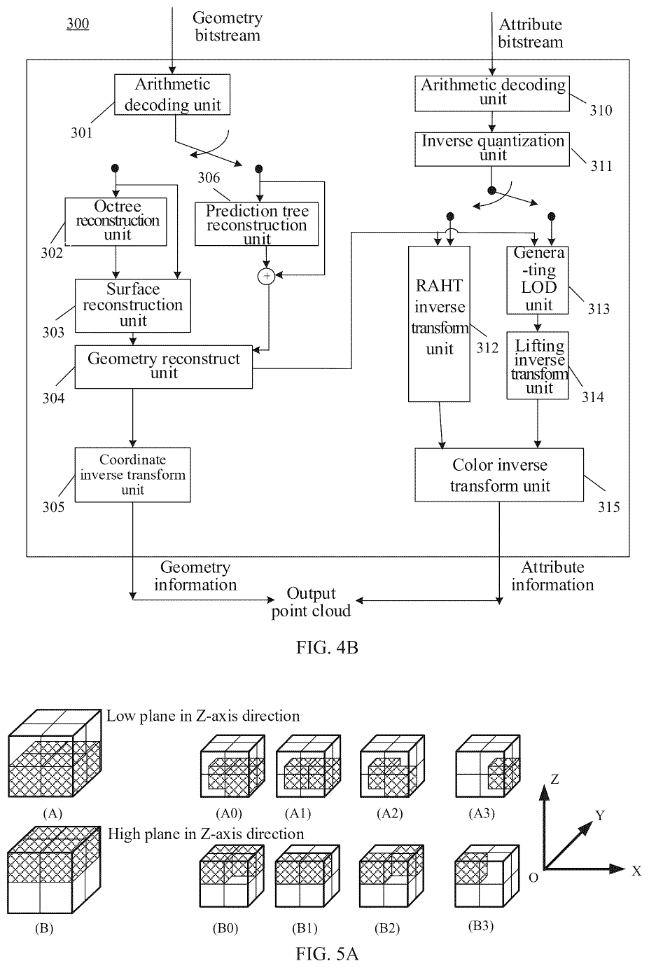

FIG. 4A is a schematic block diagram of a point cloud encoder provided by an embodiment of the present disclosure.

As can be seen from the above, a point in the point cloud may include position information of the point and attribute information of the point. Therefore, the encoding of the point in the point cloud mainly includes position encoding and attribute encoding. In some examples, the position information of the point in the point cloud is also referred to as geometry information; and correspondingly, the position encoding of the point in the point cloud may also be referred to as geometric encoding.

In the GPCC encoding framework, the geometry information of the point cloud and the corresponding attribute information of the point cloud are encoded separately.

As illustrated in FIG. 4A below, the current G-PCC geometric encoding and decoding may be classified into octree-based geometric encoding and decoding and predictive tree-based geometric encoding and decoding.

A process of the position encoding includes: performing preprocessing (e.g., coordinate transform, quantization, and removal of duplicate points) on the points in the point cloud; and then, performing geometric encoding on the preprocessed point cloud, e.g., constructing an octree or constructing a predictive tree, and performing geometric encoding on the constructed octree or predictive tree to form a geometry bitstream. At the same time, based on the position information output by the constructed octree or predictive tree, position information of each point in the point cloud data is reconstructed to obtain a reconstructed value of the position information of each point.

A process of the attribute encoding includes: selecting one of three prediction modes to perform point cloud prediction through given reconstructed information of position information and an original value of attribute information of an input point cloud, quantizing the predicted result, and performing arithmetic encoding to form an attribute bitstream.

As illustrated in FIG. 4A, the position encoding may be implemented by the following units:
a coordinate transform (transform coordinates) unit 201, a voxelize unit 202, an octrec partitioning (analyze octrec) unit 203, a geometry reconstruct (reconstruct geometry) unit 204, an arithmetic encode unit 205, a surface fitting (analyze surface approximation) unit 206, and a predictive tree construction unit 207.

The coordinate transform unit 201 may be used to transform world coordinates of a point in the point cloud into relative coordinates. For example, subtracting the minimum values of the xyz-coordinate axis from geometry coordinates of the point respectively is equivalent to a direct current removal operation, to implement the transform of the coordinates of the point in the point cloud from the world coordinates to the relative coordinates.

The voxelize unit 202 is also referred to as a quantize and remove duplicate points (quantize and remove points) unit; the number of coordinates may be reduced through quantization; after quantization, originally different points may be assigned the same coordinates; and based on which, duplicate points may be removed through a deduplication operation. For example, multiple clouds with the same quantized position and different pieces of attribute information may be merged into one cloud by attribute transform. In some embodiments of the present disclosure, the voxelize unit 202 is an optional unit module.

The octree partitioning unit 203 may encode the position information of the quantized points using an octree coding manner. For example, the point cloud is partitioned in an octrec form, so that positions of the points in the point cloud may be in one-to-one correspondence with positions of the octree. By counting the positions in the octree that contain points and marking their flags as 1, the geometric encoding is performed.

In some embodiments, in a process of geometry information encoding based on trianglesoup (trisoup), octree partitioning is also performed on the point cloud through the octree partitioning unit 203. However, different from the manner of the octree-based geometry information encoding, the trisoup does not need to partition the point cloud into unit cubes with a side length of 1×1×1 step by step, but stops partitioning once there exists a block (sub-block) with a side length of W. Based on a surface formed by the distribution of the point cloud in each block, at most twelve vertices (intersections) generated by the surface and the twelve edges of the block are obtained; surface fitting is performed on the vertices by the surface fitting unit 206; and the geometric encoding is performed on the fitted vertices.

The predictive tree construction unit 207 may encode the position information of the quantized points using a predictive tree encoding manner. For example, the point cloud is partitioned in a prediction tree form, so that the positions of the point in the point cloud may be in one-to-one correspondence with the positions of nodes in the predictive tree. By counting the positions in the prediction tree that have points, the geometry position information of the nodes is predicted by selecting different prediction modes to obtain prediction residuals; and the geometry prediction residuals are quantized using a quantization parameter. Finally, through continuous iteration, the prediction residuals of the predictive tree node position information, the structure of the predictive tree and the quantization parameter are encoded to generate a binary bitstream.

The geometry reconstruct unit 204 may perform position reconstruction based on the position information output by the octree partitioning unit 203 or the vertices fitted by the surface fitting unit 206 to obtain the reconstructed value of the position information of each point in the point cloud data. Alternatively, position reconstruction is performed based on the position information output by the predictive tree construction unit 207 to obtain the reconstructed value of the position information of each point in the point cloud data.

The arithmetic encode unit 205 may perform, by using an entropy coding manner, arithmetic encoding on encode the position information output by the octree partitioning (analyze octrec) unit 203 or the vertices fitted by the surface fitting unit 206 or the geometry prediction residual values output by the predictive tree construction unit 207, to generate a geometry bitstream; where the geometry bitstream may also be referred to as a geometry bit stream.

The attribute encoding may be implemented by the following units:
a color transform (transform colors) unit 210, a recoloring (transfer attributes) unit 211, a region adaptive hierarchical transform (RAHT) unit 212, a generate LOD unit 213, a lifting (lifting transform) unit 214, a quantization unit 215, and an arithmetic encode unit 216.

It is to be noted that a point cloud encoder 200 may include more, fewer or different functional components than those illustrated in FIG. 4A.

The color transform unit 210 may be used to transform an RGB color space of the points in the point cloud into a YCbCr format or other formats.

The recoloring unit 211 performs recoloring on color information using the reconstructed geometry information, so that the uncoded attribute information corresponds to the reconstructed geometry information.

After an original value of the attribute information of the point is obtained through transformation by the recoloring unit 211, any one of the transform units may be selected to transform the point in the point cloud. The transform units may include the RAHT transform unit 212 and the lifting (lifting transform) unit 214. The lifting transform depends on generating a level of detail (LOD).

Any one of the RAHT transform and the lifting transform may be understood as being used to predict the attribute information of the point in the point cloud to obtain a prediction value of the attribute information of the point, and then to obtain a residual value of the attribute information of the point based on the prediction value of the attribute information of the point. For example, the residual value of the attribute information of the point may be obtained by subtracting the prediction value of the attribute information of the point from the original value of the attribute information of the point.

In an embodiment of the present disclosure, a process of generating an LOD by the LOD generate unit includes: obtaining Euclidean distances between points according to the position information of the points in the point cloud; and partitioning the points into different detail expression levels according to the Euclidean distances. In an embodiment, after the Euclidean distances are sorted, Euclidean distances in different ranges may be partitioned into different detail expression levels. For example, a point may be randomly selected as a first detail expression level. Then, Euclidean distances between remaining points and the point are calculated, and points whose Euclidean distances meet a first threshold requirement are partitioned as a second detail expression level. A centroid of the points in the second detail expression level is obtained, Euclidean distances between points other than the first and second detail expression levels and the centroid are calculated, and points whose Euclidean distance meet a second threshold are partitioned as a third detail expression level; and so forth, all points are partitioned into the detail expression levels. By adjusting a threshold of Euclidean distance, the number of points in each LOD level may be increased. It is to be understood that the LOD partitioning manner may also be performed using other manners, which is not limited in the present disclosure.

It is to be noted that the point cloud may be directly partitioned into one or more detail expression levels, or the point cloud may be first partitioned into multiple point cloud slices, and then each point cloud slice may be partitioned into one or more LOD levels.

For example, the point cloud may be partitioned into multiple point cloud slices, and the number of points in each point cloud slice may be in a range between 550,000 and 1.1 million. Each point cloud slice may be considered as a separate point cloud. Each point cloud slice may be partitioned into multiple detail expression levels, and each detail expression level includes multiple points. In an embodiment, the detail expression level may be partitioned according to Euclidean distances between the points.

The quantization unit 215 may be used to quantize the residual value of the attribute information of the point. For example, in a case where the quantization unit 215 is connected to the RAHT transform unit 212, the quantization unit 215 may be used to quantize the residual value of the attribute information of the point output by the RAHT transform unit 212.

The arithmetic encode unit 216 may perform entropy encoding on the residual value of the attribute information of the point using zero run length coding, to obtain an attribute bitstream. The attribute bitstream may be bitstream information.

FIG. 4B is a schematic block diagram of a point cloud decoder provided by an embodiment of the present disclosure.

As illustrated in FIG. 4B, the decoder 300 may obtain a point cloud bitstream from an encoding device, and obtain position information and attribute information of a point in the point cloud by parsing the bitstream. Decoding of the point cloud includes position decoding and attribute decoding.

A process of the position decoding includes: performing arithmetic decoding on a geometry bitstream; performing merge after constructing an octree, and reconstructing the position information of the point to obtain reconstructed information of the position information of the point; and performing coordinate transformation on the reconstructed information of the position information of the point to obtain the position information of the point. Position information of a point may also be referred to as geometry information of the point.

A process of the attribute decoding includes: obtaining a residual value of the attribute information of the point in the point cloud by parsing an attribute bitstream; obtaining an inverse-quantized residual value of the attribute information of the point by performing inverse quantization on the residual value of the attribute information of the point; selecting, based on the reconstruction information of the position information of the point obtained in the process of the position decoding, one of the RAHT inverse transform and the lifting inverse transform to perform point cloud prediction to obtain a prediction value, and adding the prediction value to the residual value to obtain a reconstructed value of the attribute information of the point; and performing color space inverse transformation on the reconstructed value of the attribute information of the point to obtain a decoded point cloud.

As illustrated in FIG. 4B, the position decoding may be implemented by the following units:
an arithmetic decoding unit 301, an octree reconstruct (synthesize octree) unit 302, a surface reconstruct (synthesize surface approximation) unit 303, a geometry reconstruct (reconstruct geometry) unit 304, a coordinate inverse transform (inverse transform coordinates) unit 305 and a predictive tree reconstruct unit 306.

The attribute decoding may be implemented by the following units:
an arithmetic decoding unit 310, an inverse quantize unit 311, an RAHT inverse transform unit 312, a generate LOD unit 313, an inverse transform (inverse lifting) unit 314, and a color inverse transform (inverse transform colors) unit 315.

It should be noted that decompression is an inverse process of compression. Similarly, as for functions of all units in the decoder 300, reference may be made to the functions of the corresponding units in the encoder 200. In addition, the point cloud decoder 300 may include more, fewer, or different functional components than those illustrated in FIG. 4B.

For example, the decoder 300 may partition the point cloud into multiple LODs based on Euclidean distances between points in the point cloud, and decode attribute information of the points in the LODs in turn, e.g., compute the number of zeros (zero_cnt) in a zero-run encoding technique to decode a residual based on zero_cnt. Then, a decoding architecture may perform inverse quantization based on the decoded residual value, and obtain a reconstructed value of the point cloud by adding an inverse-quantized residual value to a prediction value of a current point, until all point clouds are decoded. The current point will serve as the nearest neighbor point to points in a subsequent LOD, and attribute information of the subsequent points will be predicted using the reconstructed value of the current point.

The above is a basic process of the point cloud encoder and decoder based on the GPCC encoding and decoding architecture. With the development of technology, some modules or steps of the architecture or process may be optimized. The present disclosure is applicable to the basic process of the point cloud encoder and decoder based on the GPCC encoding and decoding architecture, but is not limited to the architecture and process.

Next, the octree-based geometric encoding and the prediction tree-based geometric encoding are introduced below.

The octree-based geometric encoding includes the following steps. First, coordinate transform is performed on the geometry information, so that all point clouds are included in a Bounding Box. Then, quantization is performed, and the process of quantization mainly plays the role of scaling. Due to quantization and rounding, the geometry information of part of points is the same, it is determined whether to remove duplicate points based on parameters, and the process of quantization and removal of duplicate points is also referred to as voxelization process. Next, tree partitioning (e.g., octree, quadtree, binary tree) is performed on the Bounding Box continually in the order of breadth-first traversal, and the occupancy code of each node is encoded. In an implicit geometry partitioning method. First, the bounding box of the point cloud (2^{d}, 2^{d}, 2^{d}) is calculated; and assuming that dₓ>d_{y}>d_{z}, the bounding box corresponds to a cuboid. During geometry partitioning, binary tree partitioning is performed first based on the x-axis to obtain two child nodes; binary tree partitioning continues until the condition of dₓ=d_{y}>d_{z} is met, quadtree partitioning is performed continually based on the x and y axes to obtain four child nodes; and then, when the condition of dₓ=d_{y}=d_{z} is met, octrec partitioning is performed continually until the leaf node obtained through partitioning is a unit cube with a size of 1×1×1, at which the partitioning operation terminates. After that, the points in the leaf nodes are encoded to generate a binary bitstream. During the process of binary tree/quadtree/octrec-based partitioning, two parameters, K and M, are introduced. Parameter K indicates the maximum number of binary tree/quadtree partitionings before octree partitioning is performed; and parameter M is used to indicate that the side length of the corresponding minimum block is 2^{M} when binary tree/quadtree partitioning is performed. At the same time, K and M must meet the condition: assuming that dₘₐₓ=max(dₓ,d_{y},d_{z}),dₘᵢₙ=min(dₓ,d_{y},d_{z}), parameter K meets the condition of K>=dₘₐₓ−dₘᵢₙ; and parameter M meets the condition of M>=dₘᵢₙ. The reason why parameters K and M meet the above conditions is that, during the current process of G-PCC geometry implicit partitioning, the priority of the partitioning manners is binary tree, quadtree and octree. Only when the block size of the node does not meet the condition of binary tree/quadtree, octree partitioning will be performed on the node until the minimum unit of the partitioned leaf node has a size of 1×1×1.

The octree-based geometry information encoding mode may effectively encode the geometry information of the point cloud by utilizing the correlation between neighboring points in space. However, for some relatively planar nodes or nodes with planar characteristics, the coding efficiency of the geometry information of point cloud may be further improved by utilizing the planar coding.

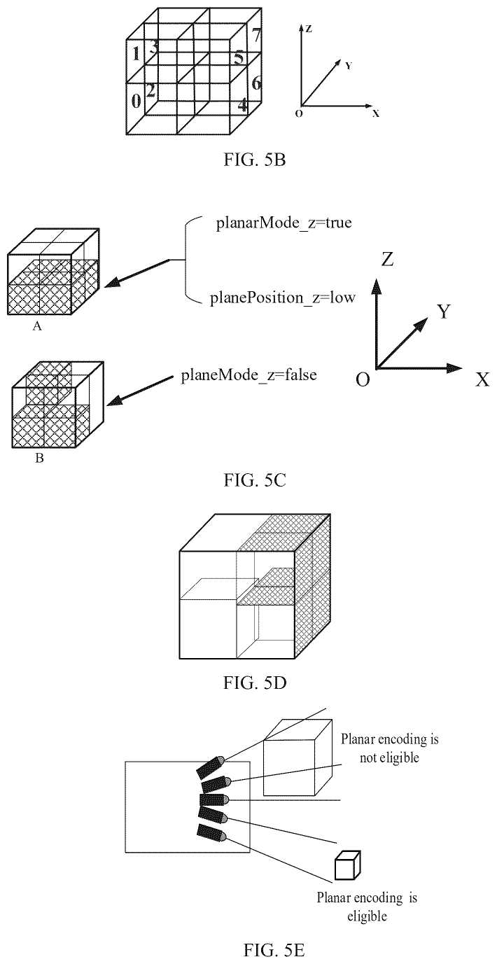

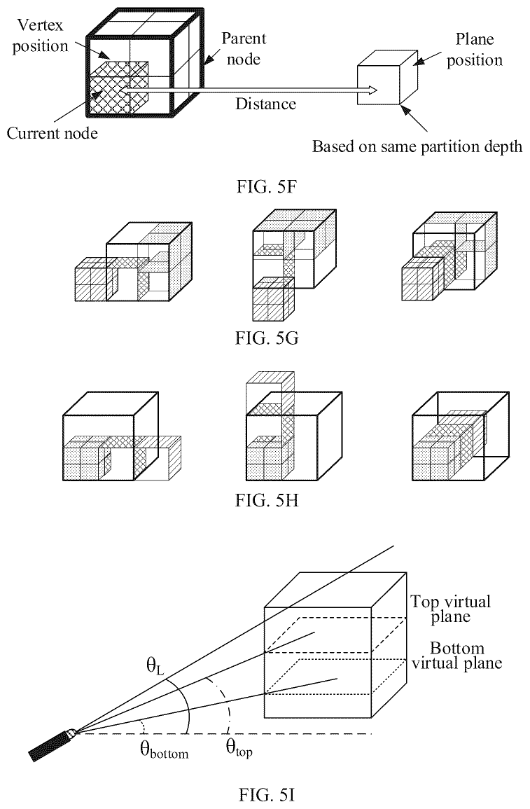

For example, as illustrated in FIG. 5A, (A) series belongs to a low plane position in a Z-axis direction, and (B) series belongs to a high plane position in the Z-axis direction. Taking (A) as an example, it can be seen that the four occupied child nodes of the current node are all located in the low plane positions of the current node in the Z-axis direction. Therefore, it may be considered that the current node belongs to a Z plane and is a low plane in the Z-axis direction. Similarly, (B) indicates that the occupied child nodes of the current node are located in the high plane positions of the current node in the Z-axis direction.

Taking (A) as an example, the octree encoding and the planar encoding are compared in terms of efficiency. As illustrated in FIG. 5B, if an octree encoding manner is used for (A) in FIG. 5A, occupancy information of the current node is represented as: 11001100. Whereas if a planar encoding manner is used, first, an identifier needs to be encoded to represent that the current node is a plane in the Z axis direction; second, if the current node is a plane in the Z axis direction, the planar position of the current node needs to be represented; and then only occupancy information of low planar nodes in the Z axis direction needs to be encoded (e.g., occupancy information of four child nodes 0246). Therefore, based on the planar encoding manner, only 6 bits are needed to encode the current node, which may reduce 2 bits of representation compared to the original octree encoding. Based on this analysis, the planar encoding has more significant encoding efficiency than the octree encoding. Therefore, for an occupied node, if the planar coding is used for encoding in a certain dimension, as illustrated in FIG. 5C, first, planar flag (planarMode) information and planar position (PlanePos) information of the current node in this dimension need to be represented, and then occupancy information of the current node is encoded based on planar information of the current node. It will be noted that: for PlaneModei (i is equal to 0, 1 or 2): 0 represents that the current node is not a plane in an i-axis direction. In a case where the node is a plane in the i-axis direction, for PlanePositioni: 0 represents that the current node is a plane in the i-axis direction, and its planar position is a low plane, 1 represents that the current node is a high plane in the i-axis direction. For example, i=0 represents the X axis, i=1 represents the Y axis, and i=2 represents the Z axis.

In the current GPCC standard, a determination of whether a node meets conditions for the planar encoding, and predictive encoding of planar flag and planar position information of the node in a case where the current node meets the conditions for the planar encoding, are introduced in detail below.

In the current G-PCC standards, there are three types of determination condition for determining whether a node meets planar coding, which are described in detail below.

The first type: the determination is performed according to a plane probability of the node in each dimension.

First, a local node density (local_node_density) of the current node and a probability of the current node Prob(i) in each dimension are determined.

When the local_node_density of the node is less than a threshold Th (Th=3), the plane probabilities of the current node in three coordinate dimensions Prob(i) are compared with thresholds Th0, Th1 and Th2, where Th0<Th1<Th2 (Th0=0.6, Th1=0.77 and Th2=0.88). Hereafter, Eligible; (i=0, 1, 2) is used to represent whether the planar coding is enabled in each dimension, the determination process of Eligible; is shown in formula (1). For example, if Eligiblei>=threshold, it indicates that planar coding is enabled in the i-th dimension:

$${Eligible}_{i} = Prob ( i ) >= threshold \qquad ( 1 )$$

It is to be noted that the thresholds is adaptively changed. For example, when Prob(1) is greater than Prob(0) and less than Prob(2) (i.e., Prob(0)>Prob(1)>Prob(2)), a value of the threshold is as shown in formula (2)):

$${Eligible}_{0} = Prob ( 0 ) >= Th 0 \qquad ( 2 )$$

$${Eligible}_{1} = Prob ( 1 ) >= Th 1$$

$${Eligible}_{2} = Prob ( 2 ) >= Th 2$$

The update process of local_node_density and the updating of Prob(i) are described below.

In an example, Prob(i) is updated as the following formula (3):

$${Prob ( i )}_{n e w} = ( Lx Prob ( i ) + δ ( coded node ) ) / L + 1 \qquad ( 3 )$$

Where L is equal to 255 (L=255). When the coded node is a plane, δ(coded node) is 1; otherwise, δ(coded node) is 0.

In an example, local_node_density is updated as the following formula (4):

$$local\_node {\_density}_{new} = local\_node \_density + 4 * numSiblings \qquad ( 4 )$$

Where local_node_density is initialized to 4, and numSiblings is the number of sibling nodes of the node. As illustrated in FIG. 5D, in a case where the current node is a left node and the right nodes are siblings of the current node, the number of the siblings of the current node is 5 (including the current node itself).

The second type: it is determined whether the nodes in the current level (or referred to as layer) meet planar coding according to the point cloud density of the current level.

The density of points in the current level is used to determine whether to perform planar coding on the nodes in the current level. Assuming that the number of points in the current to-be-encoded point cloud is pointCount, and the number of points reconstructed after IDCM encoding is numPointCountRecon. Because octree coding is performed based on the order of breadth-first traversal, the number of nodes to be encoded in the current level is assumed to be nodeCount; and then the determination of whether planar coding is enabled on the current level is assumed to be planarEligibleKOctreeDepth. Where the determination process of planarEligibleKOctreeDepth is shown in formula (5):

$$planarEligibleKOctreeDepth = ( pointCount - numPointCountRecon ) < nodeCount * 1.3 \qquad ( 5 )$$

When planarEligibleKOctrecDepth is true, planar coding is performed on all nodes in the current level; otherwise, planar coding is not performed on all nodes in the current level, and octree coding is adopted only.

The third type: it is determined whether the current node meets planar coding according to a collection parameter of a laser radar point cloud.

As illustrated in FIG. 5E, it may be seen that a node of large cube at top is passed through by two lasers simultaneously, so the current node is not a plane in a direction perpendicular to the Z axis, and a node of small cube at bottom is small enough that it cannot be passed through by two nodes simultaneously, so the current node is likely to be a plane. Therefore, whether the current node meets the planar encoding is determined based on the number of lasers corresponding to the current node.

For a node meeting the condition for planar coding, predictive coding on the planar flag information and the plane position information are introduced below.

### I. Predictive Coding of the Planar Flag Information

At present, the planar flag information is encoded using three contexts. That is, the context is designed separately for planar representations in each dimension.

Encoding of planar position information of non-lidar point clouds and encoding of planar position information of laser radar point clouds are introduced separately below.

### I. Encoding of the Planar Position Information of the Non-Lidar Point Clouds

### 1. Predictive Coding of the Plane Position Information

The predictive coding is performed on the plane position information based on the following information:
(1) the plane position information of the current node obtained by using the occupancy information of neighborhood nodes for prediction, the plane position information being three elements: predicted as a low plane, predicted as a high plane or unpredictable;
(2) the spatial distance between a node at the same partitioning depth and the same coordinate as the current node and the current node: “near” or “far”;
(3) a planar position of a node at the same partition depth and the same coordinate as the current node; and
(4) coordinate dimension (i=0, 1, 2).

As illustrated in FIG. 5F, the current node to be encoded is a left node, a neighborhood node is searched for as a right node at the same octree partition depth level and the same vertical coordinate, a distance between those two nodes is determined as “near” or “far”, with reference to the planar position of the node.

In an example, as illustrated in FIG. 5G, a node filled with gridding is the current node; and if the current node is located at a low plane of a parent node, the planar position of the current node is determined in manners as follows.

a) If any one of child nodes 4 to 7 of a node filled with slashes is occupied, and all nodes filled with points are not occupied, there is a high probability that there is a plane in the current node, and the plane position is located lower.

b) If none of the child nodes 4 to 7 of the node filled with slashes is occupied, and any node filled with points are occupied, there is a high probability that there is a plane in the current node, and the plane position is located higher.

c) If all the child nodes 4 to 7 of the node filled with slashes are empty nodes, and all the nodes filled with points are empty nodes, the plane position cannot be inferred and is therefore marked as unknown.

d) If any one of the child nodes 4 to 7 of the node filled with slashes is occupied, and any one of the nodes filled with points is occupied, the plane position still cannot be inferred and is therefore marked as unknown.

In another example, as illustrated in FIG. 5H, a black node is the current node; and if the current node is located at a high planar position of a parent node, the planar position of the current node is determined in manners as follows.

a) If any one of child nodes 4 to 7 of a node filled with points is occupied, and a node filled with slashes is not occupied, there is a high probability that there is a plane in the current node, and the plane position is located lower.

b) If the child nodes 4 to 7 of the node filled with points are not occupied, and the node filled with slashes is occupied, there is a high probability that there is a plane in the current node, and the plane position is located higher.

c) If all the child nodes 4 to 7 of the node filled with points are not occupied, and the node filled with slashes is not occupied, the plane position cannot be inferred and is therefore marked as unknown.

d) If any one of the child nodes 4 to 7 of the node filled with points is occupied, and the node filled with slashes is occupied, the plane position cannot be inferred and is therefore marked as unknown.

### II. Encoding of the Planar Position Information of Laser Radar Point Clouds

FIG. 5I illustrates the predictive encoding of the planar position information of the laser radar point cloud. The planar position of the current node is predicted by using parameters collected by a laser radar, and the position is quantized into four intervals by using positions of intersection of the current node and laser rays, which finally serve as the context of the planar position of the current node. A specific calculation process is the following: assuming that coordinates of the laser radar are (x_{Lidar}, y_{Lidar}, z_{Lidar}) and geometric coordinates of the current point are (x, y, z), a vertical tangent value tan [symbol] θ of the current point relative to the laser radar is first calculated, with the calculation process shown in formula (6):

$$tan θ = \frac{z - {z}_{Lidar}}{\sqrt{{( x - {x}_{Lidar} )}^{2} + {( y - {y}_{Lidar} )}^{2}}} \qquad ( 6 )$$

In addition, since each laser has a certain offset angle relative to the laser radar, a relative tangent value tan θ_{corr,L} of the current node relative to the laser is calculated, with the specific calculation process shown in formula (7):

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 7 )$$

Finally, the planar position of the current node is predicted by using a corrected tangent value of the current node. Specifically, assuming that a tangent value of a lower boundary of the current node is tan(θ bottom), and a tangent value of an upper boundary is tan(θ top), the planar position is quantized into 4 quantization intervals based on tan θ_{corr,L}, i.e., the context of the planar position.

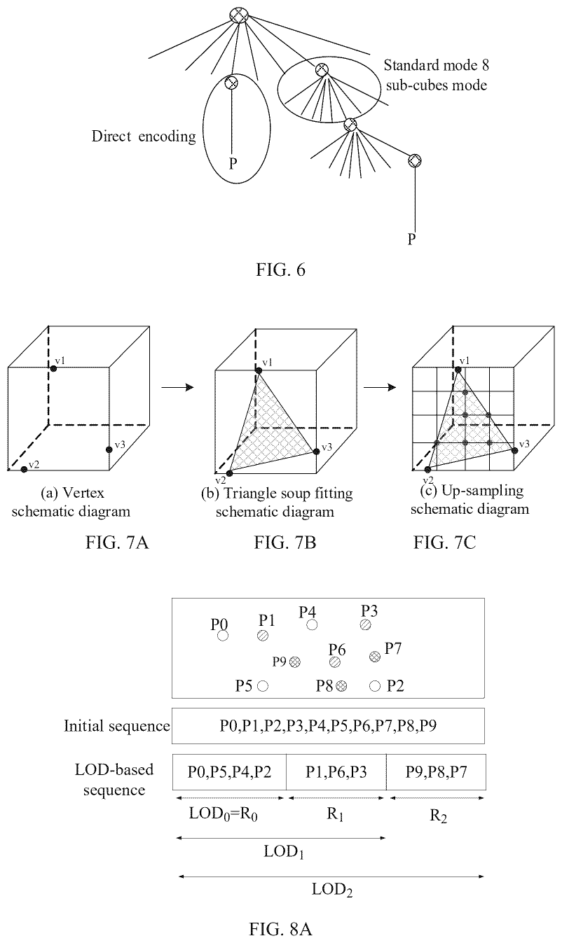

However, the octree-based geometry information encoding mode only has an efficient compression rate for points that are correlated in space. For points that are isolated in the geometric space, use of the direct coding model (DCM) may greatly reduce complexity. For all nodes in the octree, use of DCM is not represented by flag information, but is inferred from the parent node and neighboring information of the current node. There are three manners to determine whether the current node is eligible for the DCM encoding, as illustrated in FIG. 6.

(1) The current node has no sibling child nodes, that is, the parent node of the current node has only one child node, and the parent node of the parent node of the current node has only two occupied child nodes, that is, the current node has at most one neighboring node.

(2) The parent node of the current node has only one occupied child node (i.e., the current node); and the six neighboring nodes that share a face with the current node also belong to empty nodes.

(3) The number of sibling nodes of the current node is greater than 1.

If the current node is not eligible for DCM encoding, octree partitioning will be performed on the current node. If the current node is eligible for DCM encoding, the number of points included in the node will be further determined. When the number of points is less than a threshold (e.g., 2), DCM encoding will be performed on the node, otherwise, octree partitioning will continue to be performed on the node. When the DCM coding mode is applied, it is necessary to encode whether the current node is a real isolated point firstly, i.e., IDCM_flag. When IDCM_flag is true, the current node adopts DCM encoding, otherwise, it is still adopts octree coding. When the current node meets the condition for DCM encoding, it is necessary to encode the DCM coding mode of the current node. At present, there are two DCM modes, which are: (1) existing only one point (or multiple points, but they are duplicate points); and (2) containing two points. Finally, it is necessary to encode the geometry information of each point. Assuming that a side length of the node is 2^{d}, d bits are required to encode each component of the geometry coordinates of the node, and this bit information is directly encoded into the bitstream. It is to be noted here that when encoding is performed on the laser radar point cloud, predictive coding is performed on the coordinate information with three dimensions by using the laser radar acquisition parameters, thereby further improving the coding efficiency of the geometry information.

It is also to be noted that when a node is partitioned into leaf nodes, under geometry lossless encoding, the number of duplicate points in the leaf nodes needs to be encoded. Finally, the occupancy information of all nodes is encoded to generate a binary bitstream. In addition, a planar coding mode is introduced in G-PCC currently. During the process of geometry partitioning, it will be determined whether the child nodes of the current node are co-planar. If the child nodes of the current node meet the condition for co-planar, the child nodes of the current node will be represented by the plane.

For the octree-based geometric decoding, before decoding the occupancy information of each node, a decoding side will first determine, in the order of breadth-first traversal, whether to perform the planar decoding or the IDCM decoding on the current node by using the reconstructed geometry information. If the current node meets a condition for the planar decoding, the decoding side will first decode the planar flag and planar position information of the current node, and then decode the occupancy information of the current node based on the planar information. If the current node meets a condition for the IDCM decoding, the decoding side will first decode whether the current node is a true IDCM node; and if the current node is a true IDCM node, the decoding side will continue to parse the DCM decoding mode of the current node, and then the decoding side may obtain the number of points in the current DCM node and finally decode the geometry information of each point. For a node that does not meet either the planar decoding or the DCM decoding, the occupancy information of the current node will be decoded. By continuously parsing in this manner, an occupancy code of each node is obtained, and the partitioning is continued for the nodes in turn until unit cubes of 1×1×1 are obtained. The number of points included in each leaf node is parsed, and geometric reconstruction point cloud information is restored finally.

In a geometry information encoding architecture based on trisoup (triangle soup), similarly, geometric partitioning is also performed first. However, unlike the binary tree/quadtree/octree-based geometry information encoding, this method does not need to partition the point cloud into unit cubes with side lengths of 1×1×1 step by step, but stops partitioning once there exist blocks (sub-blocks) with a side length of W. Based on a surface formed in each block by the distribution of the point cloud, at most twelve vertices (intersections) generated by this surface and twelve sides of the block are obtained. Vertex coordinates of each block are encoded in turn to generate a binary bitstream.

For trisoup-based point cloud geometry information reconstruction, in response to performing the point cloud geometry information reconstruction, the decoding side first decodes the vertex coordinates to complete triangle soup reconstruction, a process of which is illustrated in FIG. 7A to FIG. 7C. There are three vertices (v1, v2, v3) in a block illustrated in FIG. 7A, and the triangle soup, i.e., trisoup, formed by these three vertices in a certain order is illustrated in FIG. 7B. Afterwards, sampling is performed on the triangle soup to obtain sampling points, which will serve as a reconstructed point cloud within the block, as illustrated in FIG. 7C.

The predictive tree-based geometric encoding includes steps as follows. First, an input point cloud is sorted, and the sorting methods currently used include unordered, Morton order, azimuth order, and radial distance order. An encoding side establishes a prediction tree structure by using two different manners including a high-latency slow mode (KD-Trec), and a low-latency fast mode in which each point is assigned to a different laser by using laser radar calibration information, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream.

For the predictive tree-based geometry decoding, the decoding side reconstructs the prediction tree structure by continuously parsing the bitstream, and then obtains the prediction residual information of the geometric position and a quantization parameter of each prediction node through parsing, and performs inverse quantization on the prediction residual for recovering, so as to obtain the reconstructed geometric position information of each node, and finally completes the geometric reconstruction on the decoding side.

The geometry information is reconstructed after the geometric encoding is completed. Currently, attribute encoding is mainly performed on color information. First, the color information is transformed from an RGB color space to a YUV color space. The point cloud is then recolored by using the reconstructed geometry information, to enable unencoded attribute information to correspond to the reconstructed geometry information. In color information encoding, there are two main transformation manners: one is distance-based lifting transformation that relies on LOD (level of detail) partitioning, and the other is that RAHT (Region Adaptive Hierarchal Transform) transformation is performed directly. Both manners can transform the color information from a spatial domain to a frequency domain, a high-frequency coefficient and a low-frequency coefficient are obtained through the transformation, and finally the coefficients are quantized and encoded to generate a binary bitstream.

When the attribute information is predicted by using the geometry information, Morton code may be used for performing nearest neighbor search, where the Morton code corresponding to each point in the point cloud may be obtained from geometric coordinates of this point. A specific method for calculating the Morton code is described below. For a three-dimensional coordinate with each component represented by a d-bit binary value, its three components may be represented as formula (8):

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} , \qquad ( 8 )$$

Where [symbol] ∈{0,1} are binary values corresponding to bits, from the highest ( [symbol] =1) to the lowest ( [symbol] =d), of x, y, z, respectively. For x, y, z, starting from the highest bit, [symbol] are crosswise arranged in e-quaintance by using the Morton code M up to the lowest bit. Calculation formula of M is shown in formula (9):

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 9 )$$

Where m_{l′}∈{0, 1} are values of M from the highest bit ( [symbol] =1) to the lowest bit ( [symbol] =3d). After the Morton code M of each point in the point cloud is obtained, the points in the point cloud are arranged in order of Morton code in an ascending order, and a weight value w of each point is set to 1.

There are 4 general test conditions for GPCC:
Condition 1: geometry positions with limited loss, and attributes with loss;
Condition 2: geometry positions lossless, but attributes with loss;
Condition 3: geometry positions lossless, and attributes with limited loss; and
Condition 4: geometry positions lossless, and attributes lossless.

The general test sequence includes four categories: Cat1A, Cat1B, Cat3-fused and Cat3-frame. Cat3-frame point cloud only includes reflectance attribute information, Cat1A and Cat1B point clouds only include color attribute information, and Cat3-fused point cloud includes both color and reflectance attribute information.

There are two technical routes for GPCC, which are distinguished by the algorithm used for geometry compression and classified into an octree coding branch and a predictive tree coding branch.

In the octree coding branch, at the encoding side, a bounding box is continuously partitioned into sub-cubes; and partitioning is continued for non-empty sub-cubes (including points in the point cloud) until leaf nodes obtained by partitioning are unit cubes of 1×1×1. In a case of geometric lossless encoding, the number of points included in the leaf node needs to be encoded to finally complete the encoding of the geometric octree and generate the binary bitstream. At the decoding side, the decoding side obtains, in the order of breadth-first traversal, an occupancy code of each node by continuous parsing, and the partitioning is continued for the nodes in turn until unit cubes of 1×1×1 are obtained. In the case of the geometric lossless decoding, the number of points included in each leaf node needs to be parsed, and the geometric reconstruction point cloud information is restored finally.

In the predictive tree coding branch, at the encoding side, a prediction tree structure is established by using two different manners including a high-latency slow mode (KD-Trec), and a low-latency fast mode in which each point is assigned into a different laser by using laser radar calibration information, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream. At the decoding side, the decoding side reconstructs the prediction tree structure by continuously parsing the bitstream, and then obtains the prediction residual information of the geometric position and a quantization parameter of each prediction node through parsing, and performs inverse quantization on the prediction residual for recovering, so as to obtain the reconstructed geometric position information of each node, and finally completes the geometric reconstruction on the decoding side.

The geometric encoding and decoding under the G-PCC coding framework are introduced above. The attribute encoding and decoding under the G-PCC coding framework are introduced below.

As illustrated in FIG. 4A, the current G-PCC coding framework includes three attribute encoding methods: predicting transform (PT), lifting transform (LT), and region adaptive hierarchical transform (RAHT). The first two methods perform predictive encoding on the point cloud based on the generation order of LODs, and the RAHT adaptively transforms attribute information from bottom to top based on the construction hierarchy of the octree. These three point cloud attribute encoding methods are explained separately below.

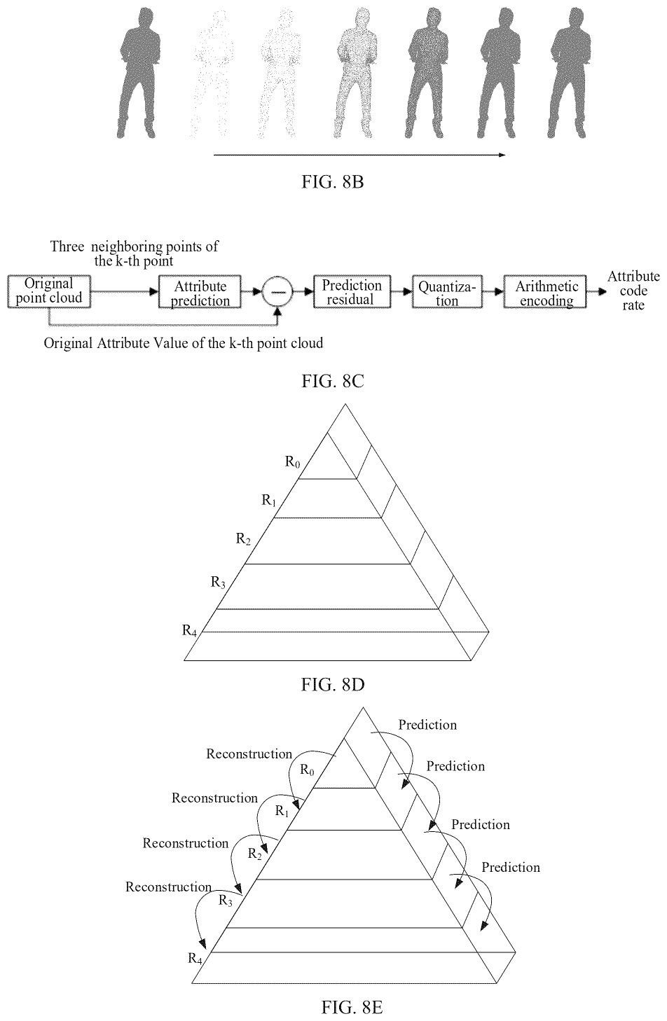

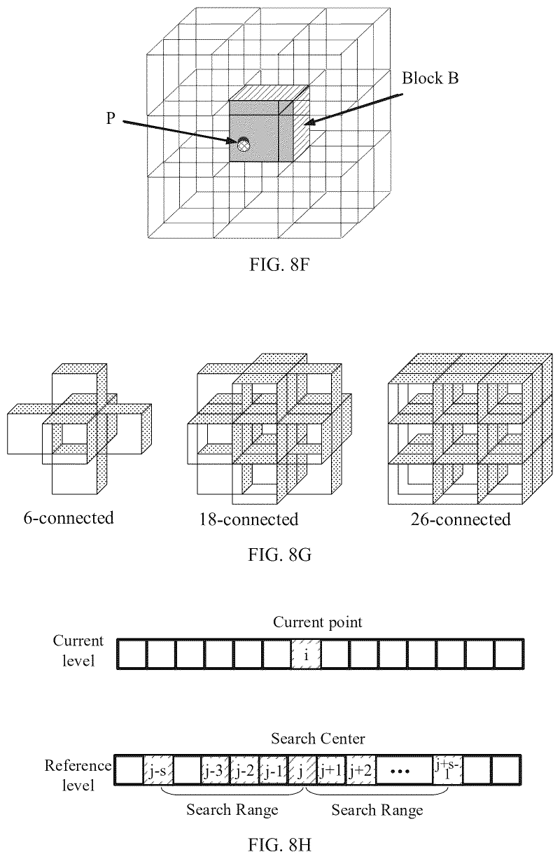

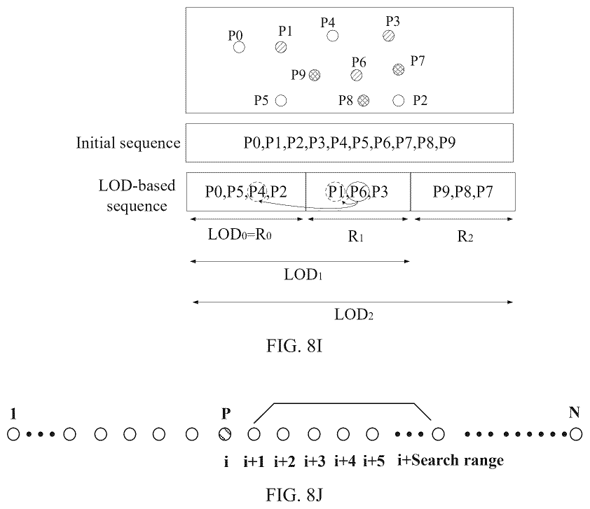

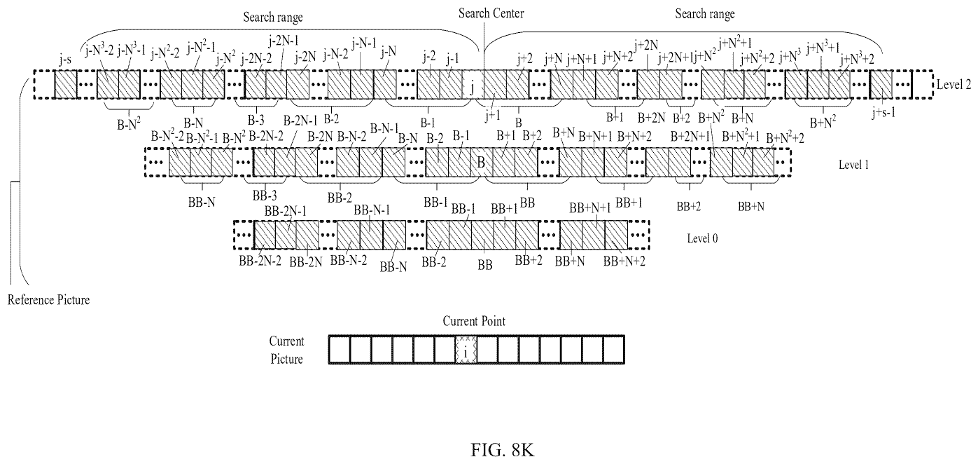

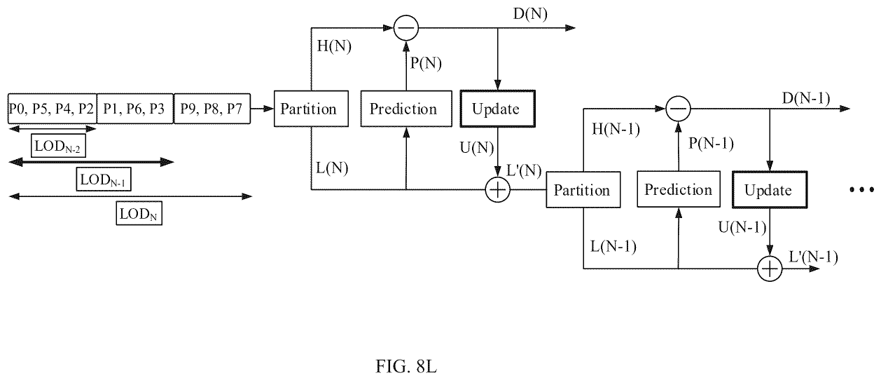

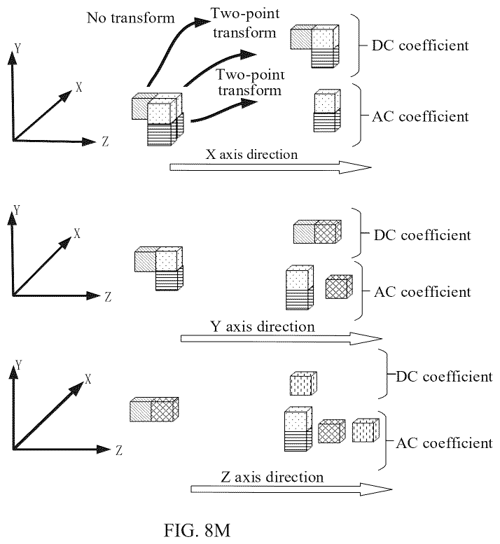

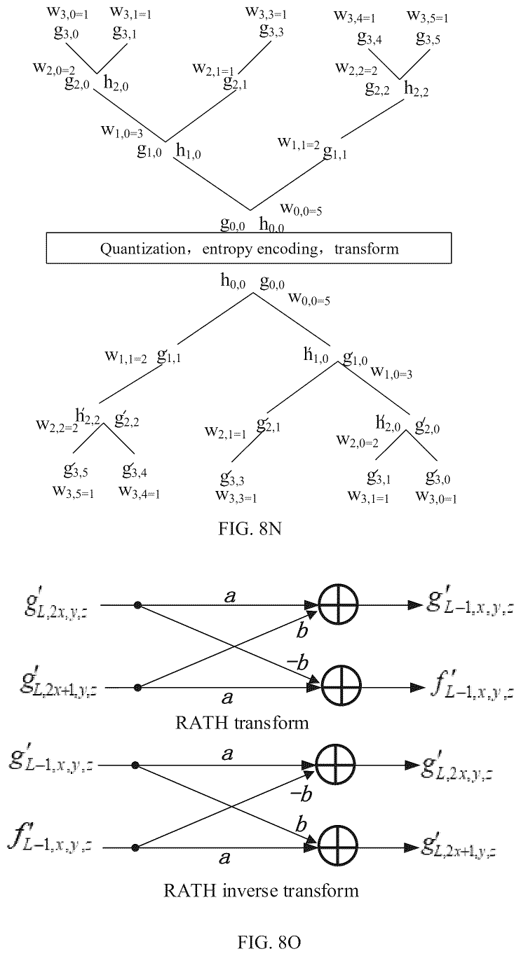

At present, the attribute prediction module of G-PCC uses a nearest neighbor attribute prediction encoding scheme based on a level-of-details (LoDs) structure. The LOD construction methods include a distance-based LOD construction scheme, a fixed sampling rate-based LOD construction scheme, and an octree-based LOD construction scheme. In the LOD construction scheme based on a distance threshold, the point cloud is first Morton sorted before constructing LOD to ensure that there is a strong attribute correlation between neighboring points. As illustrated in FIG. 8A, an example of a distance-based LOD construction process is given, in which the point clouds are partitioned into L different point cloud levels of detail (Rl) l=0, 1, . . . L−1 based on L Manhattan distances (dl) l=0, 1, . . . L−1 preset by the user, where (dl) l=0, 1, . . . L−1 meets dl less than dl−1. The construction process of LOD is as follows. (1) First, all points in the point cloud are marked as unvisited, and a set V is established to store the visited point set. (2) For each iteration 1, by traversing the points in the point cloud, if the current point has been visited, the current point is skipped, otherwise the minimum distance D from the current point to the point set V is calculated, if D less than dl, the point is skipped; otherwise, the current point is marked as visited, and the current point is added to the levels of detail Rl and the point set V. (3) The points in the level of detail LOD1 are composed of the points in the levels of detail R0, R1, R2 . . . . Rl; (4) The above steps are repeated until all points have been marked as visited.

Based on the LOD structure, the attribute value of each point is linearly weighted predicted by using the reconstructed attribute value of the point in the same or higher LOD level, where the maximum number of reference prediction neighbors is determined based on the encoder high-level syntax elements. For the attributes of each point, the rate-distortion optimization algorithm is used at the encoding side to select weighted prediction by using the attributes of the N nearest neighbor points searched or selecting the attributes of a single nearest neighbor point for prediction, and finally the selected prediction mode and prediction residual are encoded.

For example, the attribute prediction value is determined based on the following formula (10):

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} ) \qquad ( 10 )$$

Where N represents the number of prediction points in the nearest neighbor point set of point i, Pᵢ represents a sum of the N nearest neighbor points of point i, Dₘ represents a spatial geometry distance from the nearest neighbor point m to the current point i, Attrₘ represents the attribute value of the nearest neighbor point m after reconstruction, Attrᵢ′ represents the attribute prediction value of the current point i, and the number of points N is a preset value.

In order to balance the attribute encoding efficiency and parallel processing between different LOD levels, a switch is introduced in the encoder high-level syntax element to control whether to introduce intra-LOD level prediction. If the switch is turned on, intra-LOD level prediction is started, and points in the same LOD level may be used for prediction. It should be noted that in a case where the number of LOD levels is 1, intra-LOD level prediction is always used.

In an example, FIG. 8B illustrates a visualization result of LOD. The points at the first level represent outer contours of the point cloud. As the number of levels of LOD increases, the detail description of the point cloud becomes clearer.

In an example, FIG. 8C illustrates a flowchart of G-PCC attribute prediction. That is, for the k-th point in the point cloud, three neighboring points of the k-th point are first determined, and an attribute prediction value of the k-th point is determined based on the attribute reconstructed information of the three neighboring points. Next, an attribute prediction residual of the k-th point is obtained based on an original attribute value and the attribute prediction value of the k-th point, and after the attribute prediction residual is quantized, arithmetic encoding is performed to obtain an attribute bitstream.

In some embodiments, after the LOD is constructed, the three nearest neighbor points of the current point to be encoded are first found from the encoded data points based on the generation order of the LOD. The attribute reconstructed values of the three nearest neighbor points are used as candidate prediction values of the current point to be encoded; then, the optimal prediction value is selected from the attribute reconstructed values of the three nearest neighbor points according to the rate-distortion optimization (RDO). For example, in a case of encoding the attribute value of point P2 in FIG. 8A, the predictor variable index of the attribute value of the nearest neighbor point P4 is set to 1; the attribute predictor variable indexes of the second neighboring point P5 and the third neighboring point P0 are set to 2 and 3 respectively; and the predictor variable index of the weighted average of points P0, P5 and P4 is set to 0, as shown in Table 2:

TABLE 2
Samples of candidate prediction items for attribute encoding

| Prediction mode | Prediction value |
|---|---|
| 0 | Weighted average of attributes of three neighbors |
| 1 | P4 (an attribute value of the first neighbor) |
| 2 | P5 (an attribute value of the second neighbor) |
| 3 | P0 (an attribute value of the third neighbor) |

Finally, the optimal predictor variable is selected using RDO. The formula of weighted average is shown in formula (11):

$${\hat{a}}_{i} = Round ( {\sum }_{j = 0}^{2} \frac{{\tilde{w}}_{i j}}{{\sum }_{j = 0}^{2} {\tilde{w}}_{i j}} {\tilde{a}}_{j} ) \qquad ( 11 )$$

In formula (11), \tilde{w}ᵢⱼ represents the spatial geometric weight from the neighboring point j to the current point i, and the calculation formula is shown in formula (12):

$${\tilde{w}}_{ij} = \frac{1}{{( x - {x}_{ij} )}^{2} + {( {y}_{i} - {y}_{ij} )}^{2} + {( z - {z}_{ij} )}^{2}} \qquad ( 12 )$$

Where âᵢ represents the attribute prediction value of the current point i, j represents the indexes of the three neighboring points, ã; represents the attribute value of the nearest-neighbor points after reconstruction, xᵢ, yᵢ, zᵢ are the geometry position coordinates of the current point i, and xᵢⱼ, yᵢⱼ, zᵢⱼ are the geometry coordinates of the neighboring points j.

The attribute prediction residual and quantification are introduced below.

Through the above prediction, the attribute prediction value (âᵢ)_{i∈0 . . . k-1} (where k represents a total number of points in the point cloud) of the current point i is obtained. Let (aᵢ)_{i∈0 . . . k-1} be the original attribute value of the current point, then as shown in formula (13), the attribute residual (rᵢ)_{i∈0 . . . k-1} is denoted as:

$${r}_{i} = {a}_{i} - {\hat{a}}_{i} \qquad ( 13 )$$

Furthermore, the prediction residual is quantified based on the following formula (14):

$${Q}_{i} = \frac{{r}_{i}}{Q s} \qquad ( 14 )$$

In formula (14), Qᵢ represents the quantized attribute residual of the current point i, and Qₛ represents the quantization step, which may be calculated by the quantization parameter (QP) specified by CTC.

### Reconstruction of the Attribute Value at the Encoding Side

The purpose of reconstruction at the encoding side is to predict subsequent points. Before the reconstruction of the attribute value, the residual needs to undergo inverse quantization, as shown in formula (15), \hat{r}ᵢ is denoted as the residual after inverse quantization:

$${\hat{r}}_{i} = {Q}_{i} \times Q s \qquad ( 15 )$$

Then, based on the following formula (16), the reconstructed value ãᵢ of the point i is obtained by adding \hat{r}ᵢ to the prediction value âᵢ:

$${\tilde{a}}_{i} = {\hat{r}}_{i} + {\hat{a}}_{i} \qquad ( 16 )$$

When performing attribute nearest neighbor search based on LOD partition, there are currently two major types of algorithms: intra nearest neighbor search and inter nearest neighbor search. The intra nearest neighbor search is divided into two algorithms: inter-level nearest neighbor search and intra-level nearest neighbor search.

### Intra Nearest Neighbor Search

The intra nearest neighbor search is divided into two algorithms: inter-level nearest neighbor search and intra-level nearest neighbor search. After LOD partition, a pyramid structure similar to that illustrated in FIG. 8D is obtained.

### 1. Inter-Level Nearest Neighbor Search

As illustrated in FIG. 8E and FIG. 8A, different LOD levels, namely LOD0, LOD1 and LOD2, are obtained based on the geometry information partitioning, and points in LOD0 are used to predict attributes of points in a next LOD during the process of the inter-level nearest neighbor search.

The entire process of the intra nearest neighbor search is described in detail below.

In the entire process of LOD partition, there are three sets O(k), L(k) and I(k), where k is the index of the LOD during LOD level partition, and I(k) is the input point set during the current LOD level partition. After LOD partition, O(k) and L(k) sets are obtained. The O(k) set stores the sampling point set, and L(k) is the point set in the current LOD level. That is, the entire process of LOD partitioning is as follows.

(1) Initialization

$$if k = 0 , ( k ) ← \{ \} . Otherwise , ( k ) ← L ( k - 1 )$$

$$O ( k ) ← \{ \}$$

(2) Based on the LOD partition algorithm, the sampling points are stored in (k), and the remaining points are partitioned into (k).

(3) In a case of performing the next iteration, I←(k).

It is to be noted here that since the entire process of LOD partition is based on the Morton code, O(k), L(k) and I(k) store the Morton code index corresponding to the point.

When performing inter-level nearest neighbor search, that is, the points in the L(k) set performing nearest neighbor search in the O(k) set, the specific search algorithm is as follows.

Nearest neighbor search is performed based on spatial relationships

When predicting the current point P, neighbor search is performed by using the parent block (Block B) corresponding to the point P, as illustrated in FIG. 8F, to search for points in neighbor blocks that are co-planar or co-edge with the current parent block to perform attribute prediction.

For example, the spatial relationship of co-plane, co-edge and co-vertex is illustrated in FIG. 8G.

First, the coordinates of the current point are used to obtain a corresponding spatial block. Secondly, the nearest neighbor search is performed in the previously encoded LOD level to find spatial blocks that are co-planar, co-edged, and co-pointed with the current block to obtain the N neighbors of the current point.

If the N neighbors of the current point are still not obtained after performing co-planar, co-edge and co-vertex nearest neighbor searches, the N neighbors of the current point will be obtained based on a fast search algorithm, and the specific algorithm is illustrated in FIG. 8H. When performing inter-attribute level prediction, the Morton code corresponding to the current point is first obtained using the geometric coordinates of the current point to be encoded. Secondly, based on the Morton code of the current point, the reference point (j) whose Morton code is a first one greater than the Morton code of the current point is found in the reference picture. Then, the nearest neighbor search is performed in the range of [j−searchRange, j+searchRange].

The rest of the specific algorithms for updating the nearest neighbor are the same as the inter nearest neighbor search algorithm, which will not be repeated here. The specific algorithms will be mentioned in the inter nearest neighbor search algorithm.

### 2. Intra-Level Nearest Neighbor Search

As illustrated in FIG. 8I, when the intra-level prediction algorithm is turned on, in the same LOD level, a nearest neighbor search is performed on the set of encoded points in the same level to obtain the N neighbors of the current point (inter-level nearest neighbor search is also performed).

When performing attribute inter-level prediction, the nearest neighbor search is performed based on the fast search algorithm. The specific algorithm is illustrated in FIG. 8J.

Assuming that the Morton code index of the current point is i, the nearest neighbor search will be performed in [i+1, i+searchRange]. The specific nearest neighbor search algorithm is consistent with the block-based inter fast search algorithm, which will not be repeated here and will be discussed in detail later.

The intra nearest neighbor search is described above. The inter nearest neighbor search is described below.

### Inter Nearest Neighbor Search

As illustrated in FIG. 8H, when performing attribute inter prediction, the Morton code corresponding to the current point are first obtained using the geometric coordinates of the current point to be encoded. Secondly, based on the Morton code of the current point, the reference point (j) whose Morton code is a first one greater than the Morton code of the current point is found in the reference picture. Then, the nearest neighbor search is performed in the range of [j−searchRange, j+searchRange].

At present, when performing intra nearest neighbor search and inter nearest neighbor search, the neighborhood search is performed based on blocks, as illustrated in FIG. 8K. When searching for the neighborhood of the current point (Morton code index is i), the points in the reference picture are first partitioned into N (N is equal to 3) levels according to the Morton code. The specific partition algorithm is as follows.

First level: it is assumed that the reference picture contains numPoints points, the points in the reference picture are first partitioned into a block every M (M=2⁵=32) points.

Second level: on the basis of the first level, the blocks of the first level are partitioned into one block every M (M=2⁵=32) blocks according to the order of Morton code.

Third level: on the basis of the second level, the blocks of the first level are partitioned into one block every M (M=2⁵=32) blocks according to the order of Morton code.

Finally, the prediction structure illustrated in FIG. 8K is obtained.

When performing attribute prediction based on the prediction structure illustrated in FIG. 8K, assuming that the Morton code index of the current point to be encoded is i, the point in the reference picture whose Morton code is a first one greater than or equal to the Morton code of the current point is first obtained, with an index of j. Secondly, the block index of the reference point is calculated based on j. The specific calculation method is as follows.

First level: BucketSize_0=2⁵=32.

Second level: BucketSize_1=2⁵=32×BucketSize_0=1024.

Third level: BucketSize_2=2⁵=32×BucketSize_1=32768.

Assuming that the reference range in the prediction picture of the current point is [j−searchRange, j+searchRange], the starting index of the third level is calculated using j−searchRange, and the ending index of the third level is calculated using j+searchRange. Next, it is determined whether some blocks of the second level need to undergo nearest neighbor search in the blocks of the third level; then, moving to the second level, it is determined whether a search is needed for each block of the first level; if some blocks of the first level need to undergo nearest neighbor search, some points of the blocks of the first level will be determined point by point to update the nearest neighbors.

The index-based calculation block algorithm is introduced below. Assuming that the Morton code index corresponding to the current point is “index”, the index of the corresponding third level block is as shown in formula (17):

$$idx\_ 2 = index / BucketSize\_ 2 \qquad ( 17 )$$

After the index idx_2 of the third level block is obtained, the starting index and the ending index of the block of the second level corresponding to the current block may be obtained using idx_2, as shown in formula (18):

$$startIdx 1 = idx\_ 2 \times BucketSize\_ 1 \qquad ( 18 )$$

$$endIdx = idx\_ 2 \times BucketSize\_ 1 + BucketSize\_ 1 - 1$$

Based on the same algorithm, the index of the first level block is obtained based on the index of the second level block.

When performing nearest neighbor search based on blocks, it is first determined whether the current block needs to undergo nearest neighbor search, that is, filter the nearest neighbor search of the block. Each spatial block may be obtained based on two variables minPos and maxPos, where minPos represents the minimum value of the block and maxPos represents the maximum value of the block.

It is assumed that the distance of the farthest point among the N neighbors of the current point is Dist, the coordinates of the point to be encoded are (x, y, z), and the current block is represented by (minPos, maxPos), where minPos is the minimum value of the bounding box in three dimensions, and maxPos is the maximum value of the bounding box in three dimensions, then the distance D between the current point and the bounding box is calculated as shown in formula (19):

$$int dx = int ( std \text{::} max ( std \text{::} max ( minPos [ 0 ] - point [ 0 ] , 0 ) , point [ 0 ] - maxPos [ 0 ] ) ; int dy = int \text{} ( \text{} std \text{::} max ( std \text{::} max ( minPos [ 1 ] - point [ 1 ] , 0 ) , point [ 1 ] - maxPos [ 1 ] ) ) ; int dz = int ( std \text{::} max ( std \text{::} max ( minPos [ 2 ] - point [ 2 ] , 0 ) , point [ 2 ] - maxPos [ 2 ] ) ) ; D = dx + dy + dz \qquad ( 19 )$$

When D is less than or equal to Dist, the points in the current block will be traversed.

The lifting transform encoding of the attribute information of the point cloud is introduced below.

FIG. 8L illustrates an encoding process of the lifting transform. The lifting transform also performs predictive encoding on the attributes of the point cloud based on LOD. The difference from the prediction transform is that the lifting transform first partitions the LOD into higher and lower levels, performs prediction in the reversed order of the LOD level generation, and introduces an update operator in the prediction process to update the quantization weights of the points in the lower LOD level to improve the accuracy of the prediction. This is because the attribute values of points in the lower LOD level are frequently used to predict the attribute values of points in the higher LOD level, and points in the lower LOD level should have greater influence.

### Step 1: Partitioning Process

The partitioning process is to partition the complete LOD level into lower LOD levels L(N) and higher LOD levels H(N). If a point cloud has three levels of LOD, i.e., (LODₗ)_{l=0,1,2}, after partitioning, LOD₂ is the higher LOD level and denoted as H(N), and (LODₗ)_{l=0,1} are the lower LOD levels and denoted as L(N).

### Step 2: Prediction Process

The point in the higher LOD level selects the attribute information of the nearest neighbor points from the lower LOD level as the attribute prediction value P(N) of the current point to be encoded. The prediction residual D(N) is shown in formula (20):

$$D ( N ) = H ( N ) - P ( N ) \qquad ( 20 )$$

### Step 3: Update Process

The attribute prediction residual D(N) in the higher LOD level is updated to obtain U(N), and the attribute values of the points in the lower LOD level are lifted using U(N), as shown in (21):

$${L}^{′} ( N ) = L ( N ) + U ( N ) \qquad ( 21 )$$

The above process will iterate continuously until the lowest LOD level according to the order of LOD from high to low.

Since the LOD-based prediction scheme makes the points in the lower LODs have greater influence, the transform scheme based on lifting wavelet transform introduces quantization weights and updates the prediction residual according to the prediction residual D(N) and the distance between the prediction point and the neighboring points. Finally, adaptive quantization is performed on the prediction residual using the quantization weights in the transform process. It should be noted that the quantization weight value of each point may be determined by geometric reconstruction at the decoding side, so the quantization weight do not need to be encoded.

The region adaptive hierarchical transform is introduced below.

The region adaptive hierarchical transform (RAHT) is a Haar wavelet transform that may transform the attribute information of the point cloud from the spatial domain to the frequency domain and further reduce the correlation between the attributes of the point cloud. The main idea is to transform the nodes in each level from the three dimensions of x, y, and z (as illustrated in FIG. 8M) in a bottom-up manner according to the octree structure, and to perform iteration until reaching the root node of the octree. As illustrated in FIG. 8N, the basic idea is to perform wavelet transform based on the hierarchical structure of the octree, associate the attribute information with the nodes of the octree, and recursively transform the attributes of the occupied nodes in the same parent node in a bottom-up manner. The nodes in each level are transformed from the three dimensions of x, y, and z until reaching the root node of the octree. In the process of hierarchical transform, the low-pass (DC) coefficients obtained after transforming the nodes in the same level are passed to the nodes in the next level for further transformation, while all high-pass (AC) coefficients are encoded by the arithmetic encoder.

During the transformation process, the DC coefficient (direct current component) of the nodes in the same level after transformation will be passed to the previous level for further transformation, and the AC coefficient (alternating current component) after transformation of each level will be quantized and encoded. The main transformation process is introduced below.

FIG. 8O illustrates the corresponding transform and inverse transform process. Assuming that

$${g}_{L , 2 x , y , z}^{′} and {g}_{L , 2 x + 1 , y , z}^{′}$$

are two attributes DC coefficients that are neighboring points in the L level. After the linear transformation, the information of the L−1 level is the AC coefficient

$${f}_{L - 1 , x , y , z}^{′}$$

and the DC coefficient

$${g}_{L - 1 , x , y , z}^{′} ;$$

then, no more transform will be performed on

$${f}_{L - 1 , x , y , z}^{′} ,$$

and quantization encoding will be performed on

$${f}_{L - 1 , x , y , z}^{′}$$

directly

$${g}_{L - 1 , x , y , z}^{′}$$

will continue to search nearest neighbors for transformation, and it will be passed directly to the L−2 level if none are found. That is, the RAHT transform is only valid for nodes with neighboring points, and nodes without neighboring points will be passed directly to the previous level. In the above transformation process, the weights corresponding to

$${g}_{L , 2 x , y , z}^{′} and {g}_{L , 2 x + 2 , y , z}^{′}$$

(the number of non-empty child nodes in a node) are

$${w}_{L , 2 x , y , z}^{′} and {w}_{L , 2 x + 1 , y , z}^{′}$$

(abbreviated as

$${w}_{0}^{′} and {w}_{1}^{′} ) ,$$

and the weight of

$${g}_{L - 1 , x , y , z}^{′} is {w}_{L - 1 , x , y , z}^{′} ,$$

then the general transformation formula (22) is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 22 )$$

For example, T_{w0,w1} in the formula is a transformation matrix determined according to the following formula (23):

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 23 )$$

The transform matrix will be updated as the weights corresponding to each point change adaptively. The above process will be continuously iterated and updated based on the partition structure of the octree until reaching the root node of the octree.

The encoding and decoding technology of the geometry information of the point cloud and the encoding and decoding technology of the attribute information of the point cloud are described above.

Upon performing nearest neighbor search on an attribute, G-PCC performs fast nearest neighbor search based on blocks. First, the prediction reference point set is stored in a buffer, which is partitioned into three levels. Then, a fast nearest neighbor search is performed based on blocks. Finally, the nearest neighbor attributes found are used to perform a weighted prediction of the attributes of the current point. However, in the existing algorithms, there is no limitation on the buffer content of the current prediction reference point set, but the buffer memory is proportional to the number of prediction reference points. Therefore, the existing algorithms will cause a dynamic and uncontrollable problem in the hardware implementation of the buffer. That is to say, upon performing attribute prediction on the current point, all reference points of the current point are buffered in the prediction reference buffer. If there are many reference points, the prediction reference buffer will be large, and if there are few reference points, the prediction reference buffer will be small, making the size of the prediction reference buffer uncontrollable, thereby resulting in low attribute decoding performance.

In order to solve the above technical problems, the embodiments of the present disclosure determine a first parameter upon encoding and decoding the attribute information of the current point. The first parameter is used to indicate the maximum number M of reference points bufferable in the prediction reference buffer. Then, based on the first parameter, M reference points are determined, and these M reference points are stored in the prediction reference buffer. Then, based on the reference points included in the prediction reference buffer, an attribute prediction value of the current point is determined. That is, the embodiments of the present disclosure uses the first parameter to indicate a size of the prediction reference buffer, so that the size of the prediction reference buffer is fixed and does not change dynamically with the change in the number of reference points, thereby saving memory resources of the encoding and decoding devices and improving the decoding performance of point cloud attributes.

The point cloud encoding and decoding methods involved in the embodiments of the present disclosure are introduced below in conjunction with specific embodiments.

First, taking the decoding end (or referred to as decoding side or decoder) as an example, the point cloud decoding method provided by the embodiments of the present disclosure is introduced.

FIG. 9 is a flowchart of a point cloud decoding method provided by an embodiment of the present disclosure. The point cloud decoding method in the embodiment of the present disclosure may be completed by the point cloud decoding device or point cloud decoder illustrated in FIG. 3 or FIG. 4B above.

As illustrated in FIG. 9, the point cloud decoding method in the embodiment of the present disclosure includes:
S101: determining a first parameter.

The first parameter is used to indicate the maximum number M of reference points bufferable in the prediction reference buffer, M being a positive integer. In some embodiments, M is expressed as max NumPoints.

From the above, it can be seen that the point cloud includes geometry information and attribute information, and the decoding of the point cloud includes geometry decoding and attribute decoding. The embodiments of the present disclosure relate to attribute decoding of point clouds.

The point cloud attribute decoding in the embodiments of the present disclosure is performed after the point cloud geometry decoding. That is to say, in the embodiments of the present disclosure, the geometry information of the point cloud is first decoded to obtain the point cloud after decoding the geometry information. Next, based on the point cloud after decoding the geometry information, the attribute information of the point cloud is decoded.

In some embodiments, upon decoding the attribute information of a point cloud, the point cloud is partitioned into multiple levels based on the geometry information of the point cloud, and then the attribute information of each point in each level is decoded level by level.

For example, the point cloud may be partitioned into multiple LOD levels based on the geometry information of the point cloud, and attribute information of each point in each LOD level may be decoded.

In some embodiments, before partitioning the point cloud into multiple levels, the point cloud is first sorted. For example, based on geometry information of each point in the point cloud, a Morton code of each point in the point cloud is determined, and then points in the point cloud are sorted based on the Morton code to obtain a Morton-sorted point cloud.

In the embodiments of the present disclosure, the decoding process of the attribute information of each point in each level is basically the same. Taking a point in a certain level of a point cloud as an example, first, N neighboring points of a current point whose attribute information has been decoded are determined and found, N being a positive integer. Then, attribute information of the current point is predicted based on the attribute information (i.e., attribute reconstructed value) of the N neighboring points. For example, attribute information of a neighboring point among the N neighboring points is determined as an attribute prediction value of the current point, or a weighted average of the attribute information of the N neighboring points is determined as the attribute prediction value of the current point.

Upon determining the N neighboring points of the current point, intra nearest neighbor search and/or inter nearest neighbor search are usually included.

For example, in some embodiments, only the intra nearest neighbor search method is used to determine the N neighboring points of the current point. In some embodiments, only the inter nearest neighbor search method is used to determine the N neighboring points of the current point.

For another example, in some embodiments, both the intra nearest neighbor search and the inter nearest neighbor search are used to determine the N neighboring points of the current point.

At present, upon performing the nearest neighbor search on an attribute, G-PCC performs a fast nearest neighbor search based on blocks. First, a prediction reference point set is stored in a buffer, which is partitioned into three levels. Then, the fast nearest neighbor search is performed based on blocks. Finally, attributes of a nearest neighbor found are used to perform a weighted prediction on the attributes of the current point. However, in the existing algorithms, there is no constraint on a buffer content of the current prediction reference point set, but a buffer memory is proportional to the number of prediction reference points. Therefore, the existing algorithms will cause a dynamic and uncontrollable problem in the hardware implementation of the buffer. That is to say, upon performing attribute prediction on the current point, all reference points of the current point are buffered in the prediction reference buffer, and if there are many reference points, the prediction reference buffer will be large, or if there are few reference points, the prediction reference buffer will be small, making a size of the prediction reference buffer uncontrollable, thereby resulting in low attribute decoding performance.

In order to solve the above technical problems, the embodiments of the present disclosure introduce a first parameter, which is used to control the number of parameter points stored in a prediction reference buffer, thereby achieving controllable buffer content on the decoding end, thereby saving memory resources of the encoding and decoding device and improving the decoding performance of point cloud attributes.

In some embodiments, the maximum number M of reference points bufferable in the prediction reference buffer may be understood as a spatial size of the prediction reference buffer being M, or may be understood as at most M reference points being bufferable in the prediction reference buffer. For example, if M=100, when the decoding end performs attribute prediction, 100 reference points are buffered in the prediction reference buffer each time.

The specific process of determining the first parameter by the decoding end is introduced below.

In some embodiments, the first parameter above may be a preset value or a default value. That is, the encoding end and decoding end determine the preset value or the default value as the maximum number of reference points bufferable in the prediction reference buffer, that is, a size of the prediction reference buffer.

In some embodiments, the encoding end determines the first parameter and signals the first parameter into a bitstream. In this way, the decoding end obtains the first parameter by decoding the bitstream, and then obtains the size of the prediction reference buffer or the bufferable maximum number M of reference points based on the first parameter.

The embodiments of the present disclosure do not limit the specific expression form of the first parameter.

For example, the first parameter may be represented using a syntax element, max_points_per_bucket_log2_plus1.

In some embodiments, the first parameter above may be included in an attribute parameter set (Attribute parameter set, APS).

The embodiments of the present disclosure do not limit a specific position and specific form of the first parameter in the ASP.

In an example, the syntaxes of data unit in the attribute parameter set are illustrated in Table 3:

TABLE 3

| | Descriptor |
|---|---|
| attribute_parameter_set( ) { | |
| aps_attr_parameter_set_id | u(4) |
| aps_seq_parameter_set_id | u(4) |
| attr_coding_type | ue(v) |
| attr_primary_qp_minus4 | ue(v) |
| attr_secondary_qp_offset | se(v) |
| attr_qp_offsets_present | u(1) |
| if(attr_coding_type == 0) { | |
| raht_prediction_enabled | u(1) |
| if(raht_prediction_enabled) { | |
| raht_prediction_subtree_min | ue(v) |
| raht_prediction_samples_min | ue(v) |
| } | |
| } else if(attr_coding_type ≤ 2) { | |
| max_points_per_bucket_log2_plus1 | ue(v) |
| pred_set_size_minus1 | ue(v) |
| pred_inter_lod_search_range | ue(v) |
| for(k = 0; k < 3; k++) | |
| pred_dist_bias_minus1_xyz[k] | ue(v) |
| if (attr_coding_type == 2) | |
| last_comp_pred_enabled | u(1) |
| lod_scalability_enabled | u(1) |
| if(lod_scalability_enabled) | |
| pred_max_range_minus1 | ue(v) |
| else { | |
| lod_max_levels_minus1 | ue(v) |
| if(¬lod_max_levels_minus1) | |
| attr_canonical_order_enabled | u(1) |
| else { | |
| lod_decimation_mode | ue(v) |
| if(lod_decimation_mode > 0) | |
| for(lvl = 0; lvl < | |
| lod_max_levels_minus1; lvl++) | |
| lod_sampling_period_minus2[lvl] | ue(v) |
| lod_initial_dist_log2 | ue(v) |
| lod_dist_log2_offset_present | u(1) |
| } | |
| } | |
| if(attr_coding_type == 1) { | |
| pred_direct_max_idx_plus1 | ue(v) |
| if(pred_direct_max_idx_plus1) { | |
| pred_direct_threshold | u(8) |
| pred_direct_avg_disabled | u(1) |
| } | |
| pred_intra_lod_search_range | ue(v) |
| if(pred_intra_lod_search_range) | |
| pred_intra_min_lod | ue(v) |
| inter_comp_pred_enabled | u(1) |
| pred_blending_enabled | u(1) |
| } | |
| } else if(attr_coding_type == 3) | |
| raw_attr_width_present | u(1) |
| if(¬lod_scalability_enabled) | |
| attr_coord_conv_enabled | u(1) |
| if(attr_coord_conv_enabled) | |
| for(k = 0; k < 3; k++) { | |
| attr_coord_conv_scale_bits_minus1[k] | u(5) |
| attr_coord_conv_scale[k] | u(v) |
| } | |
| aps_extension_present | u(1) |
| if(aps_extension_present) | |
| while(more_data_in_data_unit( )) | |
| aps_extension_data | u(1) |
| byte_alignment( ) | |
| } | |

As illustrated in Table 3, max_points_per_bucket_log2_plus1 represents the first parameter.

In this example, the decoding end obtains the first parameter max_points_per_bucket_log2_plus1 by decoding the syntax elements illustrated in Table. 3, and then obtains the size M of the prediction reference buffer or the maximum number M of reference points bufferable in the prediction reference buffer based on the first parameter.

In some embodiments, the encoding end may also signals the first parameter into other positions in the bitstream except the APS, which is not limited in the embodiments of the present disclosure.

After determining the first parameter based on the above steps, the decoding end performs the following step S102.
S102: M reference points are determined based on the first parameter, and the M reference points are stored into the prediction reference buffer.

Based on the above steps, after determining the first parameter, the decoding end may determine the maximum number M of reference points bufferable in the prediction reference buffer, and then determine M reference points from points whose current attribute has been decoded, and store the M reference points into the prediction reference buffer. That is to say, in the embodiments of the present disclosure, the decoding end buffers at most M reference points into the prediction reference buffer through the first parameter, thereby controlling the number of points stored in the prediction reference buffer.

The embodiments of the present disclosure do not limit the specific method of determining the M reference points based on the first parameter.

In some embodiments, as can be seen from the above, upon performing attribute decoding on the point cloud, the point cloud geometry has been decoded, so the point cloud is sorted according to the geometry decoding information of the point cloud, for example, the point cloud is sorted by Morton code. The M points whose attribute information has been decoded are selected as the M reference points of the current point from the sorted point cloud, and the M reference points are stored into the prediction reference buffer. For example, according to the sorting order of the point cloud, the M reference points are selected from the points whose attribute information has been decoded. For another example, random sampling is performed on the sorted points whose attribute information has been decoded to obtain M points whose attribute information has been decoded as the M reference points.

In some embodiments, upon performing attribute decoding on a point cloud, the point cloud is partitioned into levels, for example, LOD construction is performed on the point cloud. In this way, upon performing attribute decoding on the current point in a certain level, the M reference points may be selected from the current LOD level where the current point is located. For example, the decoding end decodes the bitstream to determine whether the current point cloud introduces LOD intra-level prediction, and if it is determined that the current point cloud enables the LOD intra-level prediction, points in the same LOD level may be used for attribute prediction, that is, M points whose attribute information has been decoded are selected from the current LOD level, and stored into the prediction reference buffer as the M reference points for the current point. It should be noted that when the number of LOD levels is 1, the LOD intra-level prediction is always used.

In some embodiments, upon predicting the attribute information of the current point, the decoding end first determines a prediction reference point set corresponding to the current point. In this case, determining the M reference points based on the first parameter in S102 includes the following steps:
S102-A1: determining the prediction reference point set corresponding to the current point, where the prediction reference point set includes multiple reference points; and
S102-A2: selecting the M reference points from the prediction reference point set based on the first parameter.

In this embodiment, the decoding end first determines multiple reference points corresponding to the current point, and uses a set consisting of the multiple reference points as the prediction reference point set corresponding to the current point. Existing methods, upon performing attribute prediction on the current point, store all reference points in the prediction reference point set into the prediction reference buffer, which takes up a large amount of memory, leaving less memory for other calculations on the decoding end, thereby reducing decoding efficiency. In order to solve this technical problem, the embodiments of the present disclosure control the size of the prediction reference buffer through the first parameter, when predicting the attribute information of each point in the point cloud, M reference points are stored into the prediction reference buffer each time, thereby avoiding excessive memory occupation by the prediction reference buffer, and further improving the decoding efficiency of the decoding end.

For example, taking an intra nearest neighbor search as an example, in an entire LOD partitioning process, there are three sets O(k), L(k) and I(k), where k is an index of an LOD level during LOD partitioning, and I(k) is an input point set during the current LOD level partitioning. After LOD partitioning, the O(k) set and the L(k) set are obtained. The O(k) set stores a sampling point set, and L(k) is a set of points in the current LOD level. For example, since the entire LOD partitioning process is based on the Morton code, O(k), L(k) and I(k) store Morton code indexes corresponding to the points. Upon performing inter-level nearest neighbor search, for the points in the L(k) set, nearest neighbor search is performed in the O(k) set.

In the embodiments of the present disclosure, the current point is any point in the L(k) set whose attribute information is to be decoded, and the O(k) set is recorded as the prediction reference point set corresponding to the current point. It should be noted that, in the embodiments of the present disclosure, the reference points included in the prediction reference set are all points whose attribute information has been decoded.

In some embodiments, during intra prediction, the decoded point set in the same level in the same LOD is added to the prediction reference point set.

In some embodiments, during inter prediction, at least one point in a reference frame of the current point whose attribute information has been decoded may be added to the prediction reference point set.

In the embodiments of the present disclosure, the reference frame of the current point may be understood as a reference frame of a current frame where the current point is located.

The embodiments of the present disclosure do not limit the number of reference frames of the current point, that is, the current point includes one or more reference frames.

In some embodiments, the reference frame of the current point includes a forward reference frame of the current frame.

In some embodiments, the reference frame of the current point includes a backward reference frame of the current frame.

In some embodiments, the reference frame of the current point includes a forward reference frame and a backward reference frame of the current frame.

From the above, it can be seen that no matter whether the current point adopts intra nearest neighbor search, inter nearest neighbor search, or both intra nearest neighbor search and inter nearest neighbor search, the prediction reference set may be determined. Typically, the prediction reference set includes more than M points whose attribute information has been decoded.

In the embodiments of the present disclosure, the decoding end, after determining the prediction reference set corresponding to the current point, does not buffer all points in the prediction reference set into the prediction reference buffer. Instead, based on the first parameter, the decoding end selects M reference points from the prediction reference set and buffers the M reference points into the prediction reference buffer to avoid the prediction reference buffer occupying more memory space and affecting the decoding efficiency.

In the embodiments of the present disclosure, the manners for selecting the M reference points from the prediction reference set include but are not limited to the following.

Manner I: Based on a distance between each point in the prediction reference set and the current point, M reference points nearest to the current point are selected from the prediction reference set.

Manner II: Based on an index of each reference point in the prediction reference point set, M reference points are selected from the prediction reference point set. For example, respective points in the prediction reference set are sorted according to the Morton code, so that several points with indexes larger than an index of the current point, and several points with indexes smaller than the index of the current point may be selected from the prediction reference point set, and a total of M points are selected as the M reference points corresponding to the current point.

Manner III: To prevent frequent updates of points in the prediction reference buffer, M reference points are selected in sequence according to a search of each point in the prediction reference point set and stored in the prediction reference buffer.

In some embodiments, if the number of reference points included in the prediction reference set corresponding to the current point is equal to or less than the maximum number M of reference points bufferable in the prediction reference buffer indicated by the first parameter, a step of selecting M reference points from the prediction reference point set is skipped, and all reference points in the prediction reference set are buffered in the prediction reference buffer.

According to the above steps, the decoding end determines the M reference points based on the first parameter and stores the M reference points into the prediction reference buffer, and then performs the following step S103.
S103: an attribute prediction value of the current point is determined based on the reference points included in the prediction reference buffer.

Based on the first parameter, the decoding end selects the M reference points from the points whose attribute information has been decoded, and stores the M reference points into the prediction reference buffer. Then, based on the reference points included in the prediction reference buffer, the attribute prediction is performed on the current point to obtain the attribute prediction value of the current point.

The embodiments of the present disclosure do not limit the specific manner in which the decoding end determines the attribute prediction value of the current point based on the reference points included in the prediction reference buffer.

In some embodiments, as can be seen from the above, in order to reduce the memory usage of the prediction reference buffer, the embodiments of the present disclosure reduce the number of reference points included in the prediction reference buffer, that is, a fixed number of M reference points are stored in the prediction reference buffer each time. Since the number of reference points included in the prediction reference buffer is relatively small, the decoding end may directly use all or part of the reference points included in the prediction reference buffer as neighboring points of the current point, to predict the attribute information of the current point.

In some embodiments, the decoding end performs attribute prediction on the current point through the following steps S103-A and S103-B:
S103-A: searching for at least one neighboring point of the current point among the reference points included in the prediction reference buffer; and
S103-B: determining the attribute prediction value of the current point based on attribute information of the at least one neighboring point.

In this embodiment, upon performing attribute prediction on the current point, the decoding end searches for the at least one neighboring point of the current point from the reference points included in the prediction reference buffer, and then predicts the attribute information of the current point based on the attribute information of the at least one neighboring point (i.e., attribute reconstructed value) to obtain the attribute prediction value of the current point.

In the embodiments of the present disclosure, manners for searching for the at least one neighboring point of the current point among the reference points included in the prediction reference buffer includes but is not limited to the following.

Manner I: In the intra inter-level nearest neighbor search, the reference points included in the prediction reference buffer include points in the LOD level that have been decoded before the current LOD level. Based on this, the decoding end first uses the coordinate of the current point to obtain a corresponding spatial block as the current block, and then performs a nearest neighbor search in the LOD level that has been decoded before the current LOD level, for example, searching for a reference point included in the spatial block that is co-planar, co-edge, or co-vertex with the current block as at least one neighboring point of the current point.

Manner II: The above S103-A includes the following steps:
S103-A1: determining a first reference point corresponding to the current point in the prediction reference point set; and
S103-A2: searching for the at least one neighboring point of the current point among the reference points included in the prediction reference buffer based on the first reference point.

In the manner II, the decoding end first determines a reference point among the reference points included in the prediction reference point set as the first reference point corresponding to the current point, and then, based on the first reference point, searches for the at least one neighboring point of the current point among the reference points included in the prediction reference buffer.

The embodiments of the present disclosure do not limit the specific manner in which the decoding end determines the first reference point corresponding to the current point in the prediction reference point set.

In an example, any reference point in the prediction reference point set is determined as the first reference point corresponding to the current point.

In an example, the decoding end and the encoding end use a reference point in the prediction reference point set as the first reference point corresponding to the current point by default. In an example, the reference points in the prediction reference point set are sorted based on the indexes, so that the first point, or the second point, or the n-th point in the prediction reference point set may be used as the first reference point corresponding to the current point, n being a positive integer less than or equal to M.

In an example, the decoding end determines a reference point in the prediction reference point set whose index is a first one greater than or equal to the index of the current point (i.e., a reference point in the prediction reference point set whose index is first greater than or equal to an index of the current point according to a specific order) as the first reference point. For example, the index of the current point is i, a search is performed in the prediction reference point set, and a reference point (j) whose index is a first one greater than or equal to the index of the current point is found, and used as the first reference point of the current point.

The embodiments of the present disclosure do not limit the specific form of the index of the current point and the index of the reference point.

For example, if the embodiments of the present disclosure sort the point cloud based on the Morton code order, the index of the above point may be the Morton code index of the point.

For another example, if the embodiments of the present disclosure sort the point cloud based on the Hilbert order, the index of the above point may be the Hilbert index of the point.

The decoding end, after determining the first reference point corresponding to the current point based on the above steps, performs the above step S103-A2 to search for the at least one neighboring point of the current point among the reference points included in the prediction reference buffer based on the first reference point.

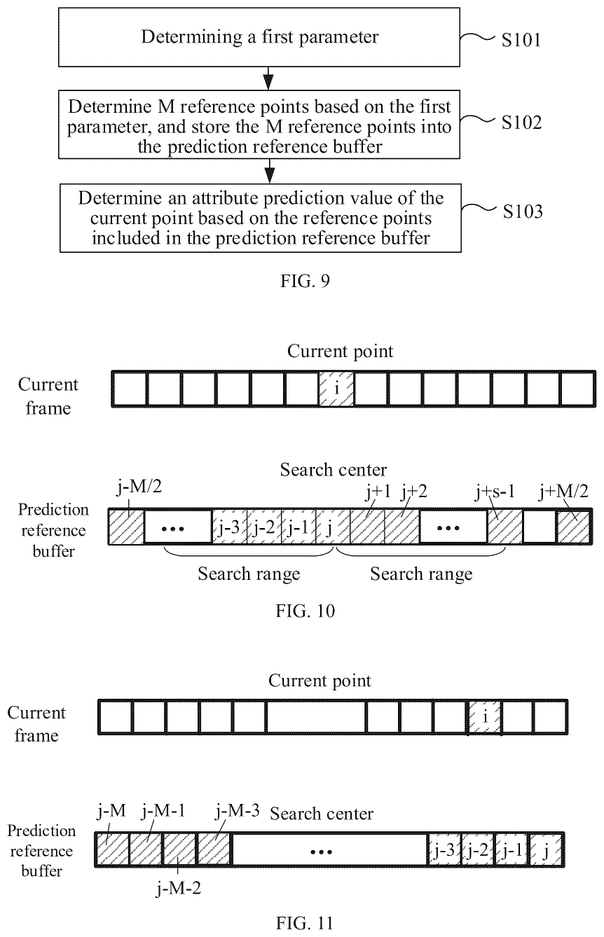

For example, as illustrated in FIG. 10, it is assumed that the current point is an i-th point in the current point frame, or the index of the current point is i, the index of the first reference point is j, and it is assumed that indexes of the M reference points included in the prediction reference buffer are: P_{j-M/2}, . . . , Pⱼ₋₃, Pⱼ₋₂, Pⱼ₋₁, Pⱼ, Pⱼ₊₁, Pⱼ₊₂, . . . , and P_{j+M/2}, the decoding end searches for the at least one neighboring point of the current point from the M reference points. For example, with the first reference point as the center of Pⱼ, a search is performed within a preset search range to obtain at least one neighboring point of the current point.

The embodiments of the present disclosure do not limit the specific manner in which the decoding end searches for the at least one neighboring point of the current point among the reference points included in the prediction reference buffer based on the first reference point.

In a possible implementation, the decoding end searches for at least one reference point nearest to the current point near the first reference point in the prediction reference buffer as the at least one neighboring point of the current point.

In a possible implementation, the above S103-A2 includes the following steps S103-A21 to S103-A23:
S103-A21: determining, based on the first reference point, whether to update the prediction reference buffer;
S103-A22: in response to determining to update the prediction reference buffer, updating at least one reference point included in the prediction reference buffer, based on remaining reference points in the prediction reference point set, to obtain an updated prediction reference buffer; and
S103-A23: searching for the at least one neighboring point of the current point among the reference points included in the updated prediction reference buffer.

In this implementation, the decoding end, after determining the first reference point, first determines, based on the first reference point, whether to update the prediction reference buffer. That is, the decoding end determines, based on the first reference point, whether may accurately determine the at least one neighbor of the current point from the reference points currently buffered in the prediction reference buffer. If it is determined that the at least one neighboring point of the current point cannot be determined from the reference points included in the current prediction reference buffer, it is determined to update the current prediction reference buffer.

In response to determining that the prediction reference buffer does not need to be updated, the decoding end searches for the at least one neighboring point of the current point from the M reference points included in the current prediction reference buffer.

In response to determining to update the prediction reference buffer, the decoding end updates the at least one reference point included in the prediction reference buffer based on the remaining reference points in the prediction reference point set, to obtain the updated prediction reference buffer, and then searches for the at least one neighboring point of the current point among the reference points included in the updated prediction reference buffer.

The specific manner for determining, based on the first reference point, whether to update the prediction reference buffer in the above S103-A21 is introduced below.

The embodiments of the present disclosure do not limit the specific manner in which the decoding end determines, based on the first reference point, whether to update the prediction reference buffer.

In some embodiments, the above S103-A21 includes: in response to the first reference point being a last reference point or one of the last reference points in the current prediction reference buffer, determining to update the current prediction reference buffer.

In some embodiments, the above S103-A21 includes:
S103-A211: in response to a sum of the index of the first reference point and a first value being greater than or equal to an index of the last reference point in the prediction reference buffer, determining to update the prediction reference buffer, the first value being an integer.

In S103-A211, the decoding end adds the index of the first reference point and a first value K to obtain a sum value, which is recorded as A. Next, the sum value A is compared with an index B of the last reference point in the current prediction reference buffer to determine whether the sum value A is greater than or equal to the index B of the last reference point in the current prediction reference buffer.

In response to the sum value A being less than the index B of the last reference point in the current prediction reference buffer, it means that the decoding end may search for the at least one neighboring point of the current point among the reference points included in the current prediction reference buffer, in this case, it is determined that the current prediction reference buffer is not updated.

In response to the sum value A being greater than or equal to the index B of the last reference point in the current prediction reference buffer, it means that the reference points included in the current prediction reference buffer are insufficient for searching for the at least one neighboring point of the current point, or that the reference points included in the current prediction reference buffer do not include a neighboring point of the current point, or the number of neighboring points of the current point included is insufficient. In this case, it is determined that the current prediction reference buffer needs to be updated.

The embodiments of the present disclosure do not limit the specific value of the above first value K, as long as K is an integer, such as 0, 1, 2, or 3.

There are two cases described below: the first value being 0, and the first value being a preset search range value. It should be noted that the first value being 0 or the preset search range value is only an example, and the value of the first value in the embodiments of the present disclosure includes but is not limited to these two cases.

Case I: In response to the first value being 0, then the above S103-A211 includes the step S103-A211-a:
S103-A211-a: in response to the index of the first reference point being greater than or equal to the index of the last reference point in the prediction reference buffer, determining to update the prediction reference buffer.

In this case I, after determining the first reference point corresponding to the current point based on the above steps, the decoding end compares the index of the first reference point with the index of the last reference point among the reference points included in the current prediction reference buffer.

In some embodiments, in response to the index of the first reference point being smaller than the index of the last reference point among the reference points included in the current prediction reference buffer, it is determined not to update the prediction reference buffer, but to directly search for the at least one neighboring point of the current point among the reference points included in the current prediction reference buffer.

In some embodiments, in response to the index of the first reference point being greater than or equal to the index of the last reference point among the reference points included in the current prediction reference buffer, it is determined that the current prediction reference buffer needs to be updated. As illustrated in FIG. 11, it is assumed that the index of the first reference point is j, and the index of the last reference point included in the current prediction reference buffer is also j, at this time, the decoding end determines to update the current prediction reference buffer.

In this case I, after determining to update the current prediction reference buffer, the decoding end performs the above step S103-A22, updates the at least one reference point in the prediction reference buffer based on the remaining reference points in the prediction reference point set, to obtain the updated prediction reference buffer.

In the embodiments of the present disclosure, the specific manner for the decoding end to update the at least one reference point among the M reference points included in the prediction reference buffer, to obtain the updated prediction reference buffer is not limited.

In a possible implementation, the decoding end directly deletes all reference points in the current prediction reference buffer, selects M new reference points from the remaining reference points in the prediction reference point set, and stores the selected M new reference points into the prediction reference set. That is to say, in this implementation, in response to the index of the last reference point in the current prediction reference buffer being less than or equal to the index of the first reference point, the decoding end will directly delete the entire M reference points in the prediction reference buffer, and select M new reference points to store in the prediction reference buffer, thereby realizing a rapid update of the entire prediction reference buffer. In this way, the decoding end may search for the at least one neighboring point of the current point from all updated prediction reference buffer.

In an example of this implementation, the decoding end selects M reference points with indexes less than or equal to the index of the first reference point from the remaining reference points in the prediction reference point set, and stores them into the prediction reference point set as new reference points.

For example, the M points included in the prediction reference point set are sorted from small to large according to indexes: P0, P1, . . . , Pj−1, Pj, Pj+1, . . . , it is assumed that the M reference points buffered in the current prediction reference buffer are: P0, P1, . . . , PM−1, the first reference point corresponding to the current point is Pj, and j is greater than M−1, in this case, the index j of the first reference point Pⱼ corresponding to the current point is greater than the index M−1 of the last reference point PM−1 in the current prediction reference buffer, so it is determined that the current prediction reference buffer needs to be updated.

In this example, the decoding end updates the current prediction reference buffer by deleting the M reference points P0, P1, . . . , PM−1 included in the current prediction reference buffer. Next, the decoding end selects the M reference points with indexes less than or equal to the index of the first reference point, that is, the decoding end selects M new reference points (i.e., Pj, Pj+1, . . . , Pj+M−1), from the remaining reference points in the prediction reference point set, and stores the M new reference points into the prediction reference buffer, thereby updating the entire prediction reference buffer.

In an example of this implementation, the decoding end and the encoding end use the same sampling manner to sample M reference points from the remaining reference points in the prediction reference point set, and store the M reference points, as new reference points, into the prediction reference point set.

In a possible implementation, the above S103-A22 includes the following steps S103-A22-a1 and S103-A22-a2:
S103-A22-a1: acquiring at least one second reference point from the remaining reference points in the prediction reference set based on the index of the first reference point; and
S103-A22-a2: using the at least one second reference point to update the at least one reference point in the prediction reference buffer, to obtain the updated prediction reference buffer.

In this implementation, in response to determining that the index of the first reference point is greater than or equal to the index of the last reference point in the current prediction reference buffer, the decoding end selects at least one reference point from the remaining reference points in the prediction reference set based on the index of the first reference point. For example, at least one reference point with an index greater than the index of the first reference point is selected from the remaining reference points in the prediction reference set, recorded as the at least one second reference point, and the at least one second reference point is used to update the at least one reference point in the prediction reference buffer, to obtain the updated prediction reference buffer.

In this implementation, there is no limitation on the number of second reference points selected by the decoding end from the remaining reference points in the prediction reference set based on the index of the first reference point.

In some embodiments, the decoding end selects M second reference points from the remaining reference points in the prediction reference set based on the index of the first reference point. That is to say, in this embodiment, the decoding end selects the M second reference points from the remaining reference points in the reference point set based on the index of the first reference point, and then uses the M second reference points to replace the M reference points currently included in the prediction reference buffer as a whole. For example, the decoding end directly deletes the M reference points currently included in the prediction reference buffer, and stores the M second reference points selected above into the prediction reference buffer. In this way, the decoding end searches for the at least one neighboring point of the current point from the M second reference points included in the updated prediction reference buffer.

The embodiments of the present disclosure do not limit the specific manner in which the decoding end selects the M second reference points from the remaining reference points in the prediction reference set based on the index of the first reference point.

In an example, the decoding end selects M reference points with indexes greater than or equal to the index of the first reference point from the remaining reference points in the prediction reference set as the M second reference points.

In an example, an index of a point with the smallest index among the above M second reference points is greater than or equal to the index of the first reference point.

In an example, an index of a point with the largest index among the above M second reference points is greater than or equal to the sum of the index of the first reference point and M.

In an example, in response to determining that the index j of the first reference point is greater than or equal to the index of the last reference point in the prediction reference buffer, the decoding end selects reference points with indexes [j, j+M] from the prediction reference set as the M second reference points.

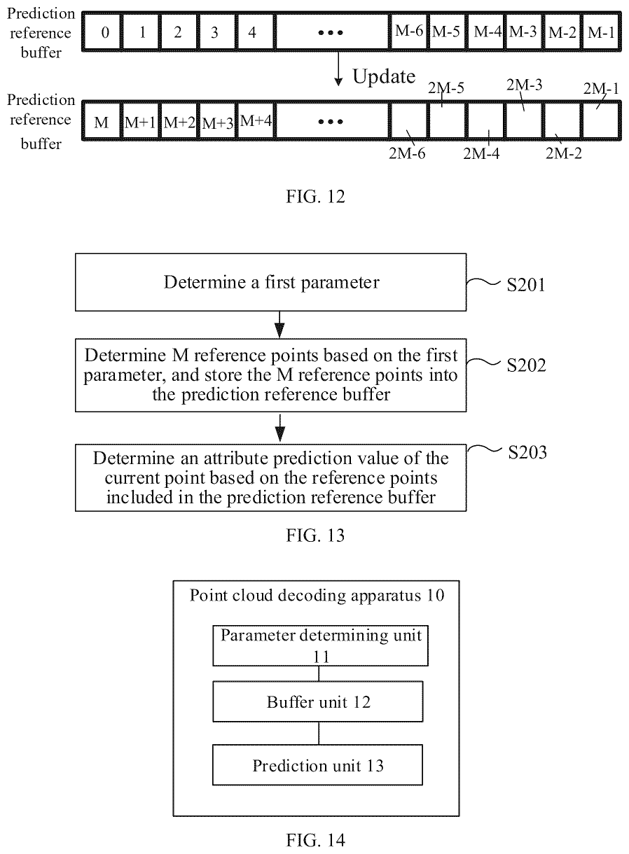

In this embodiment, the decoding end selects the M second reference points from the remaining reference points in the prediction reference set based on the index of the first reference point, and then performs the above step S103-A22-a2, that is, deleting the M reference points in the prediction reference buffer and adding the above determined M second reference points to the prediction reference buffer, thereby obtaining the updated prediction reference buffer as illustrated in FIG. 12.

The process in which the decoding end updates the prediction reference buffer when the first value is 0 in case I is introduced above.

Case II: In response to the first value being the preset search range value, the above S103-A211 includes steps S103-A211-b1 and S103-A211-b2:
S103-A211-b1: adding the index of the first reference point and the preset search range value to obtain a first sum value; and
S103-A211-b2: in response to the first sum value being greater than or equal to the index of the last reference point in the prediction reference buffer, determining to update the prediction reference buffer.

In this case II, after determining the first reference point corresponding to the current point based on the above steps, the decoding end adds the index j of the first reference point and the preset search range value searchRange to obtain the first sum value j+searchRange. Next, the first sum value j+searchRange is compared with the index of the last reference point among the reference points included in the current prediction reference buffer, to determine whether to update the current prediction reference buffer.

In some embodiments, in response to the first sum value j+searchRange being less than the index of the last reference point among the reference points included in the current prediction reference buffer, it is determined not to update the prediction reference buffer, but to directly search for the at least one neighboring point of the current point among the reference points included in the current prediction reference buffer.

In some embodiments, in response to the first sum value j+searchRange being greater than or equal to the index of the last reference point among the reference points included in the current prediction reference buffer, it is determined that the current prediction reference buffer needs to be updated. It is assumed that the index of the first reference point is j, the preset search range value is searchRange, and the first sum value is j+searchRange, in response to the index of the last reference point among the reference points included in the current prediction reference buffer being also j+searchRange, at this time, the decoding end determines to update the current prediction reference buffer.

In this case II, after determining to update the current prediction reference buffer, the decoding end performs the above step S103-A22, to update the at least one reference point in the prediction reference buffer based on the remaining reference points in the prediction reference point set, to obtain the updated prediction reference buffer.

In the embodiments of the present disclosure, the specific manner for the decoding end to update the at least one reference point among the M reference points included in the prediction reference buffer, to obtain the updated prediction reference buffer is not limited.

In a possible implementation, the decoding end directly deletes all reference points in the current prediction reference buffer, selects M new reference points from the remaining reference points in the prediction reference point set, and stores the selected M new reference points into the prediction reference set. That is to say, in this implementation, in response to the index of the last reference point in the current prediction reference buffer being less than or equal to the first sum value, the decoding end will directly delete the entire M reference points in the prediction reference buffer, and select the M new reference points to be stored in the prediction reference buffer, thereby realizing a rapid update of the entire prediction reference buffer. In this way, the decoding end may find the at least one neighboring point of the current point from all updated prediction reference buffer.

In an example of this implementation, the decoding end selects M reference points with indexes less than or equal to the index of the first reference point from the remaining reference points in the prediction reference point set, and stores the M reference points, as new reference points, into the prediction reference point set.

For example, the M points included in the prediction reference point set are sorted from small to large according to indexes: P0, P1, . . . , Pj−1, Pj, Pj+1, . . . , it is assumed that the M reference points in the current prediction reference buffer are: P0, P1, . . . , PM−1, the first reference point corresponding to the current point is Pj, and the first sum value j+searchRange is greater than M−1. In this case, the first sum value j+searchRange of the index j of the first reference point Pj corresponding to the current point and the preset search range value searchRange is greater than the index M−1 of the last reference point PM−1 in the current prediction reference buffer, therefore it is determined that the current prediction reference buffer needs to be updated.

In this example, the decoding end updates the current prediction reference buffer by deleting the M reference points P0, P1, . . . , PM−1 included in the current prediction reference buffer. Next, from the remaining reference points in the prediction reference point set, M reference points with indexes less than or equal to the index of the first reference point are selected, that is, M new reference points Pj, Pj+1, . . . , Pj+M−1 are selected and stored into the prediction reference buffer, thereby achieving the updating of the entire prediction reference buffer.

In an example of this implementation, the decoding end and the encoding end use the same sampling manner to sample the M reference points from the remaining reference points in the prediction reference point set, and store the M reference points, as new reference points, into the prediction reference point set.

In a possible implementation, the above S103-A22 includes the following steps S103-A22-b1 and S103-A22-b2:
S103-A22-b1: obtaining at least one third reference point from the remaining reference points in the prediction reference set based on the index of the first reference point; and
S103-A22-b2: using the at least one third reference point to update the at least one reference point included in the prediction reference buffer, to obtain the updated prediction reference buffer.

In this implementation, in response to determining that the first sum value is greater than or equal to the index of the last reference point in the current prediction reference buffer, the decoding end selects at least one reference point from the remaining reference points in the prediction reference set based on the index of the first reference point. For example, at least one reference point with an index greater than the index of the first reference point is selected from the remaining reference points of the prediction reference set, recorded as the at least one third reference point, and the at least one third reference point is used to update the at least one reference point in the prediction reference buffer to obtain the updated prediction reference buffer.

In this implementation, there is no limitation on the number of third reference points selected by the decoding end from the remaining reference points in the prediction reference set based on the index of the first reference point.

In some embodiments, the decoding end selects the M third reference points from the remaining reference points in the prediction reference set based on the index of the first reference point. That is to say, in this embodiment, the decoding end selects the M third reference points from the remaining reference points in the reference point set based on the index of the first reference point, and then uses the M third reference points to replace the M reference points currently included in the prediction reference buffer as a whole. For example, the decoding end directly deletes the M reference points currently included in the prediction reference buffer, and stores the M third reference points selected above into the prediction reference buffer. In this way, the decoding end searches for the at least one neighboring point of the current point from the M third reference points included in the updated prediction reference buffer.

The embodiments of the present disclosure do not limit the specific manner in which the decoding end selects the at least one third reference point from the remaining reference points in the prediction reference set based on the index of the first reference point.

In an example, the decoding end selects at least one reference point with an index greater than or equal to the index of the first reference point from the remaining reference points in the prediction reference set as the at least one third reference point.

In an example, the decoding end selects P third reference points from the remaining reference points in the prediction reference set based on the index of the first reference point, P being equal to a difference between the index of the first reference point and an index of a first reference point in the prediction reference buffer.

In an example, the index of the point with the smallest index among the above P third reference points is greater than or equal to the index of the last reference point in the prediction reference buffer plus one. For example, the index of the last reference point in the prediction reference buffer is 99, and the index of the point with the smallest index among the P third reference points is 100 or greater than 100.

In an example, the index of the point with the largest index among the above P third reference points is greater than or equal to a sum of the index of the first reference point and M minus one. For example, the index of the first reference point is 67, M=100, then the index of the point with the largest index among the P third reference points is 166 or greater than 166.

For example, it is assumed that the prediction reference buffer includes 100 points, with indexes ranging from 0 to 99 from small to large, and it is assumed that the index of the first reference point is 67, and the preset search range value is 40, then the sum of the index of the first reference point and the preset search range value is 107. In this case, the first sum value 107 is greater than the index of the last reference point in the prediction reference buffer, therefore, it is determined to update the current prediction reference buffer. Next, the decoding end selects 67 third reference points with indexes from 100 to 166 from the remaining reference points in the prediction reference set based on the index j of the first reference point.

In this embodiment, the decoding end selects the P third reference points from the remaining reference points in the prediction reference set based on the index of the first reference point, and then performs the step of the above S103-A22-b2 step, for example, the P points preceding the first reference point in the prediction reference buffer are deleted, and the P third reference points are added to the prediction reference buffer to obtain the updated prediction reference buffer.

From the above, it can be seen that in an example of case II, in response to a first numerical value being the preset search range value, the decoding end adds the index of the first reference point and the preset search range value to obtain the first sum value, and in response to the first sum value being greater than or equal to the index of the last reference point in the prediction reference buffer, based on the index of the first reference point, the P third reference points are selected from the remaining reference points in the prediction reference set. Next, the decoding end deletes the P points preceding the first reference point in the prediction buffer, and adds the P third reference points determined above to the prediction reference buffer, thereby updating the prediction reference buffer.

In this example, the manner in which the decoding end uses the P third reference points to update the prediction reference buffer includes, but is not limited to the following examples: In example I, the decoding end deletes the P points before the first reference point in the prediction reference buffer and moves M−P points following the first reference point in the prediction reference buffer forward. Then, the P third reference points determined above are stored following the first reference point to obtain the updated prediction reference buffer. In this case, the updated prediction reference buffer includes M reference points, including M−P old reference points and the P third reference points determined above.

In example II, the decoding end deletes the P points preceding the first reference point in the prediction reference buffer, does not move the M−P points following the first reference point in the prediction reference buffer, but directly stores the P third reference points determined above in the positions preceding the first reference point, to obtain the updated prediction reference buffer. In this case, the updated prediction reference buffer includes M reference points, including M−P old reference points and the P third reference points determined above, and the positions of the M−P old reference points in the prediction reference buffer do not change.

In some embodiments of the case II, upon determining that the above first sum value is greater than or equal to the index of the last reference point in the prediction reference buffer, the decoding end deletes all reference points in the current prediction reference buffer and reselects M new reference points from the prediction reference set and stores the M new reference points into the prediction reference buffer. In an example, the minimum index of the M new reference points is less than or equal to the index of the first parameter. In an example, the minimum index of the M new reference points is greater than or equal to the index of the last point in the current prediction reference buffer.

The above description uses the case where the first value is 0 or a preset search range value as an example to illustrate updating the prediction reference buffer at the decoding end. It should be noted that the embodiments of the present disclosure do not limit the specific process of updating the prediction reference buffer at the decoding end.

In some embodiments, in order to increase the update speed, upon determining that the prediction reference buffer needs to be updated, the decoding end may reselect M reference points from the reference points included in the prediction reference set based on the index of the first parameter, and update all points in the prediction reference buffer.

In some embodiments, when the decoding end determines that the prediction reference buffer needs to be updated, the decoding end may update the points in the prediction reference buffer one by one based on the index of the first parameter.

After updating the prediction reference buffer based on the above steps, the decoding end performs the above step S103-A23 to search for the at least one neighboring point of the current point among the reference points included in the updated prediction reference buffer.

In the embodiments of the present disclosure, the decoding end searches for the at least one neighboring point of the current point from the prediction reference buffer in the same manner as searching for the at least one neighboring point of the current point from the updated prediction reference buffer. The following description will be made by taking an example where the decoding end searches for the at least one neighboring point of the current point from the prediction reference buffer.

The embodiments of the present disclosure do not limit the specific manner in which the decoding end searches for the at least one neighboring point of the current point from the prediction reference buffer.

In an example, in response to the above prediction reference buffer includes the inter-level decoded point of the current point in the inter-level nearest neighbor search, the decoding end obtains a corresponding spatial block from the coordinate of the current point, and then performs the nearest neighbor search in the previously decoded LOD level to search spatial blocks that are co-planar, co-edge, or co-vertex with the current block to obtain the at least one neighboring point of the current point.

In an example, in response to the prediction reference buffer including intra-level decoded points in an intra-level nearest neighbor search, the decoding end searches for the at least one neighboring point of the current point from the intra-level decoded points.

In an example, in response to the prediction reference buffer including decoded points in the reference frame of the current point in an inter nearest neighbor search, the decoding end may search for the at least one neighboring point of the current point from the inter decoded points.

It should be noted that the specific manner in which the decoding end searches for the at least one neighboring point of the current point from the prediction reference buffer may be referred to the description of the above embodiments, which will not be repeated herein.

Upon determining the at least one neighboring point of the current point based on the above steps, the decoding end performs the above step of S103-B to determine the attribute prediction value of the current point based on the attribute information of the at least one neighboring point.

The embodiments of the present disclosure do not limit the specific manner in which the decoding end determines the attribute prediction value of the current point based on the attribute information of at least one neighboring point.

In an example, in response to the at least one neighboring point including a neighboring point, the decoding end determines the attribute information of the neighboring point (i.e., the attribute reconstructed value) as the attribute prediction value of the current point.

For another example, in response to the at least one neighboring point including multiple neighboring points, an average value of the attribute information of the multiple neighboring points is determined as the attribute prediction value of the current point.

For another example, in response to the at least one neighboring point including multiple neighboring points, a weighted average value of the attribute information of the multiple neighboring points is determined as the attribute prediction value of the current point.

For example, the decoding end determines the attribute prediction value of the current point based on the following formula (24):

$${\hat{a}}_{i} = Round ( {\sum }_{j = 0}^{N - 1} \frac{{\tilde{w}}_{ij}}{{\sum }_{j = 0}^{N - 1} {\tilde{w}}_{ij}} {\tilde{a}}_{j} ) \qquad ( 24 )$$

where âᵢ represents the attribute prediction value of the current point i, j represents an index of a j-th neighboring point, ãⱼ represents the attribute information of the j-th neighboring point (i.e., the attribute reconstructed value), and \tilde{w}ᵢⱼ represents a spatial geometry weight of the j-th neighboring point to the current point.

For example, the spatial geometry weight of the j-th neighboring point to the current point i may be determined by the following formula (25):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} \qquad ( 25 )$$

where (xᵢ, yᵢ, zᵢ) is the geometry coordinate of the current point, and (xᵢⱼ, yᵢⱼ, zᵢⱼ) is the geometry coordinate of the j-th neighboring point.

As can be seen from the above, in the embodiments of the present disclosure, a size of the prediction reference buffer is controlled by the first parameter, and then based on the first parameter, M reference points are determined, and the M reference points are stored into the prediction reference buffer, and then based on the reference points included in the prediction reference buffer, the attribute prediction value of the current point is determined. That is, the embodiments of the present disclosure use the first parameter to indicate the size of the prediction reference buffer, so that the size of the prediction reference buffer is fixed and does not change dynamically with the change in the number of reference points, thereby saving memory resources of the encoding and decoding devices, and improving the decoding performance of point cloud attributes.

In order to further illustrate the decoding effect of the point cloud decoding method proposed in the embodiments of the present disclosure, the decoding efficiency of the attributes when the first parameter max_points_per_bucket_log2_plus1 is set to different values is demonstrated below.

In an example, when max_points_per_bucket_log2_plus1 is 16, the decoding efficiency of the attributes is as illustrated in Table 4:

TABLE 4

| Index of | | The present | | |
|---|---|---|---|---|
| a frame | TMC13-v20.0 | disclosure | Inter/Intra | BPP |
| 0 | 49223B | 49223B | Intra | 100% |
| 1 | 41470B | 46549B | Inter | 112% |
| 2 | 39927B | 46014B | Inter | 115% |
| 3 | 40559B | 45585B | Inter | 112% |
| 4 | 41355B | 46117B | Inter | 112% |

It can be seen from Table 4 above that in response to the first parameter being 16, the solutions in the embodiments of the present disclosure may bring a gain of 12% to 15%.

In an example, when max_points_per_bucket_log2_plus1 is 20, the decoding efficiency of the attributes is as illustrated in Table 5:

TABLE 5

| Index of | | The present | | |
|---|---|---|---|---|
| a frame | TMC13-v20.0 | disclosure | Inter/Intra | BPP |
| 0 | 49223B | 49223B | Intra | 100% |
| 1 | 41470B | 41470B | Inter | 100% |
| 2 | 39927B | 39927B | Inter | 100% |
| 3 | 40559B | 40559B | Inter | 100% |
| 4 | 41355B | 41355B | Inter | 100% |

It can be seen from Table 4 and Table 5 above that the smaller the first parameter max_points_per_bucket_log2_plus1 is set, the greater the impact on attribute decoding efficiency.

In the point cloud decoding method provided by the embodiments of the present disclosure, upon performing attribute decoding, the decoding end first determines a first parameter, which is used to indicate a maximum number M of reference points bufferable in a prediction reference buffer. Then, based on the first parameter, M reference points are determined and stored into the prediction reference buffer. Then, based on the reference points included in the prediction reference buffer, an attribute prediction value of the current point is determined. That is, the embodiments of the present disclosure use the first parameter to indicate a size of the prediction reference buffer, so that the size of the prediction reference buffer is fixed and does not change dynamically with the change in the number of reference points, thereby saving memory resources of the decoding device and improving the decoding performance of point cloud attributes.

The decoding end is taken as an example to introduce in detail the point cloud decoding method provided by the embodiments of the present disclosure above. The encoding end (or referred to as encoding side or encoder) is taken as an example to introduce the point cloud encoding method provided by the embodiments of the present disclosure below.

FIG. 13 is a flowchart of a point cloud encoding method provided by an embodiment of the present disclosure. The point cloud encoding method in the embodiments of the present disclosure may be completed by the point cloud encoding device illustrated in FIG. 3 or FIG. 4A above.

As illustrated in FIG. 13, the point cloud encoding method in the embodiments of the present disclosure includes:
S201: determining a first parameter.

The first parameter is used to indicate a maximum number M of reference points bufferable in the prediction reference buffer, M being a positive integer.

From the above, it can be seen that the point cloud includes geometry information and attribute information, and the encoding of the point cloud includes geometry encoding and attribute encoding. The embodiments of the present disclosure relate to point cloud attribute encoding.

The point cloud attribute encoding in the embodiments of the present disclosure is performed after the point cloud geometry encoding. That is to say, in the embodiments of the present disclosure, the geometry information of the point cloud is first encoded. Next, based on the point cloud after geometry information encoding, the attribute information of the point cloud is encoded.

In some embodiments, upon encoding the attribute information of a point cloud, the point cloud is partitioned into multiple levels based on the geometry information of the point cloud, and the attribute information of each point in each level is encoded level by level.

For example, the point cloud may be partitioned into multiple LOD levels based on the geometry information of the point cloud, and the attribute information of each point in each LOD level may be encoded.

In some embodiments, before partitioning the point cloud into multiple levels, the point cloud is first sorted. For example, based on geometry information of each point in the point cloud, a Morton code of each point in the point cloud is determined, and then points in the point cloud are sorted based on the Morton code to obtain a Morton-sorted point cloud.

In the embodiments of the present disclosure, the encoding process of the attribute information of each point in each level is basically the same. Taking a point in a certain level of a point cloud as an example, first, N neighboring points of a current point whose attribute information has been encoded are determined and found, N being a positive integer. Then, attribute information of the current point is predicted based on the attribute information (i.e., attribute reconstructed value) of the N neighboring points. For example, attribute information of a neighboring point among the N neighboring points is determined as an attribute prediction value of the current point, or a weighted average of the attribute information of the N neighboring points is determined as the attribute prediction value of the current point.

Upon determining the N neighboring points of the current point, intra nearest neighbor search and/or inter nearest neighbor search are usually included.

For example, in some embodiments, only the intra nearest neighbor search method is used to determine the N neighboring points of the current point. In some embodiments, only the inter nearest neighbor search method is used to determine the N neighboring points of the current point.

For another example, in some embodiments, both the intra nearest neighbor search and the inter nearest neighbor search are used to determine the N neighboring points of the current point.

At present, upon performing the nearest neighbor search on an attribute, G-PCC performs a fast nearest neighbor search based on blocks. First, a prediction reference point set is stored in a buffer, which is partitioned into three levels. Then, the fast nearest neighbor search is performed based on blocks. Finally, attributes of a nearest neighbor found are used to perform a weighted prediction of the attributes of the current point. However, in the existing algorithms, there is no constraint on a buffer content of the current prediction reference point set, but a buffer memory is proportional to the number of prediction reference points. Therefore, the existing algorithms will cause a dynamic and uncontrollable problem in the hardware implementation of the buffer. That is to say, upon performing attribute prediction on the current point, all reference points of the current point are buffered in the prediction reference buffer, and if there are many reference points, the prediction reference buffer will be large, or if there are few reference points, the prediction reference buffer will be small, making a size of the prediction reference buffer uncontrollable, thereby resulting in low attribute encoding performance.

In order to solve the above technical problems, the embodiments of the present disclosure introduce a first parameter, which is used to control the number of parameter points stored in a prediction reference buffer, thereby achieving controllable buffer content on the encoding end, thereby saving memory resources of the encoding and decoding device and improving the encoding performance of point cloud attributes.

In some embodiments, the maximum number M of reference points bufferable in the prediction reference buffer may be understood as a spatial size of the prediction reference buffer being M, or may be understood as at most M reference points being bufferable in the prediction reference buffer. For example, if M=100, when the encoding end performs attribute prediction, 100 reference points are buffered in the prediction reference buffer each time.

The specific process of determining the first parameter at the encoding end is introduced below.

In some embodiments, the above first parameter may be a preset value or a default value. That is, the encoding end and decoding end determine the preset value or the default value as the maximum number of reference points bufferable in the prediction reference buffer, that is, a size of the prediction reference buffer.

In some embodiments, the encoding end determines the first parameter and signals the first parameter into a bitstream. In this way, the encoding end obtains the first parameter by encoding the bitstream, and then obtains the size of the prediction reference buffer or the maximum number M of reference points bufferable based on the first parameter.

The embodiments of the present disclosure do not limit the specific form of expression of the first parameter.

For example, the first parameter may be represented using a syntax element max_points_per_bucket_log2_plus2.

In some embodiments, the first parameter may be included in an attribute parameter set (Attribute parameter set, APS).

The embodiments of the present disclosure do not limit a specific position and specific form of the first parameter in the ASP.

In an example, the syntaxes of data unit in the attribute parameter set is illustrated in Table 3.

In this example, the encoding end obtains the first parameter max_points_per_bucket_log2_plus2 by encoding the syntax elements illustrated in Table 3, and then obtains the size M of the prediction reference buffer or the maximum number M of reference points bufferable in the prediction reference buffer based on the first parameter.

In some embodiments, the encoding end may also signals the first parameter into other positions in the bitstream except the APS, which is not limited in the embodiments of the present disclosure.

Upon determining the first parameter based on the above steps, the encoding end performs the following step S202.
S202: M reference points are determined based on the first parameter, and the M reference points are stored into the prediction reference buffer.

Based on the above steps, after determining the first parameter, the encoding end may determine the maximum number M of reference points bufferable in the prediction reference buffer, and then determine M reference points from points whose current attribute has been encoded, and store the M reference points into the prediction reference buffer. That is to say, in the embodiments of the present disclosure, the encoding end buffers at most M reference points into the prediction reference buffer through the first parameter, thereby controlling the number of points stored in the prediction reference buffer.

The embodiments of the present disclosure do not limit the specific manner of determining the M reference points based on the first parameter.

In some embodiments, as can be seen from the above, upon performing attribute encoding on the point cloud, the point cloud geometry has been encoded, so the point cloud is sorted according to the geometry information of the point cloud, for example, the point cloud is sorted through Morton code. The M points whose attribute information has been encoded are selected as the M reference points of the current point from the sorted point cloud, and the M reference points are stored into the prediction reference buffer. For example, according to the sorting order of the point cloud, the M reference points are selected from the points whose attribute information has been encoded. For another example, random sampling is performed on the sorted points whose attribute information has been encoded to obtain M points whose attribute information has been encoded as the M reference points.

In some embodiments, upon performing attribute encoding on a point cloud, the point cloud is partitioned into levels, for example, LOD construction is performed. In this way, upon performing attribute encoding on the current point in a certain level, the M reference points may be selected from the current LOD level where the current point is located. For example, the encoding end determines whether the current point cloud introduces LOD intra-level prediction, and if it is determined that the current point cloud enables the LOD intra-level prediction, points in the same LOD level may be used for attribute prediction, that is, M points whose attribute information has been encoded are selected from the current LOD level, and stored into the prediction reference buffer as the M reference points for the current point. It should be noted that when the number of LOD levels is 1, the LOD intra-level prediction is always used.

In some embodiments, upon predicting the attribute information of the current point, the encoding end first determines a prediction reference point set corresponding to the current point.

In this case, determining the M reference points based on the first parameter in S202 includes the following steps:
S202-A1: determining the prediction reference point set corresponding to the current point, where the prediction reference point set includes multiple reference points; and
S202-A2: selecting the M reference points from the prediction reference point set based on the first parameter.

In this embodiment, the encoding end first determines multiple reference points corresponding to the current point, and uses a set consisting of the multiple reference points as the prediction reference point set corresponding to the current point. When performing attribute prediction on the current point, existing methods store all reference points in the prediction reference point set into the prediction reference buffer, which takes up a large amount of memory, leaving less memory for other calculations on the encoding end, thereby reducing encoding efficiency. In order to solve this technical problem, the embodiments of the present disclosure control the size of the prediction reference buffer through the first parameter, upon predicting the attribute information of each point in the point cloud, M reference points are stored into the prediction reference buffer each time, thereby avoiding excessive memory occupation by the prediction reference buffer, and improving the encoding efficiency of the encoding side.

For example, taking an intra nearest neighbor search as an example, in an entire LOD partitioning process, there are three sets O(k), L(k) and I(k), where k is an index of an LOD level during LOD partitioning, and I(k) is an input point set during the current LOD level partitioning. After LOD partitioning, the O(k) set and the L(k) set are obtained. The O(k) set stores a sampling point set, and L(k) is a set of points in the current LOD level. For example, since the entire LOD partitioning process is based on the Morton code, O(k), L(k) and I(k) store Morton code indexes corresponding to the points. When performing inter-level nearest neighbor search, the points in the L(k) set perform nearest neighbor search in the O(k) set.

In the embodiments of the present disclosure, the current point is any point in the L(k) set whose attribute information is to be encoded, and the O(k) set is recorded as the prediction reference point set corresponding to the current point. It should be noted that, in the embodiments of the present disclosure, the reference points included in the prediction reference set are all points whose attribute information has been encoded.

In some embodiments, during intra prediction, the encoded point set in the same level within the same level LOD is added to the prediction reference point set.

In some embodiments, during inter prediction, at least one point in a reference frame of the current point whose attribute information has been encoded may be added to the prediction reference point set.

In the embodiments of the present disclosure, the reference frame of the current point may be understood as a reference frame of a current frame where the current point is located.

The embodiments of the present disclosure do not limit the number of reference frames of the current point, that is, the current point includes one or more reference frames.

In some embodiments, the reference frame of the current point includes a forward reference frame of the current frame.

In some embodiments, the reference frame of the current point includes a backward reference frame of the current frame.

In some embodiments, the reference frame of the current point includes both a forward reference frame and a backward reference frame of the current frame.

From the above, it can be seen that no matter whether the current point adopts intra nearest neighbor search, inter nearest neighbor search, or intra nearest neighbor search and inter nearest neighbor search, the prediction reference set may be determined. Typically, the prediction reference set includes more than M points whose attribute information has been encoded.

In the embodiments of the present disclosure, after determining the prediction reference set corresponding to the current point, the encoding end does not buffer all points in the prediction reference set into the prediction reference buffer. Instead, based on the first parameter, the decoding end selects M reference points from the prediction reference set and buffers the M reference points into the prediction reference buffer to avoid the prediction reference buffer occupying more memory space and affecting the encoding efficiency.

In the embodiments of the present disclosure, the manners for selecting the M reference points from the prediction reference set include but are not limited to the following.

Manner I: Based on a distance between each point in the prediction reference set and the current point, M reference points nearest to the current point are selected from the prediction reference set.

Manner II: Based on an index of each reference point in the prediction reference point set, M reference points are selected from the prediction reference point set. For example, the points in the prediction reference set are sorted according to the Morton code, so that several points with indexes larger than an index of the current point, and several points with indexes smaller than the index of the current point may be selected from the prediction reference point set, and a total of M points are selected as the M reference points corresponding to the current point.

Manner III: To prevent frequent updates of points in the prediction reference buffer, M reference points are selected in sequence according to a search of each point in the prediction reference point set and stored in the prediction reference buffer.

In some embodiments, if the number of reference points included in the prediction reference set corresponding to the current point is equal to or less than the maximum number M of reference points bufferable in the prediction reference buffer indicated by the first parameter, a step of selecting M reference points from the prediction reference point set is skipped, and all reference points in the prediction reference set are buffered in the prediction reference buffer.

According to the above steps, the encoding end determines the M reference points based on the first parameter and stores the M reference points into the prediction reference buffer, and then performs the following step S203.

S203: An attribute prediction value of the current point is determined based on the reference points included in the prediction reference buffer.

Based on the first parameter, the encoding end selects the M reference points from the points whose attribute information has been encoded, and stores the M reference points into the prediction reference buffer. Then, based on the reference points included in the prediction reference buffer, the attribute prediction is performed on the current point to obtain the attribute prediction value of the current point.

The embodiments of the present disclosure do not limit the specific manner in which the encoding end determines the attribute prediction value of the current point based on the reference points included in the prediction reference buffer.

In some embodiments, as can be seen from the above, in order to reduce the memory usage of the prediction reference buffer, the embodiments of the present disclosure reduce the number of reference points included in the prediction reference buffer, that is, a fixed number of M reference points are stored in the prediction reference buffer each time. Since the number of reference points included in the prediction reference buffer is relatively small, the encoding end may directly use all or part of the reference points included in the prediction reference buffer as neighboring points of the current point to predict the attribute information of the current point.

In some embodiments, the encoding end performs attribute prediction on the current point through the following steps S203-A and S203-B:
S203-A: searching for at least one neighboring point of the current point among the reference points included in the prediction reference buffer; and
S203-B: determining the attribute prediction value of the current point based on attribute information of the at least one neighboring point.

In this embodiment, upon performing attribute prediction on the current point, the encoding end searches for the at least one neighboring point of the current point from the reference points included in the prediction reference buffer, and then predicts the attribute of the current point based on the attribute information of the at least one neighboring point (i.e., attribute reconstructed value) to obtain the attribute prediction value of the current point.

In the embodiments of the present disclosure, manner for searching for the at least one neighboring point of the current point among the reference points included in the prediction reference buffer includes but is not limited to the following.

Manner I: In the intra inter-level nearest neighbor search, the reference points included in the prediction reference buffer include points in the LOD level that has been encoded before the current LOD level. Based on this, the encoding end first uses the coordinate of the current point to obtain a corresponding spatial block as the current block, and then performs a nearest neighbor search in the LOD level that has been encoded before the current LOD level, for example, searching for a reference point included in the spatial block that is co-planar, co-edge, or co-vertex with the current block as at least one neighboring point of the current point.

Manner II: The above S203-A includes the following steps:
S203-A1: determining a first reference point corresponding to the current point in the prediction reference point set; and
S203-A2: searching for the at least one neighboring point of the current point among the reference points included in the prediction reference buffer based on the first reference point.

In the manner II, the encoding end first determines a reference point among the reference points included in the prediction reference point set as the first reference point corresponding to the current point, and then, based on the first reference point, searches for the at least one neighboring point of the current point among the reference points included in the prediction reference buffer.

The embodiments of the present disclosure do not limit the specific manner in which the encoding end determines the first reference point corresponding to the current point in the prediction reference point set.

In an example, any reference point in the prediction reference point set is determined as the first reference point corresponding to the current point.

In an example, the encoding end and the decoding end use a reference point in the prediction reference point set as the first reference point corresponding to the current point by default. In an example, the reference points in the prediction reference point set are sorted based on indexes, so that the first point, or the second point, or the n-th point in the prediction reference point set may be used as the first reference point corresponding to the current point, n being a positive integer less than or equal to M.

In an example, the encoding end determines a reference point in the prediction reference point set whose index is a first one greater than or equal to the index of the current point as the first reference point. For example, the index of the current point is i, a search is performed in the prediction reference point set, and a first reference point (j) whose index is a first one greater than or equal to the index of the current point is found, and used as the first reference point of the current point.

The embodiments of the present disclosure do not limit the specific forms of the index of the current point and the index of the reference point.

For example, if the embodiments of the present disclosure sort the point cloud based on the Morton code order, the index of the above point may be the Morton code index of the point.

For another example, if the embodiments of the present disclosure sort the point cloud based on the Hilbert order, the index of the point may be the Hilbert index of the point.

After determining the first reference point corresponding to the current point based on the above steps, the encoding end performs the above step S203-A2 to search for the at least one neighboring point of the current point among the reference points included in the prediction reference buffer based on the first reference point.

For example, as illustrated in FIG. 10, it is assumed that the current point is an i-th point in the current point frame, or the index of the current point is i, the index of the first reference point is j, and it is assumed that indexes of the M reference points included in the prediction reference buffer are: P_{j-M/2}, . . . , Pⱼ₋₃, Pⱼ₋₂, Pⱼ₋₁, Pⱼ, Pⱼ₊₁, Pⱼ₊₂, . . . , and P_{j+M/2}, the encoding end searches for the at least one neighboring point of the current point from the M reference points. For example, with the first reference point as the center of Pⱼ, a search is performed within a preset search range to obtain at least one neighboring point of the current point.

The embodiments of the present disclosure do not limit the specific manner in which the encoding end searches for the at least one neighboring point of the current point among the reference points included in the prediction reference buffer based on the first reference point.

In a possible implementation, the encoding end searches for at least one reference point nearest to the current point near the first reference point in the prediction reference buffer as the at least one neighboring point of the current point.

In a possible implementation, the above S203-A2 includes the following steps S203-A21 to S203-A23:
S203-A21: determining, based on the first reference point, whether to update the prediction reference buffer;
S203-A22: in response to determining to update the prediction reference buffer, updating at least one reference point included in the prediction reference buffer, based on remaining reference points in the prediction reference point set, to obtain an updated prediction reference buffer; and
S203-A23: searching for the at least one neighboring point of the current point among the reference points included in the updated prediction reference buffer.

In this implementation, after determining the first reference point, the encoding end first determines, based on the first reference point, whether to update the prediction reference buffer. That is, the encoding end determines, based on the first reference point, whether at least one neighboring of the current point may be accurately determined from the reference points currently buffered in the prediction reference buffer. If it is determined that the at least one neighboring point of the current point cannot be determined from the reference points included in the current prediction reference buffer, it is determined to update the current prediction reference buffer.

In response to determining that the prediction reference buffer does not need to be updated, the encoding end searches for the at least one neighboring point of the current point from the M reference points included in the current prediction reference buffer.

In response to determining to update the prediction reference buffer, the encoding end updates the at least one reference point included in the prediction reference buffer based on the remaining reference points in the prediction reference point set, to obtain the updated prediction reference buffer, and then searches for the at least one neighboring point of the current point among the reference points included in the updated prediction reference buffer.

The specific manner for determining, based on the first reference point, whether to update the prediction reference buffer in the above S203-A21 is introduced below.

The embodiments of the present disclosure do not limit the specific manner in which the encoding end determines, based on the first reference point, whether to update the prediction reference buffer.

In some embodiments, the above S203-A21 includes: in response to the first reference point being a last reference point or one of the last reference points in the current prediction reference buffer, determining to update the current prediction reference buffer.

In some embodiments, the above S203-A21 includes:
S203-A211: in response to a sum of the index of the first reference point and a first value being greater than or equal to an index of the last reference point in the prediction reference buffer, determining to update the prediction reference buffer, the first value being an integer.

In S203-A211, the encoding end adds the index of the first reference point and a first value K to obtain a sum value, which is recorded as A. Next, the sum value A is compared with an index B of the last reference point in the current prediction reference buffer to determine whether the sum value A is greater than or equal to the index B of the last reference point in the current prediction reference buffer.

In response to the sum value A being less than the index B of the last reference point in the current prediction reference buffer, it means that the encoding end may search for the at least one neighboring point of the current point among the reference points included in the current prediction reference buffer, in this case, it is determined that the current prediction reference buffer will not be updated.

In response to the sum value A being greater than or equal to the index B of the last reference point in the current prediction reference buffer, it means that the reference points included in the current prediction reference buffer are insufficient to search for the at least one neighboring point of the current point, or that the reference points included in the current prediction reference buffer do not include a neighboring point of the current point, or the number of neighboring points of the current point included is insufficient. In this case, it is determined that the current prediction reference buffer needs to be updated.

The embodiments of the present disclosure do not limit the specific value of the above first value K, as long as K is an integer, such as 0, 1, 2, or 3.

There are two cases described below: the first value being 0, and the first value being a preset search range value. It should be noted that the first value being 0 or the preset search range value is only an example, and the value of the first value in the embodiments of the present disclosure includes but is not limited to these two cases.

Case I: In response to the first value being 0, then the above S203-A211 includes the step S203-A211-a:
S203-A211-a: in response to the index of the first reference point being greater than or equal to the index of the last reference point in the prediction reference buffer, determining to update the prediction reference buffer.

In the case I, after determining the first reference point corresponding to the current point based on the above steps, the encoding end compares the index of the first reference point with the index of the last reference point among the reference points included in the current prediction reference buffer.

In some embodiments, in response to the index of the first reference point being smaller than the index of the last reference point among the reference points included in the current prediction reference buffer, it is determined not to update the prediction reference buffer, but to directly search for the at least one neighboring point of the current point among the reference points included in the current prediction reference buffer.

In some embodiments, in response to the index of the first reference point being greater than or equal to the index of the last reference point among the reference points included in the current prediction reference buffer, it is determined that the current prediction reference buffer needs to be updated. As illustrated in FIG. 11, it is assumed that the index of the first reference point is j, and the index of the last reference point included in the current prediction reference buffer is also j, the encoding end determines to update the current prediction reference buffer.

In the case I, after determining to update the current prediction reference buffer, the encoding end performs the above step S203-A22, updates the at least one reference point in the prediction reference buffer based on the remaining reference points in the prediction reference point set, to obtain the updated prediction reference buffer.

In the embodiments of the present disclosure, the specific manner for the encoding end to update the at least one reference point among the M reference points included in the prediction reference buffer, to obtain the updated prediction reference buffer is not limited.

In a possible implementation, the encoding end directly deletes all reference points in the current prediction reference buffer, selects M new reference points from the remaining reference points in the prediction reference point set, and stores the selected M new reference points into the prediction reference set. That is to say, in this implementation, in response to the index of the last reference point in the current prediction reference buffer being less than or equal to the index of the first reference point, the encoding end will directly delete the entire M reference points in the prediction reference buffer, and select M new reference points to store in the prediction reference buffer, thereby realizing a rapid update of the entire prediction reference buffer. In this way, the encoding end may search for the at least one neighboring point of the current point from all updated prediction reference buffer.

In an example of this implementation, the encoding end selects M reference points with indexes less than or equal to the index of the first reference point from the remaining reference points in the prediction reference point set, and stores the M reference points into the prediction reference point set as new reference points.

For example, the M points included in the prediction reference point set are sorted from small to large according to indexes: P0, P1, . . . , Pj−1, Pj, Pj+1, . . . , it is assumed that the M reference points buffered in the current prediction reference buffer are: P0, P1, . . . , PM−1, the first reference point corresponding to the current point is Pj, and j is greater than M−1, in this case, the index j of the first reference point Pj corresponding to the current point is greater than the index M−1 of the last reference point PM−1 in the current prediction reference buffer, so it is determined that the current prediction reference buffer needs to be updated.

In this example, the encoding end updates the current prediction reference buffer by deleting the M reference points P0, P1, . . . , PM−1 included in the current prediction reference buffer. Next, the decoding end selects the M reference points with indexes less than or equal to the index of the first reference point, that is, the decoding end selects M new reference points are Pⱼ, Pⱼ+1, . . . , Pⱼ+M−1, from the remaining reference points in the prediction reference point set, and stores the M new reference points into the prediction reference buffer, thereby updating the entire prediction reference buffer.

In an example of this implementation, the encoding end and the decoding end use the same sampling manner to sample M reference points from the remaining reference points in the prediction reference point set, and store the M reference points into the prediction reference point set as new reference points.

In a possible implementation, the above S203-A22 includes the following steps S203-A22-a1 and S203-A22-a2:
S203-A22-a1: obtaining at least one second reference point from the remaining reference points in the prediction reference set based on the index of the first reference point; and
S203-A22-a2: using the at least one second reference point to update the at least one reference point in the prediction reference buffer, to obtain the updated prediction reference buffer.

In this implementation, in response to determining that the index of the first reference point is greater than or equal to the index of the last reference point in the current prediction reference buffer, the encoding end selects at least one reference point from the remaining reference points in the prediction reference set based on the index of the first reference point. For example, at least one reference point with an index greater than the index of the first reference point is selected from the remaining reference points in the prediction reference set, recorded as the at least one second reference point, and the at least one second reference point is used to update the at least one reference point in the prediction reference buffer, to obtain the updated prediction reference buffer.

In this implementation, there is no limitation on the number of second reference points selected by the encoding end from the remaining reference points in the prediction reference set based on the index of the first reference point.

In some embodiments, the encoding end selects M second reference points from the remaining reference points in the prediction reference set based on the index of the first reference point. That is to say, in this embodiment, the encoding end selects the M second reference points from the remaining reference points in the reference point set based on the index of the first reference point, and then uses the M second reference points to replace the M reference points currently included in the prediction reference buffer as a whole. For example, the encoding end directly deletes the M reference points currently included in the prediction reference buffer, and stores the M second reference points selected above into the prediction reference buffer. In this way, the encoding end searches for the at least one neighboring point of the current point from the M second reference points included in the updated prediction reference buffer.

The embodiments of the present disclosure do not limit the specific manner in which the encoding end selects the M second reference points from the remaining reference points in the prediction reference set based on the index of the first reference point.

In an example, the encoding end selects M reference points with indexes greater than or equal to the index of the first reference point from the remaining reference points in the prediction reference set as the M second reference points.

In an example, an index of a point with the smallest index among the M second reference points is greater than or equal to the index of the first reference point.

In an example, an index of a point with the largest index among the M second reference points is greater than or equal to the sum of the index of the first reference point and M.

In an example, in response to determining that the index j of the first reference point is greater than or equal to the index of the last reference point in the prediction reference buffer, the encoding end selects reference points with indexes [j, j+M] from the prediction reference set as the M second reference points.

In this embodiment, the encoding end selects the M second reference points from the remaining reference points in the prediction reference set based on the index of the first reference point, and then performs the above step of S203-A22-a2, that is, deleting the M reference points in the prediction reference buffer and adding the above determined M second reference points to the prediction reference buffer, thereby obtaining the updated prediction reference buffer as illustrated in FIG. 12.

The process in which the encoding end updates the prediction reference buffer when the first value is 0 in case I is introduced above.

Case II: In response to the first value being the preset search range value, the above S203-A211 includes steps S203-A211-b1 and S203-A211-b2:
S203-A211-b1: adding the index of the first reference point and the preset search range value to obtain a first sum value; and
S203-A211-b2: in response to the first sum value being greater than or equal to the index of the last reference point in the prediction reference buffer, determining to update the prediction reference buffer.

In this case II, after determining the first reference point corresponding to the current point based on the above steps, the encoding end adds the index j of the first reference point and the preset search range value searchRange to obtain the first sum value j+searchRange. Next, the first sum value j+searchRange is compared with the index of the last reference point among the reference points included in the current prediction reference buffer, to determine whether to update the current prediction reference buffer.

In some embodiments, in response to the first sum value j+searchRange being less than the index of the last reference point among the reference points included in the current prediction reference buffer, it is determined not to update the prediction reference buffer, but to directly search for the at least one neighboring point of the current point among the reference points included in the current prediction reference buffer.

In some embodiments, in response to the first sum value j+searchRange being greater than or equal to the index of the last reference point among the reference points included in the current prediction reference buffer, it is determined that the current prediction reference buffer needs to be updated. It is assumed that the index of the first reference point is j, the preset search range value is searchRange, and the first sum value is j+searchRange, in response to the index of the last reference point among the reference points included in the current prediction reference buffer being also j+searchRange, the encoding end determines to update the current prediction reference buffer.

In this case II, after determining to update the current prediction reference buffer, the encoding end performs the above step S203-A22, to update the at least one reference point in the prediction reference buffer based on the remaining reference points in the prediction reference point set, to obtain the updated prediction reference buffer.

In the embodiments of the present disclosure, the specific manner for the encoding end to update the at least one reference point among the M reference points included in the prediction reference buffer, to obtain the updated prediction reference buffer is not limited.

In a possible implementation, the encoding end directly deletes all reference points in the current prediction reference buffer, selects M new reference points from the remaining reference points in the prediction reference point set, and stores the selected M new reference points into the prediction reference set. That is to say, in this implementation, in response to the index of the last reference point in the current prediction reference buffer being less than or equal to the first sum value, the encoding end will directly delete the entire M reference points in the prediction reference buffer, and select the M new reference points to store in the prediction reference buffer, thereby realizing a rapid update of the entire prediction reference buffer. In this way, the encoding end may find the at least one neighboring point of the current point from all updated prediction reference buffer.

In an example of this implementation, the encoding end selects M reference points with indexes less than or equal to the index of the first reference point from the remaining reference points in the prediction reference point set, and stores the M reference points into the prediction reference point set as new reference points.

For example, the M points included in the prediction reference point set are sorted from small to large according to indexes: P0, P1, . . . , Pj−1, Pj, Pj+1, . . . , it is assumed that the M reference points in the current prediction reference buffer are: P0, P1, . . . , PM−1, the first reference point corresponding to the current point is Pj, and the first sum j+searchRange is greater than M−1. In this case, the first sum value j+searchRange of the index j of the first reference point Pj corresponding to the current point and the preset search range value searchRange is greater than the index M−1 of the last reference point PM−1 in the current prediction reference buffer, therefore it is determined that the current prediction reference buffer needs to be updated.

In this example, the encoding end updates the current prediction reference buffer by deleting the M reference points P0, P1, . . . , PM−1 included in the current prediction reference buffer. From the remaining reference points in the prediction reference point set, M reference points with indexes less than or equal to the index of the first reference point are selected, that is, M new reference points Pj, Pj+1, . . . , Pj+M−1 are selected and stored into the prediction reference buffer, thereby updating the entire prediction reference buffer.

In an example of this implementation, the encoding end and the decoding end use the same sampling manner to sample the M reference points from the remaining reference points in the prediction reference point set, and store the M reference points into the prediction reference point set as new reference points.

In a possible implementation, the above S203-A22 includes the following steps S203-A22-b1 and S203-A22-b2:
S203-A22-b1: obtaining at least one third reference point from the remaining reference points in the prediction reference set based on the index of the first reference point; and
S203-A22-b2: using the at least one third reference point to update the at least one reference point included in the prediction reference buffer, to obtain the updated prediction reference buffer.

In this implementation, in response to determining that the first sum value is greater than or equal to the index of the last reference point in the current prediction reference buffer, the encoding end selects at least one reference point from the remaining reference points in the prediction reference set based on the index of the first reference point. For example, at least one reference point with an index greater than the index of the first reference point is selected from the remaining reference points of the prediction reference set, recorded as the at least one third reference point, and the at least one third reference point is used to update the at least one reference point in the prediction reference buffer to obtain the updated prediction reference buffer.

In this implementation, there is no limitation on the number of third reference points selected by the encoding end from the remaining reference points in the prediction reference set based on the index of the first reference point.

In some embodiments, the encoding end selects the M third reference points from the remaining reference points in the prediction reference set based on the index of the first reference point. That is to say, in this embodiment, the encoding end selects the M third reference points from the remaining reference points in the reference point set based on the index of the first reference point, and then uses the M third reference points to replace the M reference points currently included in the prediction reference buffer as a whole. For example, the encoding end directly deletes the M reference points currently included in the prediction reference buffer, and stores the M third reference points selected above into the prediction reference buffer. In this way, the encoding end searches for the at least one neighboring point of the current point from the M third reference points included in the updated prediction reference buffer.

The embodiments of the present disclosure do not limit the specific manner in which the encoding end selects the at least one third reference point from the remaining reference points in the prediction reference set based on the index of the first reference point.

In an example, the encoding end selects at least one reference point with an index greater than or equal to the index of the first reference point from the remaining reference points in the prediction reference set as the at least one third reference point.

In an example, the encoding end selects P third reference points from the remaining reference points in the prediction reference set based on the index of the first reference point, P being equal to a difference between the index of the first reference point and an index of a first reference point in the prediction reference buffer.

In an example, the index of the point with the smallest index among the above P third reference points is greater than or equal to the index of the last reference point in the prediction reference buffer plus one. For example, the index of the last reference point in the prediction reference buffer is 99, and the index of the point with the smallest index among the above P third reference points is 100 or greater than 100.

In an example, the index of the point with the largest index among the above P third reference points is greater than or equal to a sum of the index of the first reference point and M minus one. For example, the index of the first reference point is 67, M=100, then the index of the point with the largest index among the above P third reference points is 166 or greater than 166.

For example, it is assumed that the prediction reference buffer includes 100 points, with indexes ranging from 0 to 99 from small to large, and it is assumed that the index of the first reference point is 67, and the preset search range value is 40, then the sum of the index of the first reference point and the preset search range value is 107. In this case, the first sum value 107 is greater than the index of the last reference point in the prediction reference buffer, therefore, it is determined to update the current prediction reference buffer. Next, the encoding end selects 67 third reference points with indexes from 100 to 166 from the remaining reference points in the prediction reference set based on the index j of the first reference point.

In this embodiment, the encoding end selects the P third reference points from the remaining reference points in the prediction reference set based on the index of the first reference point, and then performs the above step of S203-A22-b2 step, for example, the P points preceding the first reference point in the prediction reference buffer are deleted, and the P third reference points are added to the prediction reference buffer to obtain the updated prediction reference buffer.

From the above, it can be seen that in an example of case II, in response to a first numerical value being the preset search range value, the encoding end adds the index of the first reference point and the preset search range value to obtain the first sum value, and in response to the first sum value being greater than or equal to the index of the last reference point in the prediction reference buffer, based on the index of the first reference point, the P third reference points are selected from the remaining reference points in the prediction reference set. Next, the encoding end deletes the P points before the first reference point in the prediction buffer, and adds the P third reference points determined above to the prediction reference buffer, thereby updating the prediction reference buffer.

In this example, the encoding end uses the P third reference points to update the prediction reference buffer in the following ways, but is not limited to:

In example I, the encoding end deletes the P points preceding the first reference point in the prediction reference buffer and moves M−P points following the first reference point in the prediction reference buffer forward. Then, the P third reference points determined above are stored following the first reference point to obtain the updated prediction reference buffer. In this case, the updated prediction reference buffer includes M reference points, including M−P old reference points and the P third reference points determined above.

In example II, the encoding end deletes the P points preceding the first reference point in the prediction reference buffer, does not move the M−P points after the first reference point in the prediction reference buffer, but directly stores the P third reference points determined above in the positions preceding the first reference point, to obtain the updated prediction reference buffer. In this case, the updated prediction reference buffer includes M reference points, including M−P old reference points and the P third reference points determined above, and the positions of the M−P old reference points in the prediction reference buffer do not change.

In some embodiments of the case II, upon determining that the above first sum value is greater than or equal to the index of the last reference point in the prediction reference buffer, the encoding end deletes all reference points in the current prediction reference buffer and reselects M new reference points from the prediction reference set and stores the M new reference points into the prediction reference buffer. In an example, the minimum index of the M new reference points is less than or equal to the index of the first parameter. In an example, the minimum index of the M new reference points is greater than or equal to the index of the last point in the current prediction reference buffer.

The above description uses the case where the first value is 0 or a preset search range value as an example to illustrate updating the prediction reference buffer at the encoding end. It should be noted that the embodiments of the present disclosure do not limit the specific process of updating the prediction reference buffer at the encoding side.

In some embodiments, in order to increase the update speed, upon determining that the prediction reference buffer needs to be updated, the encoding end may reselect M reference points from the reference points included in the prediction reference set based on the index of the first parameter, and update all points in the prediction reference buffer.

In some embodiments, when the encoding end determines that the prediction reference buffer needs to be updated, the encoding end may update the points in the prediction reference buffer one by one based on the index of the first parameter.

After updating the prediction reference buffer based on the above steps, the encoding end performs the above step S203-A23 to search for the at least one neighboring point of the current point among the reference points included in the updated prediction reference buffer.

In the embodiments of the present disclosure, the encoding end searches for the at least one neighboring point of the current point from the prediction reference buffer in the same manner as searching for the at least one neighboring point of the current point from the updated prediction reference buffer. The following description will be made by taking an example where the encoding end searches for the at least one neighboring point of the current point from the prediction reference buffer.

The embodiments of the present disclosure do not limit the specific manner in which the encoding end searches for the at least one neighboring point of the current point from the prediction reference buffer.

In an example, in the inter-level nearest neighbor search, in response to the above prediction reference buffer includes the inter-level encoded point of the current point, the encoding end obtains a corresponding spatial block from the coordinate of the current point, and then performs the nearest neighbor search in the previously encoded LOD level to search spatial blocks that are co-planar, co-edge, or co-vertex with the current block to obtain the at least one neighboring point of the current point.

In an example, in an intra-level nearest neighbor search, in response to the prediction reference buffer including intra-level encoded points, the encoding end searches for the at least one neighboring point of the current point from the intra-level decoded points.

In an example, in an inter nearest neighbor search, in response to the prediction reference buffer including encoded points in the reference frame of the current point, the encoding end may search for the at least one neighboring point of the current point from the encoded points in the reference frame.

It should be noted that the specific manner in which the encoding end searches for the at least one neighboring point of the current point from the prediction reference buffer may be referred to the description of the above embodiments, which will not be repeated herein.

Upon determining the at least one neighboring point of the current point based on the above steps, the encoding end performs the above step of S203-B to determine the attribute prediction value of the current point based on the attribute information of the at least one neighboring point.

The embodiments of the present disclosure do not limit the specific manner in which the encoding end determines the attribute prediction value of the current point based on the attribute information of at least one neighboring point.

In an example, in response to the at least one neighboring point including a neighboring point, the encoding end determines the attribute information of the neighboring point (i.e., the attribute reconstructed value) as the attribute prediction value of the current point.

For another example, in response to the at least one neighboring point including multiple neighboring points, an average value of the attribute information of the multiple neighboring points is determined as the attribute prediction value of the current point.

For another example, in response to the at least one neighboring point including multiple neighboring points, a weighted average value of the attribute information of the multiple neighboring points is determined as the attribute prediction value of the current point.

For example, the encoding end determines the attribute prediction value of the current point based on the above formula (24).

In the point cloud encoding method provided by the embodiments of the present disclosure, upon performing attribute encoding, the encoding end first determines a first parameter, which is used to indicate a maximum number M of reference points bufferable in a prediction reference buffer. Then, based on the first parameter, M reference points are determined and stored into the prediction reference buffer. Then, based on the reference points included in the prediction reference buffer, an attribute prediction value of the current point is determined. That is, the embodiments of the present disclosure use the first parameter to indicate a size of the prediction reference buffer, so that the size of the prediction reference buffer is fixed and does not change dynamically with the change in the number of reference points, thereby saving memory resources of the encoding device and improving the encoding performance of point cloud attributes.

The preferred embodiments of the present disclosure are described in detail above in conjunction with the accompanying drawings. However, the present disclosure is not limited to the specific details in the above embodiments. Within the technical concept of the present disclosure, various simple modifications may be made to the technical solution of the present disclosure, and these simple modifications all fall within the scope of protection of the present disclosure. For example, the various specific technical features described in the above specific embodiments may be combined in any appropriate manner without contradiction. In order to avoid unnecessary repetition, the present disclosure will not further describe various possible combinations. For another example, the various implementation methods of the present disclosure may be arbitrarily combined, and as long as they do not violate the concept of the present disclosure, they should also be regarded as the contents disclosed in the present disclosure.

It should also be understood that in the various method embodiments of the present disclosure, the size of the serial numbers of the above processes does not mean the order of execution. The execution order of each process should be determined by its function and internal logic, and should not constitute any limitation on the implementation process of the embodiments of the present disclosure. In addition, in the embodiments of the present disclosure, the term “and/or” herein is used to describe an association relationship between associated objects, for example, to indicate that there may be three relationships between the related objects. For example, “A and/or B” may represent that there are three situations: A alone, both A and B, B alone. In addition, the character “/” herein generally indicates that related objects before and after this character are in an “or” relationship.

The method embodiments of the present disclosure are described in detail above in conjunction with FIGS. 9 to 13, and apparatus embodiments of the present disclosure are described in detail below in conjunction with FIGS. 14 to 15.

FIG. 14 is a schematic block diagram of the point cloud decoding apparatus provided by the embodiments of the present disclosure.

As illustrated in FIG. 14, the point cloud decoding apparatus 10 may include:
a parameter determining unit 11, configured to determine a first parameter, where the first parameter is used to indicate a maximum number M of reference points bufferable in a prediction reference buffer, M being a positive integer;
a buffer unit 12, configured to determine M reference points based on the first parameter, and store the M reference points into the prediction reference buffer; and
a prediction unit 13, configured to determine an attribute prediction value of the current point based on reference points included in the prediction reference buffer.

In some embodiments, the buffer unit 12 is specifically configured to: determine a prediction reference point set corresponding to the current point, where the prediction reference point set includes multiple reference points; and select the M reference points from the prediction reference point set based on the first parameter.

In some embodiments, the prediction unit 13 is specifically configured to: search for at least one neighboring point of the current point among the reference points included in the prediction reference buffer; and determine the attribute prediction value of the current point based on attribute information of the at least one neighboring point.

In some embodiments, the prediction unit 13 is specifically configured to: determine a first reference point corresponding to the current point in the prediction reference point set; and search for the at least one neighboring point of the current point in the reference points included in the prediction reference buffer based on the first reference point.

In some embodiments, the prediction unit 13 is specifically configured to determine a reference point in the prediction reference points set whose index is a first one greater than or equal to an index of the current point as the first reference point.

Optionally, the index is a Morton code index.

In some embodiments, the prediction unit 13 is specifically configured to: determine, based on the first reference point, whether to update the prediction reference buffer; in response to determining to update the prediction reference buffer, update at least one reference point in the prediction reference buffer based on remaining reference points in the prediction reference point set, to obtain an updated prediction reference buffer; and search for the at least one neighboring point of the current point among reference points included in the updated prediction reference buffer.

In some embodiments, the prediction unit 13 is specifically configured to determine to update the prediction reference buffer, in response to a sum value of an index of the first reference point and a first value being greater than or equal to an index of a last reference point in the prediction reference buffer, the first value being an integer.

In some embodiments, the prediction unit 13 is specifically configured to, in response to the first value being 0, determine to update the prediction reference buffer, in response to the index of the first reference point being greater than or equal to the index of the last reference point in the prediction reference buffer.

In some embodiments, the prediction unit 13 is specifically configured to: acquire at least one second reference point from the remaining reference points in the prediction reference set based on the index of the first reference point; and use the at least one second reference point to update the at least one reference point in the prediction reference buffer, to obtain the updated prediction reference buffer.

In some embodiments, the prediction unit 13 is specifically configured to select M second reference points from the remaining reference points in the prediction reference set based on the index of the first reference point.

In some embodiments, an index of a point with a smallest index among the M second reference points is greater than or equal to the index of the first reference point.

In some embodiments, an index of a point with a largest index among the M second reference points is greater than or equal to a sum of the index of the first reference point and M.

In some embodiments, the prediction unit 13 is specifically configured to: delete M reference points in the prediction reference buffer, and add the M second reference points to the prediction reference buffer, to obtain the updated prediction reference buffer.

In some embodiments, the prediction unit 13 is specifically configured to determine not to update the prediction reference buffer, in response to an index of the first reference point being smaller than an index of a last reference point in the prediction reference buffer.

In some embodiments, the first value is a preset search range value, and the prediction unit 13 is specifically configured to: add the index of the first reference point to the preset search range value, to obtain a first sum value; and in response to the first sum value being greater than or equal to the index of the last reference point in the predicted reference buffer, determine to update the predicted reference buffer.

In some embodiments, the prediction unit 13 is specifically configured to: acquire at least one third reference point from the remaining reference points in the prediction reference set based on the index of the first reference point; and use the at least one third reference point to update the at least one reference point included in the prediction reference buffer, to obtain the updated prediction reference buffer.

In some embodiments, the prediction unit 13 is specifically configured to select P third reference points from the remaining reference points in the prediction reference set based on the index of the first reference point, P being equal to a difference between the index of the first reference point and an index of a first reference point in the prediction reference buffer.

In some embodiments, an index of a point with a smallest index among the P third reference points is greater than or equal to the index of the last reference point in the prediction reference buffer plus one.

In some embodiments, an index of a point with a largest index among the P third reference points is greater than or equal to a sum of the index of the first reference point and M minus one.

In some embodiments, the prediction unit 13 is specifically configured to: delete P points preceding the first reference point in the prediction reference buffer, and add the P third reference points to the prediction reference buffer, to obtain the updated prediction reference buffer.

In some embodiments, the prediction unit 13 is specifically configured to determine not to update the prediction reference buffer, in response to the first sum value being less than the index of the last reference point in the prediction reference buffer.

In some embodiments, the parameter determining unit 11 is specifically configured to decode a bitstream to obtain the first parameter.

In some embodiments, the buffer unit 12 is further configured to skip a step of selecting M reference points from the prediction reference point set, in response to the number of points included in the prediction reference point set being less than or equal to the first parameter.

It should be understood that the apparatus embodiments and the method embodiments may correspond to each other, and similar descriptions may refer to the method embodiments, which will not be repeated herein, to avoid repetition. Specifically, the point cloud decoding apparatus 10 illustrated in FIG. 14 may correspond to the corresponding subject in performing the point cloud decoding method in the embodiments of the present disclosure, and the aforementioned and other operations and/or functions of various units in the point cloud decoding apparatus 10 are respectively for realizing the corresponding processes in the point cloud decoding method, which will not be repeated herein for the sake of brevity.

FIG. 15 is a schematic block diagram of a point cloud encoding apparatus provided by the embodiments of the present disclosure.

As illustrated in FIG. 15, the point cloud encoding apparatus 20 includes:
a parameter determining unit 21, configured to determine a first parameter, where the first parameter is used to indicate a maximum number M of reference points bufferable in a prediction reference buffer, M being a positive integer;
a buffer unit 22, configured to determine M reference points based on the first parameter, and store the M reference points into the prediction reference buffer; and
a prediction unit 23, configured to determine an attribute prediction value of a current point based on reference points included in the prediction reference buffer.

In some embodiments, the buffer unit 22 is specifically configured to: determine a prediction reference point set corresponding to the current point, where the prediction reference point set includes multiple reference points; and select the M reference points from the prediction reference point set based on the first parameter.

In some embodiments, the prediction unit 23 is specifically configured to: search for at least one neighboring point of the current point among reference points included in the prediction reference buffer; and determine the attribute prediction value of the current point based on attribute information of the at least one neighboring point.

In some embodiments, the prediction unit 23 is specifically configured to: determine a first reference point corresponding to the current point in the prediction reference point set; and search for the at least one neighboring point of the current point in the reference points included in the prediction reference buffer based on the first reference point.

In some embodiments, the prediction unit 23 is specifically configured to determine a reference point in the prediction reference point set whose index is a first one greater than or equal to an index of the current point as the first reference point.

Optionally, the index is a Morton code index.

In some embodiments, the prediction unit 23 is specifically configured to: determine, based on the first reference point, whether to update the prediction reference buffer; in response to determining to update the prediction reference buffer, update at least one reference point in the prediction reference buffer based on remaining reference points in the prediction reference point set, to obtain an updated prediction reference buffer; and search for the at least one neighboring point of the current point among reference points included in the updated prediction reference buffer.

In some embodiments, the prediction unit 23 is specifically configured to determine to update the prediction reference buffer, in response to a sum value of an index of the first reference point and a first value being greater than or equal to an index of a last reference point in the prediction reference buffer, the first value being an integer.

In some embodiments, the prediction unit 23 is specifically configured to, in response to the first value being 0, determine to update the prediction reference buffer, in response to the index of the first reference point being greater than or equal to the index of the last reference point in the prediction reference buffer.

In some embodiments, the prediction unit 23 is specifically configured to: acquire at least one second reference point from the remaining reference points in the prediction reference set based on the index of the first reference point; and use the at least one second reference point to update the at least one reference point in the prediction reference buffer, to obtain the updated prediction reference buffer.

In some embodiments, the prediction unit 23 is specifically configured to select M second reference points from the remaining reference points in the prediction reference set based on the index of the first reference point.

In some embodiments, an index of a point with a smallest index among the M second reference points is greater than or equal to the index of the first reference point.

In some embodiments, an index of a point with a largest index among the M second reference points is greater than or equal to a sum of the index of the first reference point and M.

In some embodiments, the prediction unit 23 is specifically configured to: delete M reference points in the prediction reference buffer, and add the M second reference points to the prediction reference buffer, to obtain the updated prediction reference buffer.

In some embodiments, the prediction unit 23 is specifically configured to determine not to update the prediction reference buffer, in response to the index of the first reference point being less than the index of the last reference point in the prediction reference buffer.

In some embodiments, the first value is a preset search range value, and the prediction unit 23 is specifically configured to: add the index of the first reference point to the preset search range value, to obtain a first sum value; and in response to the first sum value being greater than or equal to the index of the last reference point in the prediction reference buffer, determine to update the predicted reference buffer.

In some embodiments, the prediction unit 23 is specifically configured to: acquire at least one third reference point from the remaining reference points in the prediction reference set based on the index of the first reference point; and use the at least one third reference point to update the at least one reference point included in the prediction reference buffer, to obtain the updated prediction reference buffer.

In some embodiments, the prediction unit 23 is specifically configured to select P third reference points from the remaining reference points in the prediction reference set based on the index of the first reference point, P being equal to a difference between the index of the first reference point and an index of a first reference point in the prediction reference buffer.

In some embodiments, an index of a point with a smallest index among the P third reference points is greater than or equal to the index of the last reference point in the prediction reference buffer plus one.

In some embodiments, an index of a point with a largest index among the P third reference points is greater than or equal to a sum of the index of the first reference point and M minus one.

In some embodiments, the prediction unit 23 is specifically configured to: delete P points preceding the first reference point in the prediction reference buffer, and add the P third reference points to the prediction reference buffer, to obtain the updated prediction reference buffer.

In some embodiments, the prediction unit 23 is specifically configured to determine not to update the prediction reference buffer, in response to the first sum value being smaller than the index of the last reference point in the prediction reference buffer.

In some embodiments, the parameter determining unit 21 specifically configured to signal the first parameter into a bitstream.

In some embodiments, the buffer unit 22 is further configured to skip a step of selecting M reference points from the prediction reference point set, in response to the number of points included in the prediction reference point set being less than or equal to the first parameter.

It should be understood that the apparatus embodiments and the method embodiments may correspond to each other, and similar descriptions may refer to the method embodiments, which will not be repeated herein to avoid repetition. Specifically, the point cloud encoding apparatus 20 illustrated in FIG. 15 may correspond to the corresponding subject in the point cloud encoding method in the embodiments of the present disclosure, and the aforementioned and other operations and/or functions of various units in the point cloud encoding apparatus 20 are respectively for realizing the corresponding processes in the point cloud encoding method, which will not be repeated herein for the sake of brevity.

The apparatuses and system in the embodiments of the present disclosure are described from the perspective of functional units in conjunction with the accompanying drawings. It should be understood that the functional units may be implemented in the form of hardware, or may be implemented by instructions in the form of software, or may be implemented by a combination of hardware and software units. Specifically, each step of the method embodiments in the embodiments of the present disclosure may be completed by the hardware integrated logic circuit and/or instructions in the form of software in the processor. The steps of the method disclosed in the embodiments of the present disclosure may be directly reflected as being executed by a hardware decoding processor, or being executed by a combination of hardware and software units in the decoding processor. Optionally, the software unit may be located in a mature storage medium in the art, such as a random access memory, a flash memory, a read-only memory, a programmable read-only memory, an electrically erasable programmable memory, a register, or the like. The storage medium is located in the memory, and the processor reads information in the memory and completes the steps in the above method embodiments in combination with hardware thereof.

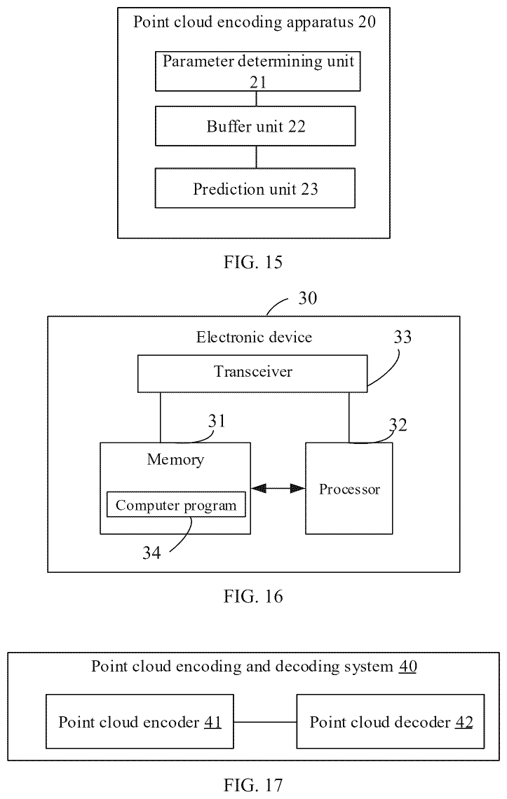

FIG. 16 is a schematic block diagram of an electronic device provided by the embodiments of the present disclosure.

As illustrated in FIG. 16, the electronic device 30 may be a point cloud decoding device or a point cloud encoding device as described in the embodiments of the present disclosure. The electronic device 30 may include:
a memory 31 and a processor 32, where the memory 31 is configured to store a computer program 34 and transmit the computer program 34 to the processor 32. In other words, the processor 32 may call the computer program 34 from the memory 31 and run the computer program 34, to implement the method in the embodiments of the present disclosure.

For example, the processor 32 may be configured to perform the steps of the point cloud encoding method or the point cloud decoding method according to the instructions in the computer program 34.

In some embodiments of the present disclosure, the processor 32 may include but is not limited to:
a general-purpose processor, a digital signal processor (Digital Signal Processor, DSP), an application specific integrated circuit (Application Specific Integrated Circuit, ASIC), a field programmable gate array (Field Programmable Gate Array, FPGA) or other programmable logic devices, discrete gates or transistor logic devices, discrete hardware components.

In some embodiments of the present disclosure, the memory 33 includes but is not limited to:
a volatile memory and/or non-volatile memory. The non-volatile memory may be a read-only memory (Read-Only Memory, ROM), a programmable ROM (Programmable ROM, PROM), an erasable PROM (Erasable PROM, EPROM), an electrically EPROM (Electrically EPROM, EEPROM), or a flash memory. The volatile memory may be a random access memory (Random Access Memory, RAM), which acts as external cache memory. By way of example and not limitation, many forms of RAM (such as a static RAM (Static RAM, SRAM), a dynamic RAM (Dynamic RAM, DRAM), a synchronous DRAM (Synchronous DRAM, SDRAM), a double data rate SDRAM (Double Data Rate SDRAM, DDR SDRAM), an enhanced SDRAM (Enhanced SDRAM, ESDRAM), a synch link DRAM (synch link DRAM, SLDRAM), and a direct rambus RAM (Direct Rambus RAM, DR RAM)) are available.

In some embodiments of the present disclosure, the computer program 34 may be divided into one or more units, which are stored in the memory 31 and executed by the processor 32, to complete the method provided by the present disclosure. The one or more units may be a series of computer program instruction segments capable of completing specific functions, and the instruction segments are used to describe the execution process of the computer program 34 in the electronic device 30.

As illustrated in FIG. 16, the electronic device 30 may further include:
a transceiver 33, where the transceiver 33 may be connected to the processor 32 or the memory 31.

The processor 32 may control the transceiver 33 to communicate with other devices, specifically, may transmit information or data to other devices, or receive information or data transmitted from other devices. The transceiver 33 may include a transmitter and a receiver. The transceiver 33 may further include an antenna(s), and the number of antenna(s) may be one or more.

It should be understood that the various components in the electronic device 30 are connected via a bus system, where the bus system includes not only a data bus, but also a power bus, a control bus and a status signal bus.

FIG. 17 is a schematic block diagram of the point cloud encoding and decoding system provided by the embodiments of the present disclosure.

As illustrated in FIG. 17, the point cloud encoding and decoding system 40 may include: a point cloud encoder 41 and a point cloud decoder 42, where the point cloud encoder 41 is configured to perform the point cloud encoding method involved in the embodiments of the present disclosure, and the point cloud decoder 42 is configured to perform the point cloud decoding method involved in the embodiments of the present disclosure.

The present disclosure also provides a bitstream, where the bitstream is generated according to the above encoding method.

The present disclosure further provides a computer storage medium having a computer program stored thereon, and the computer program, upon being executed by a computer, enables the computer to perform the method in the above method embodiments. In other words, the embodiments of the present disclosure further provide a computer program product including instructions, which, upon being executed by a computer, enable the computer to perform the method of the above method embodiments.

The embodiments may be, upon being implemented by using a software, implemented in a form of a computer program product in whole or in part. The computer program product includes one or more computer instructions. When computer program instructions are loaded on and executed by a computer, processes or functions according to the embodiments of the present disclosure are generated in whole or in part. The computer may be a general-purpose computer, a dedicated computer, a computer network, or any other programmable apparatuses. The computer instructions may be stored in a non-transitory computer-readable storage medium or transmitted from a non-transitory computer-readable storage medium to another non-transitory computer-readable storage medium. For example, the computer instructions may be transmitted from a website, a computer, a server or a data center to another website, computer, server or data center via a wired manner (such as a coaxial cable, an optical fiber, or a digital subscriber line (digital subscriber line, DSL)) or a wireless manner (such as infrared, wireless or microwave). The non-transitory computer-readable storage medium may be any available medium able to be accessed by the computer, or may be a data storage device, such as a server or a data center, integrated by one or more available media. The available medium may be a magnetic medium (e.g., a floppy disk, a hard disk or a magnetic tape), an optical medium (e.g., a digital video disc (digital video disc, DVD)), a semiconductor medium (e.g., a solid state drive (solid state drive, SSD)), or the like.

Those ordinary skilled in the art may realize that, units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the present disclosure.

In the several embodiments provided by the application, it should be understood that, the disclosed systems, apparatuses, and methods may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatuses or units via some interfaces, which may be electrical, mechanical, or in other forms.

The units illustrated as separate components may be or may not be physically separated, and the components shown as units may be or may not be physical units, that is, may be located in one place, or may be distributed onto a plurality of network units. A part or all of the units may be selected according to actual needs, to implement the purpose of the solutions of the embodiments. For example, the various functional units in the various embodiments of the present disclosure may be integrated into one processing unit, or the various units may exist physically separately, or two or more units may be integrated into one unit.

The above content is only specific implementations of the present disclosure, but the protection scope of the present disclosure is not limited thereto. Any skilled familiar with this technical field may easily think of changes or substitutions within the technical scope disclosed in the present disclosure, which should be all covered within the protection scope of the present disclosure. Therefore, the protection scope of the present disclosure should be subject to the protection scope of the claims.

What is claimed is:

1. A point cloud decoding method, comprising:
determining a first parameter, wherein the first parameter is used to indicate a maximum number M of reference points bufferable in a prediction reference buffer, M being a positive integer;
determining M reference points based on the first parameter, and storing the M reference points into the prediction reference buffer; and
determining an attribute prediction value of a current point based on reference points comprised in the prediction reference buffer.

2. The method according to claim 1, wherein determining the M reference points based on the first parameter comprises:
determining a prediction reference point set corresponding to the current point, wherein the prediction reference point set comprises multiple reference points; and
selecting the M reference points from the prediction reference point set based on the first parameter.

3. The method according to claim 2, wherein determining the attribute prediction value of the current point based on the reference points comprised in the prediction reference buffer comprises:
searching for at least one neighboring point of the current point among the reference points comprised in the prediction reference buffer; and
determining the attribute prediction value of the current point based on attribute information of the at least one neighboring point.

4. The method according to claim 3, wherein searching for the at least one neighboring point of the current point among the reference points comprised in the prediction reference buffer comprises:
determining a first reference point corresponding to the current point in the prediction reference point set; and
searching for the at least one neighboring point of the current point among the reference points comprised in the prediction reference buffer based on the first reference point.

5. The method according to claim 4, wherein determining the first reference point corresponding to the current point in the prediction reference point set comprises:
determining a reference point in the prediction reference point set whose index is a first one greater than or equal to an index of the current point as the first reference point.

6. The method according to claim 5, wherein the index is a Morton code index.

7. The method according to claim 4, wherein searching for the at least one neighboring point of the current point among the reference points comprised in the prediction reference buffer based on the first reference point comprises:
determining, based on the first reference point, whether to update the prediction reference buffer;
in response to determining to update the prediction reference buffer, updating at least one reference point in the prediction reference buffer based on remaining reference points in the prediction reference point set, to obtain an updated prediction reference buffer; and
searching for the at least one neighboring point of the current point among reference points comprised in the updated prediction reference buffer.

8. The method according to claim 7, wherein determining, based on the first reference point, whether to update the prediction reference buffer comprises:
in response to a sum value of an index of the first reference point and a first value being greater than or equal to an index of a last reference point in the prediction reference buffer, determining to update the prediction reference buffer, the first value being an integer.

9. The method according to claim 8, wherein, in response to the first value being 0, then in response to the sum value of the index of the first reference point and the first value being greater than or equal to the index of the last reference point in the prediction reference buffer, determining to update the prediction reference buffer comprises:
in response to the index of the first reference point being greater than or equal to the index of the last reference point in the prediction reference buffer, determining to update the prediction reference buffer.

10. The method according to claim 9, wherein updating the at least one reference point in the prediction reference buffer based on the remaining reference points in the prediction reference point set, to obtain the updated prediction reference buffer comprises:
acquiring at least one second reference point from the remaining reference points in the prediction reference set based on the index of the first reference point; and
using the at least one second reference point to update the at least one reference point in the prediction reference buffer, to obtain the updated prediction reference buffer.

11. The method according to claim 10, wherein acquiring the at least one second reference point from the remaining reference points in the prediction reference set based on the index of the first reference point comprises:
selecting M second reference points from the remaining reference points in the prediction reference set based on the index of the first reference point.

12. The method according to claim 11, wherein an index of a point with a smallest index among the M second reference points is greater than or equal to the index of the first reference point.

13. The method according to claim 11, wherein an index of a point with a largest index among the M second reference points is greater than or equal to a sum of the index of the first reference point and M.

14. The method according to claim 11, wherein using the at least one second reference point to update the at least one reference point comprised in the prediction reference buffer, to obtain the updated prediction reference buffer comprises:
deleting the M reference points in the prediction reference buffer, and adding the M second reference points to the prediction reference buffer, to obtain the updated prediction reference buffer.

15. The method according to claim 7, wherein determining, based on the first reference point, whether to update the prediction reference buffer comprises:
in response to an index of the first reference point being smaller than an index of a last reference point in the prediction reference buffer, determining not to update the prediction reference buffer.

16. The method according to claim 8, wherein the first value is a preset search range value, and in response to the sum value of the index of the first reference point and the first value being greater than or equal to the index of the last reference point in the prediction reference buffer, determining to update the prediction reference buffer comprises:
adding the index of the first reference point to the preset search range value, to obtain a first sum value; and
in response to the first sum value being greater than or equal to the index of the last reference point in the prediction reference buffer, determining to update the prediction reference buffer.

17. The method according to claim 16, wherein updating the at least one reference point comprised in the prediction reference buffer to obtain the updated prediction reference buffer comprises:
acquiring at least one third reference point from the remaining reference points in the prediction reference set based on the index of the first reference point; and
using the at least one third reference point to update the at least one reference point comprised in the prediction reference buffer, to obtain the updated prediction reference buffer.

18. A point cloud encoding method, comprising:
determining a first parameter, wherein the first parameter is used to indicate a maximum number M of reference points bufferable in a prediction reference buffer, M being a positive integer;
determining M reference points based on the first parameter, and storing the M reference points into the prediction reference buffer; and
determining an attribute prediction value of a current point based on reference points comprised in the prediction reference buffer.

19. A point cloud decoding device, comprising: a processor and a memory;
wherein the memory is configured to store a computer program; and
the processor is configured to call and run the computer program stored in the memory, to enable the point cloud decoding device to perform:
determining a first parameter, wherein the first parameter is used to indicate a maximum number M of reference points bufferable in a prediction reference buffer, M being a positive integer;
determining M reference points based on the first parameter, and storing the M reference points into the prediction reference buffer; and
determining an attribute prediction value of a current point based on reference points comprised in the prediction reference buffer.

20. A non-transitory computer-readable storage medium, having a computer program and a bitstream stored thereon, wherein the computer program, when executed by a processor, enables the processor to perform the steps of the point cloud encoding method according to claim 18 to generate the bitstream.
